(19) United States
(12) Patent Application Publication
(10) Pub. No.: US 2019/0392001 A1
(43) Pub. Date: Dec. 26, 2019

(54) Systems and Methods for an Artificial Intelligence Data Fusion Platform

(71) Applicant: Deep Insight Solutions, Inc. dba Lucd, Nashville, TN (US)

(72) Inventors: Christopher D. Carothers, Schenectady, NY (US); David W. Bauer, JR., Leesburg, VA (US); Justin Lapre, Poestenkill, NY (US); David Salmen, Centre Hill, PA (US); Joel Branch, West Hartford, CT (US)

(73) Assignee: Deep Insight Solutions, Inc. dba Lucd, Nashville, TN (US)

(21) Appl. No.: 16/252,422

(22) Filed: Jan. 18, 2019

Related U.S. Application Data
(63) Continuation-in-part of application No. 16/147,135, filed on Sep. 28, 2018, now Pat. No. 10,417,558.
Application No. 16/147,135 is a continuation-in-part of application No. 16/010,083, filed on Jun. 15, 2018.

(51) Int. Cl. G06F 16/901; G06K 9/62; G06F 16/908; G06N 3/063; G06F 3/0482

(52) U.S. Cl. CPC G06F 16/9024; G06K 9/6289; G06F 3/0482; G06F 16/908; G06N 3/063; G06K 9/623

(57) ABSTRACT

A computer-implemented method is disclosed. The method may include providing, in a computer-readable storage device, a dataspace. The dataspace may include a plurality of logical segments, and dataspace data stored in the plurality of logical segments. The method may include receiving, from a data source external to the dataspace, a data artifact. The data artifact may include a plurality of data elements. The method may include processing, at a plurality of data filters, the plurality of data elements. A data filter of the plurality of data filters may process a data element of the plurality of data elements, based on a structure of the plurality of the data elements, or a configuration of the data filter. The method may include generating, based on the processed plurality of data elements, processed data. The method may include sending the processed data to the dataspace.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application is a continuation-in-part of U.S. patent application Ser. No. 16/010,083, which was filed on Jun. 15, 2018 and is pending; and is a continuation-in-part of U.S. patent application Ser. No. 16/147,135, which was filed on Sep. 28, 2018 and is pending; and the entirety of these applications are incorporated by reference.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### TECHNICAL FIELD

The present disclosure generally relates to cloud computing, and more particularly to methods and systems for an artificial intelligence data fusion platform.

### BACKGROUND OF THE INVENTION

An organization may use multiple disparate and changing data sources and data processing systems to accomplish its objectives. Different data sources may include data in different formats, data with different access rights, and data that is logically separate from other data. Because of the differences in these data sources, sharing data between different parts of the organization may be difficult. For example, a person in the organization may wish to compile all the data the organization stores that pertains to a certain topic. However, because of the different data formats, the logical separation of the data, or other barriers, compiling such data may require a lot of work to transform the data into a compatible form. For example, a user may manually look through data in a relational database, file system, or other data storage means (one or more of which may reside in different logical sections), manually determine that the data stored in different places are inconsistent, choose a standardized format, and manually change the data into the standardized format. The relational database or file system store the data in highly rigid and non-flexible ways that may restrict data usage or storage options.

Furthermore, an organization may use a cloud system or supercomputer to execute artificial intelligence (AI), machine learning, or data analytics capabilities. However, while these systems may perform these capabilities, these conventional systems do not provide important features such as input data management, workflow management, or data security. Furthermore, these conventional systems cannot use unstructured data during machine learning or data analytics processes. Conventional systems, in response to encountering a portion of data with missing values, either drop the data portion or fill in the missing values with a default data value or some kind of calculated data value (e.g., an average data value calculated from other data in the dataset).

Conventional systems may use conservative execution when running an AI, machine learning, or data analytics model. During this execution, interdependent components may wait on each other for results so that calculations are accurate. However, this waiting increases the amount of the time the model spends stalled. This stalling leads to a slowdown in model execution, and a slowdown in parallel execution of the model if it is executing on multiple processors. Additionally, conventional systems may use graphical processing units (GPUs) to increase execution speed and parallelization.

Conventional systems may also use a web-based user interface that leverages Javascript libraries or may use an online coding notebook interface that accepts lines of computer code as input.

What is needed, then, are systems and methods for an artificial intelligence data fusion platform that can integrate data into a unified dataspace to allow data search, enrichment, and exploitation processes to be developed and tested.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one embodiment, a system may ingest data from one or more external sources, populating a dataspace. The system may include one or more software applications accessed by distributed users. Some of the software applications may be hosted on a cloud of the system. Some functionality may be distributed at a tactical edge of the system. The system may include one or more infrastructure services, some of which may include large-scale services. The system may support interoperability with other external systems. In some embodiments of the disclosure, the system may be deployed in a variety of configurations, such as a data center or a smaller configuration, such as half rack or transit case. The system may support a large number of widely different usages. These usages may include varying operating needs. The system may support multiple users from different organizations using the capabilities of the system simultaneously while keeping these users' or organizations' data and processing separate from one another and secure.

One embodiment of the disclosure may include a method. The method may include a method for data flow and data fusion. The method may include providing, in a computer-readable storage device, a dataspace. The dataspace may include a plurality of logical segments. The dataspace may include dataspace data stored in the plurality of logical segments. The method may include receiving, from a data source external to the dataspace, a data artifact. The data artifact may include a plurality of data elements. The method may include processing, at a plurality of data filters, the plurality of data elements. A data filter may process a data element based on a structure of the plurality of the data elements. A data filter may process a data element based on a configuration of the data filter. A data filter may process a data element based on the mathematical analysis of the data elements. A data filter may process a data element based on an algorithm based on a mathematical function. A data filter may process a data element based on a method that may include generating processed data. Generating the data may be based on the plurality of data elements. The method may include sending the processed data to a logical segment. In one embodiment, a data filter may use artificial intelligence (AI) model, system, or method functionality as part of the data flow and fusion.

One aspect of the disclosure may include a computer-implemented method. The computer-implemented method may include an improved hyperparameter search for an AI or machine learning model. The method may include generating a first deep learning model configuration. The method may include calculating a first result metric for the first deep learning model configuration. The method may include selecting a first sample space. The first sample space may be based on the first deep learning model configuration. The method may include generating a second deep learning model configuration. The second deep learning model configuration may be within the first sample space. The method may include calculating a second result metric for the second deep learning model configuration. The method may include, in response to the second result metric exceeding the first result metric, selecting a second sample space. The second sample space may be based on the second deep learning model configuration. The method may include, in response to the second result metric not exceeding the first result metric, reducing the size of the first sample space.

One aspect of the disclosure includes a computer-implemented method. The computer-implemented method may include an improved optimistic event processing method for an artificial neural network. The method may include receiving, at a neuron of an artificial neural network, a sequence of synapse messages. Each synapse message may include a timestamp of the time the synapse message was sent. The method may include determining, based on the timestamp of each synapse message, whether the neuron processed the sequence of synapse messages out of order with respect to the timestamps. The method may include in response to the neuron processing the sequence of synapse messages out of order, reverse-computing at least one computation performed by the neuron in response to processing the sequence of synapse messages out of order. The method may include performing the at least one computation based on receipt of the sequence of synapse messages in a correct order as determined by the timestamp of each synapse message in the sequence of synapse messages.

Another aspect of the disclosure includes a computer-implemented method. The computer-implemented method may include a method for roll back in a computer system. The method for rollback may include a method for rolling back data ingested into a dataspace, rolling back an artificial intelligence or machine learning model, rolling back a data model, or rolling back an assertion in a dataspace.

Numerous other objects, advantages and features of the present disclosure will be readily apparent to those of skill in the art upon a review of the following drawings and description of the various embodiments. As will be seen, in response to the non-conventional steps, functions, components, and the like of the present embodiments, the systems and methods, artificial neural networks, and other computer-related functions described herein may improve the functionality of a computing device.

### BRIEF DESCRIPTION OF THE DRAWINGS

FIG. 1A is a schematic block diagram of one embodiment of a system for an artificial intelligence data fusion platform;

FIG. 1B is a schematic block diagram illustrating one embodiment of a mission dataspace;

FIG. 2A is a schematic block diagram illustrating one embodiment of a cloud environment;

FIG. 2B is a schematic block diagram illustrating one embodiment of a cloud environment;

FIG. 3 is a schematic block diagram illustrating one embodiment of an information environment;

FIG. 4A is a schematic block diagram illustrating one embodiment of a server-side environment;

FIG. 4B is a schematic block diagram illustrating one embodiment of a portion of a system for an artificial intelligence data fusion platform;

FIG. 5A is a schematic block diagram illustrating one embodiment of a mission application environment;

FIG. 5B is a front view illustrating one embodiment of a graphic user interface (GUI) for the system for artificial intelligence data fusion platform;

FIG. 5C is a front view illustrating another embodiment of a graphic user interface (GUI) for the system for artificial intelligence data fusion platform;

FIG. 5D is a front view illustrating another embodiment of a graphic user interface (GUI) for the system for artificial intelligence data fusion platform;

FIG. 5E is a front view illustrating another embodiment of a graphic user interface (GUI) for the system for artificial intelligence data fusion platform;

FIG. 6A is a schematic block diagram illustrating one embodiment of a management environment;

FIG. 6B is a schematic block diagram illustrating one embodiment of a data management application;

FIG. 7 is a schematic block diagram illustrating one embodiment of a security environment;

FIG. 8 is a flowchart illustrating one embodiment of a method for data ingestion;

FIG. 9 is a flowchart block diagram illustrating one embodiment of a method for deep learning optimization;

FIG. 10A is a schematic block diagram illustrating one embodiment of a hyperparameter design space for deep learning optimization;

FIG. 10B is a schematic block diagram illustrating one embodiment of a hyperparameter design space for deep learning optimization;

FIG. 10C is a schematic block diagram illustrating one embodiment of a hyperparameter design space for deep learning optimization;

FIG. 10D is a schematic block diagram illustrating one embodiment of a hyperparameter design space for deep learning optimization;

FIG. 10E is a schematic block diagram illustrating one embodiment of a hyperparameter design space for deep learning optimization;

FIG. 11 is a flowchart block diagram illustrating one embodiment of a method for deep learning optimization;

FIG. 12A is a schematic block diagram illustrating one embodiment of a hyperparameter design space for deep learning optimization;

FIG. 12B is a schematic block diagram illustrating one embodiment of a hyperparameter design space for deep learning optimization;

FIG. 12C is a schematic block diagram illustrating one embodiment of a hyperparameter design space for deep learning optimization;

FIG. 12D is a schematic block diagram illustrating one embodiment of a hyperparameter design space for deep learning optimization;

FIG. 12E is a schematic block diagram illustrating one embodiment of a hyperparameter design space for deep learning optimization;

FIG. 13 is a flowchart block diagram illustrating one embodiment of a method for deep learning optimization;

FIG. 14 is a schematic block diagram depicting one embodiment of an artificial neural network;

FIG. 15 is a flowchart block diagram illustrating one embodiment of a method for artificial neural network optimistic event processing;

FIG. 16 is a flowchart block diagram illustrating one embodiment of a method for artificial neural network optimistic event processing;

FIG. 17A is a schematic block diagram depicting one embodiment of a sequence of synapse message;

FIG. 17B is a schematic block diagram depicting one embodiment of a sequence of synapse message and anti-message;

FIG. 18 is a flowchart block diagram illustrating one embodiment of a method for artificial neural network optimistic event processing;

FIG. 19 is a schematic flow diagram depicting one embodiment of an example process of a synapse group processing for an artificial neural network;

FIG. 20 is a flowchart block diagram illustrating one embodiment of a method for artificial neural network optimistic event processing; and

FIG. 21 is a schematic block diagram illustrating one embodiment of a system for neural network optimistic event processing.

### DETAILED DESCRIPTION

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “or” does not imply mutual exclusivity unless otherwise specified. The term “based on” means “based on, at least in part.”

Furthermore, the described features, structures, or characteristics of the disclosure may be combined in any suitable manner in one or more embodiments. In the following description, numerous specific details are provided, such as examples of programming, software, user selections, hardware, hardware circuits, hardware chips, or the like, to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

### The System Overview and Dataspaces

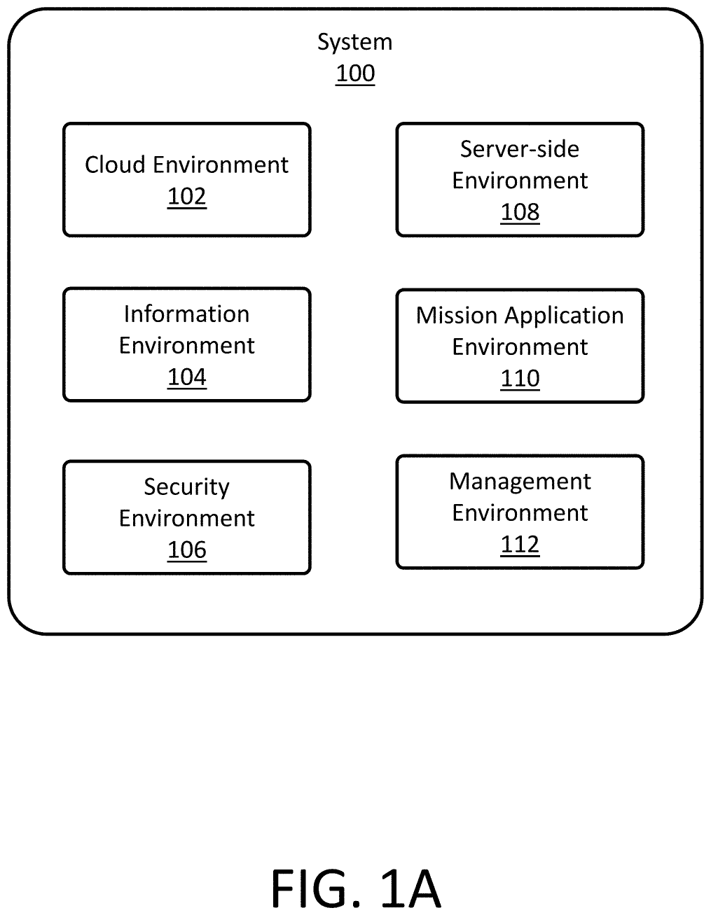

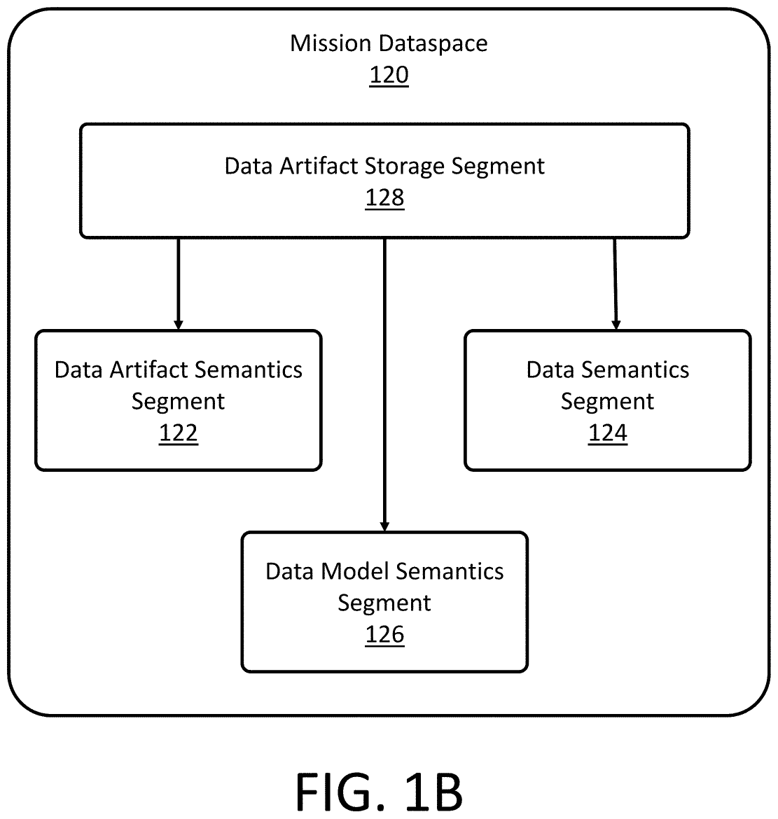

FIG. 1A depicts one embodiment of a system 100. In one embodiment, the system 100 may include a system for an artificial intelligence data fusion platform. The system 100 may include a plurality of environments. An environment of the system 100 may include a physical or logical subsection of the components, devices, or applications, of the system 100. The plurality of environments may include a cloud environment 102, an information environment 104, a security environment 106, a server-side environment 108, a mission application environment (MAE) 110, or a management environment 112.

In some embodiments, the system 100 may include a plurality of dataspaces. A dataspace may include a set of data. The dataspace may include one or more logical structures that may store or organize data stored in the system 100. The dataspace may result from data being integrated into the system 100. The dataspace may result from enrichment of the data included in the dataspace. The dataspace may include metadata associated with the data stored in the dataspace. The contents of the dataspace may be accessible by an application executing in the system 100. In some embodiments, a dataspace may be implemented on one or more storage devices, such as a cloud storage device.

FIG. 1B depicts one embodiment of a mission dataspace 120. In some embodiments, the system 100 may include a mission dataspace 120 and an operational dataspace (not depicted in FIG. 1B). The mission dataspace 120 may include data that is the subject of processing or that pertains to an application of the system 100. The operational dataspace may include data that supports the operation of the system 100 or the processing of data in the mission dataspace 120. The operational dataspace may include data used or created by infrastructure applications to support their operation or execution, input data (such as data entering the system 100 for the first time from an external system or user), work and messages queues, temporary results, configuration files, or transient data.

In one embodiment, the mission dataspace 120 may include a plurality of logical segments. The plurality of logical segments may include a first logical segment. The first logical segment may include an artifact semantics segment 122. The plurality of logical segments may include a second logical segment. The second logical segment may include a data semantics segment 124. The plurality of logical segments may include a third logical segment. The third logical segment may include a model semantics segment 126. The plurality of logical segments may include a fourth logical segment. The fourth logical segment may include a data artifact storage segment 128.

In some embodiments, the data artifact storage segment 128 may include one or more data artifacts. A data artifact may include a digital container of data. A data artifact may include data in a file, data in a relational database, data retrieved via an interface of an application or a computer system, or a data feed or stream (including a real-time data feed). A data artifact may include a plurality of data elements. A data element may include a specifiable portion of the data artifact. For example, a data element may include a string of text located at a certain byte offset in a document, an entry in a relational database table at a certain row and certain column, or a segment of audio in an audio stream from a start time to an end time.

In one embodiment, the data artifact semantics segment 122 may include metadata about a data artifact. The metadata may include generic metadata. Generic metadata may include a hash, file name, location, data size, file type, or a timestamp of the data artifact. In some embodiments, the data artifact semantics segment 122 may include the contents or body of the data artifact. In another embodiment, the data artifact semantics segment 122 may include artifact association data. The artifact association data may associate a first data artifact with a second data artifact.

In some embodiments, the data semantics segment 124 may include data element association data. The data element association data may associate a data element with another data element or a data element with a data artifact. For example, the data semantics segment 124 may include a data element for the text string “Washington.” Data element association data may associate the “Washington” data element with a data artifact including the text string “Washington.” The data element association data may associate the “Washington” data element with a “City” concept or a “Person” concept. In some embodiments, disambiguating a data element may include determining whether an instance of a data element pertains to one or more concepts. For example, a text document may include the text string “Washington,” and disambiguating the text string data element may include determining whether the text string refers to the city of Washington or a person named “Washington.” An application executing the disambiguating process may use other data in the data artifact or data in a dataspace to disambiguate. In one embodiment, the data semantics segment 124 may include metadata such as a timestamp, source, author, associated artifacts, or other metadata.

In another embodiment, the data model semantics segment 126 may include a data model and corresponding metadata for a data source or type of data artifact. For example, an email data model may describe the structure of an email data artifact. As another example, a second data model may describe the structure of a database used by an external application. A data model may include a plurality of data model elements. The plurality of data model elements for a certain data model may describe the structure of the data source. The plurality of data model elements may include concept data or predicate data. Concept data may include data associated with a representation of a concept. Concept data may include data describing a concept that a data element may pertain to. For example, a concept may include a city, a person, a name, an address, or another concept. Predicate data may include data describing a relationship between data elements and concepts. For example, a predicate may describe a data element as being a concept, having a concept, or another type of relationship.

As indicated by the arrows in FIG. 1B and as discussed below, in some embodiments, certain data elements of a data artifact may be copied or moved to the data artifact semantics segment 122. Metadata about the data artifact, or data model information associated with the data artifact (either generated by a system 100 component or ingested into the data artifact storage segment 128) may be derived from a data artifact stored in the data artifact storage segment 128 and stored in the data artifact semantics segment 122, the data semantics segment 124, or the data model semantics segment 126.

In some embodiments, a data element may include a mention. A mention may include a portion of data contained within a data artifact at a quantifiable location within the artifact. The location may be expressed as a byte offset, a pixel coordinate, a video or audio frame, or some other location-indicating data. A mention may include a string of text, an object within an image, a segment of audio or video, or some other portion of data in a data artifact. As an example, the string of text “red yellow red blue” may include two mentions of “red.”

A data element may include a sign. A sign may include a representation of multiple identical mentions. The multiple mentions of the sign may include the same portion of data, but be located at different locations. The different locations may be within the same data artifact or may be within different artifact. As an example, the sign “red” may represent all mentions of the text “red.”

A data element may include a concept. A concept may include a representation of an idea. A concept may be defined by a data model, such as the source data model of a data artifact. For example, the nodes in an ontology, a tag set in an extensible markup language (XML) schema, or attribute/table names in a relational database may define one or more concepts. Examples of a concept may include a city, a person, a name, an address, a photograph, a message, or body text.

A data element may include a term. A term may include a disambiguated sign. A sign being disambiguated may include associating a sign with a concept. As an example, the mission dataspace 120 may include two terms for the sign “red.” The first term for “red” may associate the sign “red” with the concept of color. The second term for “red” may associate the sign “red” with the concept of a slang word for a communist. A term may include a reference to a data artifact, file, or other object within the mission dataspace 120 or the system 100. For example, in one embodiment, a term may include a pathname of a file in the system 100.

A data element may include a predicate. A predicate may include a representation of a relationship between data elements or concepts. A predicate may indicate a relationship between two terms. A relationship may include a wide variety of types of relationships. A relationship may include a first thing being an instance of a second thing, a first thing being a subset of a second thing, a first thing possessing a second thing, or other relationships between two or more things.

In some embodiments, a data element may include a statement. A statement may include one or more subject terms, one or more predicates, and one or more objects. An object of the one or more objects may include a term or another statement. As an example, a statement may include a subject term, a predicate, and an object term. An example notation for such a statement may include [subject term, predicate, object term]. Such a statement may include [“red”, is an instance of, “color”]. As another example, a statement may include a subject term, a predicate, and an object statement. An example notation for such a statement may include [subject term, predicate, [object statement]]. Such a statement may include [“John Smith”, is the parent of, [“Alice Smith”, is a member of, “the Smith family”]]. Another example, statement may include a subject statement, a predicate, and an object statement. Other combinations of terms and statements may form a statement.

In one embodiment, metadata may be associated with a data element. For example, a term or a statement may include metadata describing the sign, concept, term, or statement. The metadata may include a user that generated the data element or inserted the data element into the system 100, a timestamp for when the data element was generated or inserted, or other data about a data element.

In some embodiments, the operational dataspace may include operational data. The operational data may include temporary data storage for an executing application, data for system events, performance or resource utilization metrics, log messages, a messaging infrastructure for messages sent between infrastructure applications or devices, or other operational data.

### The Cloud Environment

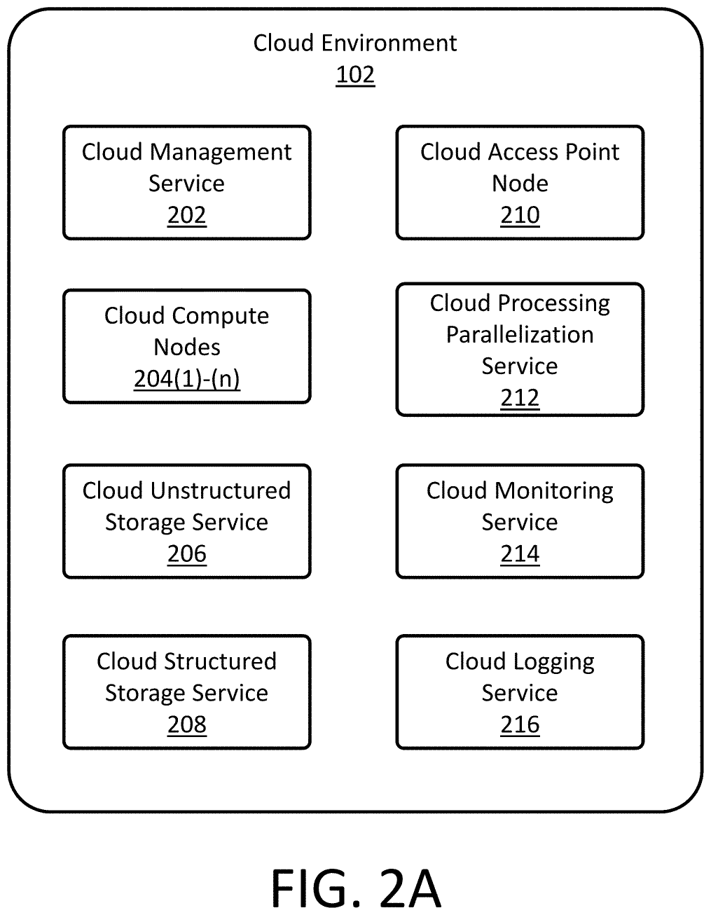

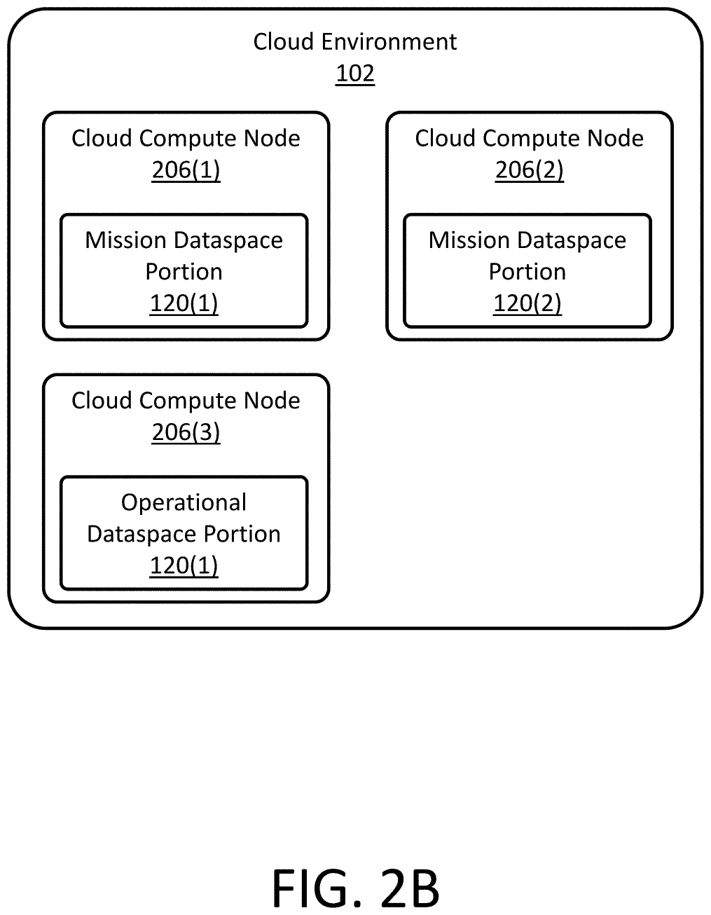

FIG. 2A depicts one embodiment of a cloud environment 102. In one embodiment, the system 100 may include a cloud environment 102. The cloud environment 102 may include one or more components that support cloud computing functionality or cloud storage functionality of the system 100 or another computer system. The cloud environment 102 may include cloud storage that stores the dataspace. In one embodiment, the cloud environment 102 may include a Cloud Management service (CMS) 202. The CMS 202 may manage, oversee, or coordinate the operation of the one or more components of the cloud environment 102. In some embodiments, the CMS 202 may include a centralized mechanism for implementing a cloud computing policy that supports overall elasticity and multi-tenacity of the cloud of the overarching system. A cloud computing policy may include a computing policy (e.g., the policy may dictate how processes, tasks, jobs, etc. may execute) or a data access policy (e.g., the policy may dictate how data may be accessed, formatted, stored, managed, etc.).

In some embodiments, the CMS 202 may manage one or more cloud environment 102 components as services. The CMS 202 may manage a component of the cloud environment 102 by adapting hardware resource allocation to comply with demands of the system 100. One example of software that may control operations of the cloud environment 102 may include HT-CONDOR (provided by the University of Wisconsin—Madison). One example of software that may control monitoring the components of the cloud environment 102 may include NAGIOS (provided by Nagios Enterprises). In some embodiments, the CMS 202 may include data center management services or high-level management services. High level management services may include dynamic execution of component services, execution of user tasks in adherence with the cloud computing policy, determining whether tasks adhere to the cloud data model, integration of cloud environment 102 components with security services (such as the components of the Systems Integrity Management Platform (S IMP) (provided by the U.S. National Security Agency), or other services. Monitoring the cloud environment 102 may include monitoring and metering activities executing in the cloud environment 102.

In some embodiments, monitoring the cloud environment 102 may include complying with one or more data standards. A data standard may include a government standard (e.g., a National Institute of Standards and Technology (NIST) standard, a Health Insurance Portability and Accountability Act (HIPAA) standard), an organizational standard (e.g., an International Organization for Standardization (ISO) standard, a Payment Card Industry (PCI) standard), or some other type of compliance standard.

In some embodiments, one or more components of the CMS 202 may execute outside the cloud environment 102. This may help promote reliable execution of the CMS 202. In some embodiments, to encourage reliability, one or more CMS 202 components may not depend on other CMS 202 components. In one embodiment, accessibility to the CMS 202 may be limited to the cloud owner and administrators. Access to different CMS 202 components may be configured based on user roles. In some embodiments, one or more CMS 202 components may include tools or application programming interfaces (APIs) that support distributed monitoring and logging of cloud environment 102 activities. This may improve system performance and allow dedication of system computing resources to other activities such as cloud computing and application execution.

In one embodiment, the CMS 202 may log one or more activities the occur in the cloud environment 102. This may allow security auditing, performance auditing, or other types of auditing. Logging the one or more activities may include storing data related to the activities. In some embodiments, the CMS 202 may be scalable. The scalability of the CMS 202 may be based on various factors. Such factors may include the number of host devices, the number of cloud compute nodes executable in the cloud environment 102, or other specifications.

In one embodiment, the cloud environment 102 may include one or more cloud compute nodes (CCN) 204(1)-(n). A CCN 204 may include a physical computing device. The CCN 204 may include a central processing unit (CPU), graphics processing unit (GPU), memory (such as random-access memory (RAM) or dynamic RAM (DRAM)), non-volatile storage (such as a hard disk drive, flash memory, or other storage). In some embodiments, a CCN 204 may include a software-implemented node executing on a host device. In another embodiment, a CCN 204 may include a virtual machine.

In some embodiments, the CCN 204 may execute a job. A job may include one or more logical process that execute on one or more CCNs 204(1)-(n). A job may be initiated by a user of the system 100 (e.g., from a command line interface). A job may be initiated by another component of the system 100. A job may include one or more subsystems, components, services, or the like described herein.

The CCN 204 may execute the job using the computing resources of a host device. In one embodiment, the CCN 204 may start, suspend, resume, checkpoint, migrate, or stop the job. The CCN 204 may advertise the capabilities, hardware specifications, software specifications, or other information related to the host device to another component of the system 100, such as the CMS 202.

In one embodiment, the CMS 202 may initiate execution of the CCN 204. In response to being initiated by the CMS 202, the CCN 204 may set up an execution environment on a host device, start a job, monitor the job's execution, detect completion of the job, and send status information to the CMS 202. In one embodiment, setting up an execution environment may include the CCN 204 executing a starter service on the host device. The starter service may be responsible for monitoring a single job. Thus, in response to initiating execution of the starter service, the CCN 204 may be free from monitoring a job and may monitor the CMS 202 for new jobs. In one embodiment, the cloud environment 102 using multiple CCNs 204(1)-(n) may allow the components of the cloud environment 102 to coordinate multiple user jobs even if those user jobs (including the one or more processes that make up each job) have differing priorities that may change over time. Coordinating multiple jobs may include setting up, executing, suspending, checkpointing, migrating, or stopping a job. In some embodiments, the CCN 204 may be scalable to multiple host devices. A job running on a CCN 204 may include an application with distributed computing capability. The cloud processing parallelization service 212 and distributed state coordination service 318 (described below) may provide some distributed state or parallel processing logic or support to the CMS 202 or one or more CCNs 204(1)-(n).

In one embodiment, the cloud environment 102 may include a cloud unstructured storage service (CUSS) 206. The CUSS 206 may provide a scalable data storage service across one or more nodes. In one embodiment, the CUSS 206 may execute on a cloud storage node (CSN), which may be a specific type of CCN 204. The CUSS 206 or the CSN may execute as a job on a host CCN 204. The CSN executing the CUSS 206 may include computer storage. The computer storage may include directed attached storage of the host device, such as a hard drive, solid-state drive, optical disc drive, or an external drive. The computer storage may include storage accessed over a computer network. The CUSS 206 may use the computer storage of the CSN to store data for the dataspace. One example of a CUSS 206 may include the HADOOP distributed file system (provided by Apache).

In one embodiment, the CUSS 206 may include a distributed file system. The CUSS 206 may include a master server and one or more chunk servers. Each of the master server and the chunk servers may execute and store data on their own CSN. In some embodiments, each server (master or chunk) may use its respective CSNs' computer storage to host the distributed file system. Each CSN may be responsible for managing a portion of the distributed file system. Each CSN may contribute computing resources that support the distributed file system such as the CSN's local disk, network bandwidth, or processing power. In some embodiments, the CUSS 206 may add additional CSNs or remove CSNs to scale the distributed file system.

In some embodiments, dataspace contents may be stored in the storage provided by the CUSS 206. Applications executing the cloud may have access to at least a portion of the dataspace contents. In some embodiments, the data storage associated with the CUSS 206 may include large scale, highly available, fast data storage and management. An application may initially communicate with the master server to obtain distributed file system metadata to determine which chunk server(s) to communicate with. The chunk server(s) may store the data for the application, which may reduce latency from having to communicate with the master server each time the application accesses data in the dataspace.

In some embodiments, data may be replicated across multiple CSNs and coordinated by the CUSS 206. In some embodiments, data may be replicated across three CSNs. This may help data to be available even if a CSN fails, goes offline, or otherwise becomes unavailable. In one embodiment, components of the CUSS 206 may communicate with each other via the secure shell protocol (SSH).

In one embodiment, the cloud environment 102 may include a cloud structured storage service (CSSS) 208. The CSSS 208 may provide scalable, distributed, persistent, or highly available logical structured storage. In some embodiments, the structured storage may include a database. The CSSS 208 may execute on a CSN as part of a job. In one embodiment, the CSSS 208 may include ACCUMULO (provided by Apache).

In some embodiments, the CSSS 208 may use the CUSS 206 to store data in a structured manner. The CSSS 208 may include a master server and one or more tablet servers. Each of the master server and the tablet servers may execute on their own CSN. The master server may coordinate the one or more tablet servers, mange the state of distributed CSSS 208 components, perform authentication and authorization checks, track the status of the tablet servers, coordinating tablet splits or migration, or other may perform other functionality.

In one embodiment, the master server may assign data regions to tablet servers. One region may include a top-level region that locates meta regions to be assigned. A meta region may map a number of user regions that make up data tables that the CSSS 208 uses. After the meta regions have been assigned, the master server may assign user regions to tablet servers.

The master server may monitor the health of the one or more tablet servers. In response to the master server detecting that a certain tablet server is unavailable, the master server may split the unavailable server's write-ahead log such that one write-ahead log exists for each region the table server used. The master server may handle table administration functions, such as on or off-lining tables, changing a table schema, or other functions.

The master server may store a meta table. The meta table may store information about each user region in the structured storage. The information may include a region information object that may include information such as the start and end row keys, whether the region is online or offline, or the address of the table server that uses the region. The master server may include a top-level table. The top-level table may include a single region and may map the regions in the meta table. The top-level table may include region information objects for each meta region.

In some embodiments, the tablet server may handle CSSS 208 read and write requests. In response to receiving a write request, the request may be written to a write-ahead log. The tablet server may store the request in an in-memory cache. In response to receiving a read request, the tablet server may check the memory cache for the requested data. If the requested data is not in the cache, the tablet server may search the distributed file system.

A tablet server may communicate with the master server to obtain a list of regions to use. The tablet server may transmit its status to the master server. In some embodiments, a status message from the master server may include region assignments or other instructions.

In one embodiment, the cloud environment may include a cloud access point node (CAPN) 210. The CAPN 210 may include a specialized type of CCN 204. The CAPN 210 may run as a job on a CCN 204. The CAPN 210 may provide a secured entry point or interface into the cloud environment 102. In some embodiments, the CAPN 210 may assist human interaction with the cloud environment 102. The CAPN 210 may support different interface formats such as web technologies, web services, or Web 2.0 technologies.

In some embodiments, the CAPN 210 may implement one or more interfaces for accessing the cloud environment 102. The CAPN 210 may communicate over a data network with a user's computing device via hypertext transfer protocol (HTTP) or HTTP secure (HTTPS). The user's computing device may include a browser or other user interface that may receive HTTP data, and the browser may send HTTP data to the CAPN 210. The CAPN 210 may user the received HTTP data to manipulate components of the cloud environment 102, such as the cloud storage. The CAPN 210 may interact with one or more cloud security components for authentication, authorization, or audit functionality to control access to the cloud environment 102. In one embodiment, an interface for accessing the cloud environment 102 may include a representational state transfer (REST) interface.

In one embodiment, the CAPN 210 may include an access point service. The access point service may include an HTTP web server or servlet container. The access point service may include a web desktop or web operating system. The access point service may include one or more software components that provide an interface for accessing the cloud environment 102.

In some embodiments, the cloud environment 102 may include a cloud processing parallelization service (CPPS) 212. The CPPS 212 may parallelize the processing of a file or data in a dataspace. The CPPS 212 may leverage processing resources available across multiple CCNs 204(1)-(n) or CSNs.

In one embodiment, the CPPS 212 may include a job tracker component. The job tracker component may schedule a job's component tasks on one or more CCNs 204(1)-(n), monitor the tasks statuses, and re-execute a task in response to the task failing. The job tracker may schedule tasks according to a first-in-first-out strategy, a priority strategy, or another scheduling strategy. The job tracker component may include a job configuration component. The job configuration component may determine the number of CCNs 204(1)-(n) to use to execute a job. The job configuration component may determine the number of CCNs 204(1)-(n) to use by determining the amount of data to be processed for the job, and calculating a number of splits on the data based on a number of task tracker services.

The CPPS 212 may include a task tracker service. A task tracker service may be in data communication with the job tracker component. The task tracker service and the job tracker component may communicate over SSH or inter-process communication data. A task tracker may execute an application on a CCN 204 or a virtual machine hosted on a CCN 204. The task tracker service may receive data indicating which split of the data to be processed the task track may work on. In one embodiment, the CPPS 212 may include the HADOOP software's MapReduce functionality.

In one embodiment, the cloud environment 102 may include a cloud monitoring service 214. The cloud monitoring service 214 may provide one or more manageability functions for the cloud environment 102. The cloud monitoring service 214 may provide a unified or consistent presentation of the health of monitored components. A monitored component may include a component of the cloud environment 102 such as a CCN 204, a CSN, an application running in the cloud environment 102 (e.g., on a CCN 204), infrastructure software, an operating system of one or more devices in the cloud environment 102, hardware, or a network devices. The cloud monitoring service 214 may provide policy-based monitoring templates. The cloud monitoring service 214 may distribute views of a presentation layer to various operating centers. The cloud monitor service 214 may support input from other monitored environments such as security events. The cloud monitoring service 214 may restrict what data a user may access based on a role of a user. The cloud monitoring service 214 may provide a user interface for performing one or more management functions.

In some embodiments, the cloud monitoring service 214 may control or change the behavior of a monitored component. The cloud monitoring service 214 may alert an administrator or other user of the system 100 in response to an event occurring. The cloud monitoring service 214 may gather performance and health data (e.g., resource utilization data) about monitored components. The cloud monitoring service 214 may store performance or health data or provide reports based on the performance/health data. The cloud monitoring service 214 may user third-party plugin applications.

In one embodiment, the cloud monitoring service 214 may include a monitor component. The monitor component may collect monitoring data from one or more monitored components through one or more APIs. The monitor component may execute on a monitored device or on a separate device in the cloud environment 102. The monitor component may forward collected monitoring data to a data collector component. The monitor component may forward certain data, such as raw events to a data store. An event engine component may process the raw events.

The cloud monitoring service 214 may include a data collector component. The data collector component may collect monitoring data from one or more monitor components. The cloud monitoring service 214 may include an event engine component. The event engine component may receive data from a data collector component. The event engine component may perform event filtering, aggregation, or masking. Event filtering may include discarding events that may be irrelevant as based on a monitoring policy or monitoring configuration. Event aggregation may include merging duplicate events (e.g., caused by network delays). Even masking may include discarding events pertaining to a cloud environment 102 component that may be downstream of a failed component. The cloud monitoring service 214 may include an analysis component. The analysis component may analyze dependencies between events, to detect whether an event can be explained by one or more other events. For example, if a database runs on a server and the server becomes overloaded, then a low service level event for the database may be explained by the overloading of the server. The analysis may be based on a model of the cloud environment 102, a dependency graph of cloud environment components 102, or other data. The data collector component or the event aggregation engine may send collected or processed data to a data store. A user interface may read from the data store.

In some embodiments, the cloud environment may include a cloud logging service 216. The cloud logging service 216 may log events that occur in the cloud environment 102. The cloud logging service 216 may include an logging agent component. The logging agent component may execute on a CCN 204. The logging agent component may collect log information from the CCN 204 or an application, service, or other software executing on the CCN 204. The logging agent component may send log information to a logging collector component. The logging collector component may aggregate received log information and store the collected information in a data store. A user interface may read the collected data from the data store. One example of a cloud logging service 216 may include CLOUDERA FLUME (provided by Apache).

### Information Environment

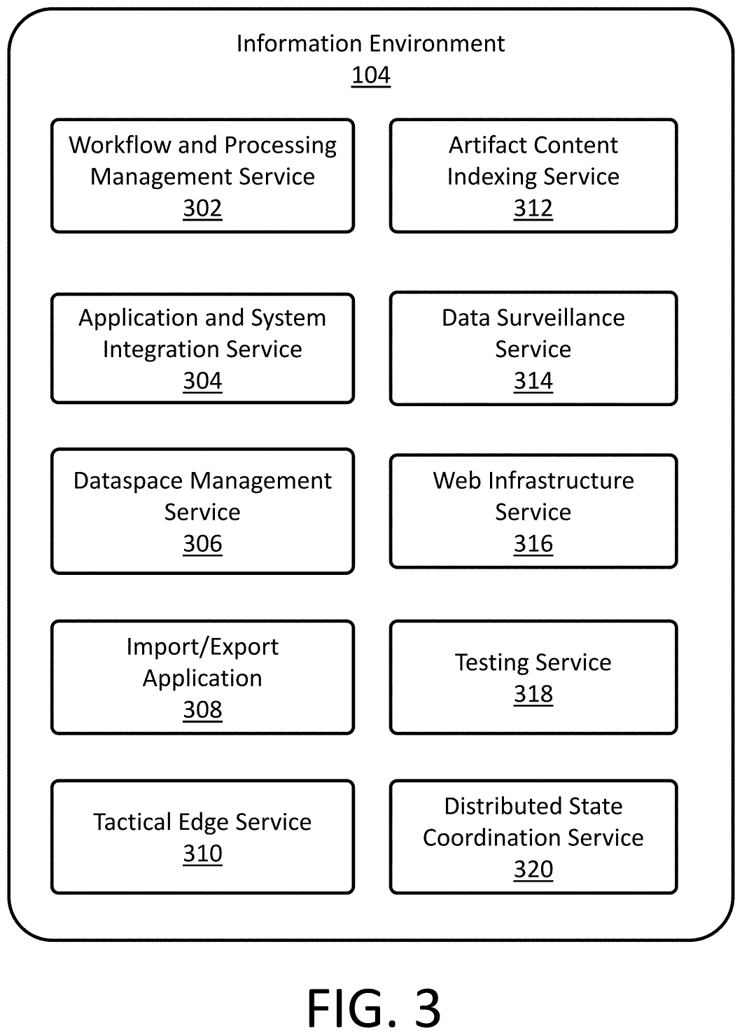

FIG. 3 depicts one embodiment of an information environment 104. In one embodiment, the system 100 may include an information environment 104. The information environment 104 may include a workflow and processing management service (WPMS) 302. The system 100 may support multiple business and management workflows. A workflow may include one or more actions arranged in a control dependency direct acyclic graph. A control dependency may include that a first action cannot execute until a second action is completed. A business workflow may be related to ingesting data into the dataspace, enriching the data of the dataspace, exploiting the data, or executing various data management activities. A management workflow may include a workflow related to operating, administrating, configuring, or monitoring the underlying infrastructure of the system 100. The WPMS 302 may support a business or management process.

In some embodiments, the WPMS 302 may collect analytics about an executing process. The WPMS 302 may execute background data management tasks, which may include indexing or validating data. The WPMS 302 may execute background system operation tasks such as creating backups, assessing security vulnerabilities, or determine computer cluster integrity. The WPMS 302 may schedule some of these tasks. The WPMS 302 may execute user-generated background tasks.

In one embodiment, the WPMS 302 may support workflow specification, visualization, or execution. The WPMS 302 may support task execution. The WPMS 302 may assist integration with certain cloud services such as a distributed file system. The WPMS 302 may assist in coordinating workflow execution, including simultaneous workflow execution. The WPMS 302 may monitor and log certain portions of workflows. The WPMS 302 may support workflow failure recovery. The WPMS 302 may support multiple task triggers such as user-initiated, time of day, an event (e.g., a file arriving at the system 100), a timer expiring, or other triggers.

In one embodiment, the WPMS 302 may include a workflow coordinator. The workflow coordinator may control workflow submissions, resubmissions, monitoring, or cancellations. The workflow coordinator may control one or more workflow nodes. A workflow node may include a control flow node or an action node. A control flow node may define the beginning and end of a workflow and may control the workflow execution path. An action node may trigger the execution of a processing task.

In some embodiments, the information environment 104 may include an application and system integration service (ASIS) 304. The ASIS 304 may integrate applications executing within the system 100. The ASIS 304 may integrate the system 100 with external systems.

In one embodiment, the ASIS 304 may execute as a job on a CAPN 210. The ASIS 304 may receive external data from outside the system 100 via the one or more interfaces of the CAPN 210 such as the HTTPS interface. An external system or a user may send the data to the ASIS 304 via the interface.

In another embodiment, the ASIS 304 may include a file transfer service (FTS). The FTS may distribute files across various network configurations. The FTS may receive data from outside the system 100. The FTS may send data from the system 100 to an external system. The FTS may support different protocols designed for different network situations. The FTS may support file or data compression, bandwidth limiting, or a secure transfer protocol (e.g., a protocol that uses encryption such as Advanced Encryption Standard (AES)). The FTS may execute as a background service or daemon. In one embodiment, the FTS may execute a transmit component that sends files or a receiving component that receives files. In some embodiments, configurations for the FTS may be stored in an extensible markup language (XML) file. One example of an FTS may include the SafeMove software (provided by the United States government).

In one embodiment, the ASIS 304 may interact with a dataspace management service (DSMS) 306 to move the external data into the dataspace. In some embodiments, the DSMS 306 may include logic and persistence data that implements one or more abstractions. The one or more abstractions may be defined in a data description framework (DDF). The DSMS 306 may operate as an abstraction layer on the dataspace. In some embodiments, the DSMS 306 may implement some services associated with relational database management such as automatic generation of indices, inverted indices, referential integrity determination, range determination for certain data columns.

In some embodiments, the DSMS 306 may include functions to access the dataspace. These functions may include inserting data into the dataspace, reading the dataspace, modifying data in the dataspace, or removing data from the dataspace. In some embodiments, inserting data into the dataspace may include the DSMS 306 receiving the external data from the ASIS 304 and writing the received data to the cloud unstructured storage via the CUSS 206.

In another embodiment, the system 100 may receive data from an import/export service 308. The import/export server 308 may receive data that has already been formatted, indexed, or otherwise processed such that the data is ready to be stored in a dataspace without further processing or with minimal further processing. The import/export service 308 may interact with the DSMS 306 to move the imported data into a dataspace of the system 100.

In some embodiments, the information environment 104 may include a tactical edge service (TES) 310. The TES 310 may provide a user access to dataspace data when the user may be unable to access the cloud environment 102 or may experience network connectivity difficulty in accessing the cloud environment 102.

In one embodiment, the TES 310 may include a proxy service. The proxy service may intercept requests between the user and the cloud environment 102. The proxy service may use a caching strategy to store data locally (e.g., in the local file system of the device executing the tactical edge application or a shared file server). The proxy service may cache frequently accessed data, recently accessed data, or other cloud data according the caching strategy. The proxy service may cache assertions created by the user or data ingested into the application at the direction of the user.

In one embodiment, when network connectivity is deteriorated, a user may create asynchronous search jobs. The proxy service may execute an asynchronous search job created by the user as the deteriorated network connectivity may allow. The proxy service may receive the search results and present them to the user. The proxy service may provide cached data to the user. The proxy service may receive ingest data or assertions from the user to asynchronously add to a dataspace.

In another embodiment, when the cloud environment 102 is unavailable to the user, the user may execute browsing jobs, search jobs on the cached data of the tactical edge application's host device. The user may insert assertions into the local data or send data to the proxy service for ingestion and the proxy service may ingest the data into the cached data. Once connection to the cloud environment 102 has been restored, the proxy service may forward cached assertions or data for ingestion to the cloud environment 102.

In some embodiments, the information environment 104 may include an artifact content indexing service (ACIS) 312. The ACIS 312 may create an index for a data artifact or other data ingested into the dataspace. The ACIS 312 may search the dataspace for data artifacts using one or more indices. The one or more functions of the ACIS 312 may be implemented by one or more components of the ACIS 312. In some embodiments, one or more components of the ACIS 312 may each execute as a job on a CCN 204. The CMS 202 may manage each ACIS 312 component executing on a CCN 204.

The ACIS 312 may include an artifact indexer component. The artifact indexer may include a long-running, standalone software application. In some embodiments, the artifact indexer may wait for a notification that a data artifact is ready to be indexed. For example, the DSMS 306, in response to receiving a data artifact into the mission dataspace 120 via one or more instances of the server ingest application 402 (discussed below), may send the notification to the artifact indexer. The data artifact may be stored in the data artifact storage segment 128 or the data artifact semantics segment 122 of the mission dataspace 120 using the CSSS 208. The notification may include an identifier that may specify the data artifact to be indexed, its location in the mission dataspace 120, or other identifying information.

The artifact indexer may access the data artifact to be indexed via the DSMS 306. The artifact indexer may index the data artifact. Indexing the artifact may include creating an alphabetical list of words, phrases or numerical information with references to where they occur in data artifacts. Indexes may also be inverted, with references being listed to one or more words, phrases or numerical information. One example of an artifact index may include LUCENE (provided by Apache), a standardized programmatic library for indexing.

In one embodiment, the ACIS 312 may include an index publisher component. The index publisher may publish an indexing file generated by one or more artifact indexers. The index publisher may publish the indexing file in response to a predetermined amount of time elapsing since the indexing file was created. The index publisher may publish the indexing file in response to the indexing file reaching a predetermined size. The predetermined amount of time or file size may be configurable by a user or a component of the system. In one embodiment, publishing the indexing file may include the index publisher copying the indexing file from the local storage of the host device to a predetermined area of the CUSS 206. The indexing file on the local storage may be deleted by the index publisher, artifact indexer, or other component.

In some embodiments, the ACIS 312 may include an index searcher component. An index publisher may notify an index searcher that an indexing file has been copied to the CUSS 206. The index searcher may use the copied indexing file to service an index search request. One example of an index searcher may include SOLR (provided by Apache).

In one embodiment, the ACIS 312 may include an index manager component. The index manager may execute as a long-running job on a CCN 204. The index manager may merge multiple unmerged indexing files that have been published by one or more index publishers. The index manager may merge the unmerged indexing files into one or more resulting merged files. The index manager may apply heuristics or logic to merge the multiple unmerged indexing files. The index manager merging the unmerged indexing files may include copying the unmerged indexing files of the CUSS 206 to the local storage of the host machine executing the index manager. Merging the unmerged indexing files may include the index manager merging the copied unmerged indexing files on the host machine. Merging the copied unmerged indexing files may include using MapReduce. In response to the merger of the unmerged indexing files, the index manager may copy the resulting one or more merged indexing files to the CUSS 206. The copying back to the CUSS 206 may include some cleanup logic of the previously unmerged indexed files. The index manager may delete the copied unmerged indexing files or the resulting merged indexing files from the local storage of the host machine executing the index manager. In some embodiments, an index searcher may copy one or more resulting merged indexing files from the CUSS 206 to the local storage of the host machine executing the index searcher.

In one embodiment, searching a data artifact in the mission dataspace 120 may include receiving a search request. In one embodiment, the DSMS 306 may send the search request to the index searcher. The DSMS 306 may receive a search request from a user (e.g., via the CAPN 210), external system (e.g., via the ASIS 304), or from a job executing within the system 100 (e.g., via an instance of the dataspace navigation and query application 506). The search request may include search criteria. Searching a data artifact may include an index searcher master receiving the search request. The index searcher master may obtain a list of index searcher workers, which may include one or more jobs executing one or more CCNs 204(1)-(n). One or more index searcher workers may include one or more indexing files stored on the local storage of the host device executing the index searcher worker. Searching a data artifact may include an index searcher worker searching the one or more indexing files of its local storage. Searching a data artifact may include the index search worker sending search results to the index worker master. The index worker master may merge the search results and return them to the DSMS 306.

In some embodiments, the DSMS 306 may apply filtering to enforce one or more authorization policies. The filtering may remove search results that the requester is not authorized to view or access.

In one embodiment, the ACIS 312 may include an index validator component. The index validator component may compare contents of an indexing file to one or more documents in the artifact semantics segment 122 of the mission dataspace 120. If a comparison of the contents of an indexing file to a document determines that the document has not been indexed or has been index improperly, the index validator may notify another component of the ACIS 312, such as an artifact indexer, to index the document.

In some embodiments, multiple instances of the index manager may execute. In another embodiment, the index manager may merge multiple unmerged indexing files into a single indexing file or into multiple indexing files. The index manager may merge different parts of different unmerged indexing files into the one or more merged indexing files.

In some embodiments, multiple instances of the artifact indexer may index a data artifact. The CMS 202 may start, monitor, or stop the instances. In one embodiment, each instance may include different functionality to index the data artifact.

In one embodiment, the information environment 104 may include a data surveillance service (DSS) 314. The DSS 314 may analyze ingested data and search for patterns in the data of the mission dataspace 120. The DSS 314 may generate data based on an observed pattern. The DSS 314 may store the generated data in the mission dataspace 120. A user or application may access the stored generated data. The DSS 314 may push the generated data to a user or application.

The DSS 314 may include a data watcher component. The data watcher component may observe changes to the mission dataspace 120. The data watcher component may include a pattern definition configuration. The pattern definition configuration may define a pattern the data watcher is to look for. The data watcher may report changes in the dataspace 120 according to the pattern definition. The data watcher component may report changes to a surveillance engine component.

The surveillance engine component may identify a pattern in data received from a data watcher component. The data received may include an event that occurred in the system 100. In response to the surveillance engine component identifying a pattern that the event may be a part of, the surveillance engine component may publish the event to other components of the system 100, notify other components, or initiate the execution of another application of the system 100.

In some embodiments, the information environment 104 may include a web infrastructure service (WIS) 316. The WIS 316 may include one or more web servers. A web server may act as an entry point into the cloud storage of the cloud environment 102. A web server may accept HTTP requests from applications (such as a web browser) and server HTTP responses. One example of a web server may include the APACHE HTTP server provided by Apache. The WIS 316 may include one or more application servers. An application server may host or execute server-side applications (such as the server ingest application 402 described below). An example application server may include TOMCAT (provided by Apache). The WIS 316 may include one or more portal servers. A portal server may include a platform for developing, delivering, or maintaining a web portal that may support personalizing user content or for aggregating information from various web applications. In some embodiments, the WIS 316 may include one or more directory servers. A director server may store profiles of users of the system 100, definitions of which users can access which environments, applications, services, or the like in the system 100, or other user information.

In one embodiment, the information environment may include a testing service 318. The testing service 318 may validate the behavior of one or more components of the system 100 to determine whether the component is behaving properly based on testing criteria. The testing service 318 may provide an environment in the system 100 to test the one or more components.

In some embodiments, the testing service 318 may evaluate component behavior and performance when data is loaded or enriched. The testing service 318 may determine whether software or system upgrades or modifications function properly. The testing service 318 may test component behavior in response to the detection of a fault in the system 100. The testing service 318 may execute tests to monitor the health of a system 100 component.

The testing service 318 may capture test output data for evaluation and comparison. The testing service 318 may play back preconfigured test scenarios. The testing service 318 may generate sample data from existing data for use in testing. The testing service 318 may maintain a library of tests, test drivers, testing data, or other testing information.

In one embodiment, the information environment 104 may include a distributed state coordination service (DSCS) 320. One or more services or applications in the system 100 may include distributed computing capabilities. The DSCS 320 may coordinate distributed computing information between distributed components. Coordinating distributed computing information may include sharing and broadcasting state information.

In some embodiments, the DSCS 320 may be initiated and monitored by the CMS 202. The DSCS 320 may use the CUSS 206 to persist state information. Some applications and services that may include distributed computing capabilities may include the CSSS 208, the ACIS 312, or the SIA 402. The DSCS 320 may use one or more security environment 112 (discussed below) components to enforce security.

The DSCS 320 may include one or more distributed coordination processes to coordinate state among each other. Each distribute coordination process may know about the other distributed coordination process. State information stored by a distributed coordination process may be stored by the CUSS 206 in the operational dataspace. Each distributed coordination process may include a coordination component. The coordination component may coordinate traffic between the multiple distributed coordination processes. A distributed application or service may be in data communication with a distributed coordination process. The data communication may be through a transmission control protocol (TCP) connection. The distributed application or service may send requests to interact with other distributed applications through their respective distributed coordination processes. The requests may include reading the state of the distributed process, updating the state, or watching the state for changes.

In some embodiments, the information environment 104 may include a domain name system (DNS) service or a network time protocol (NTP) service. The DNS service may include a hierarchical naming system and may translate domain names into numerical identifiers compatible with the components of the system 100. The NTP service may synchronize the clocks of the devices of the system 100.

### Server-side Environment

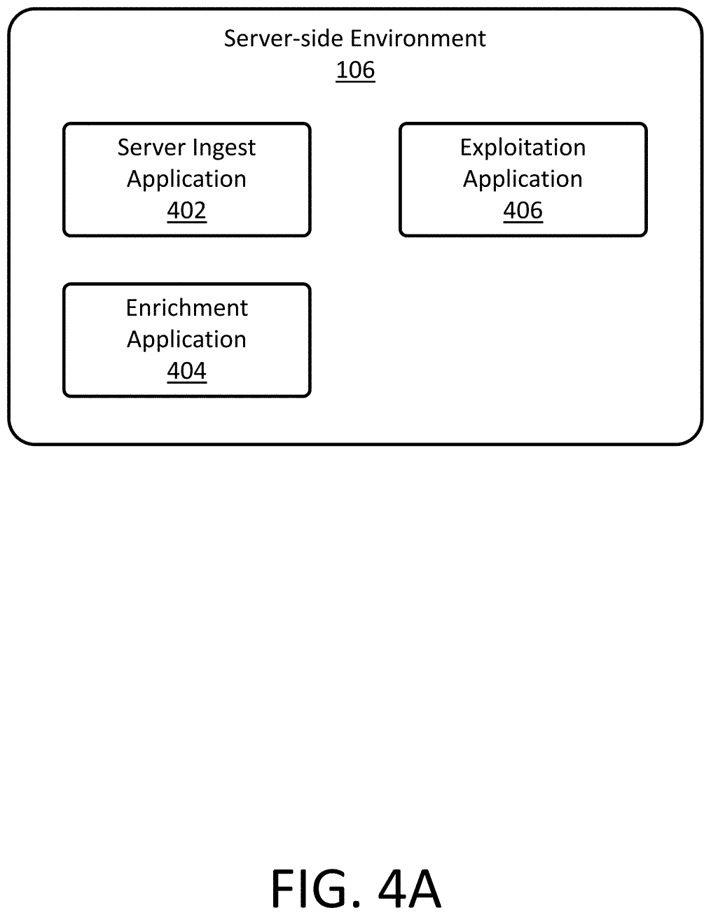

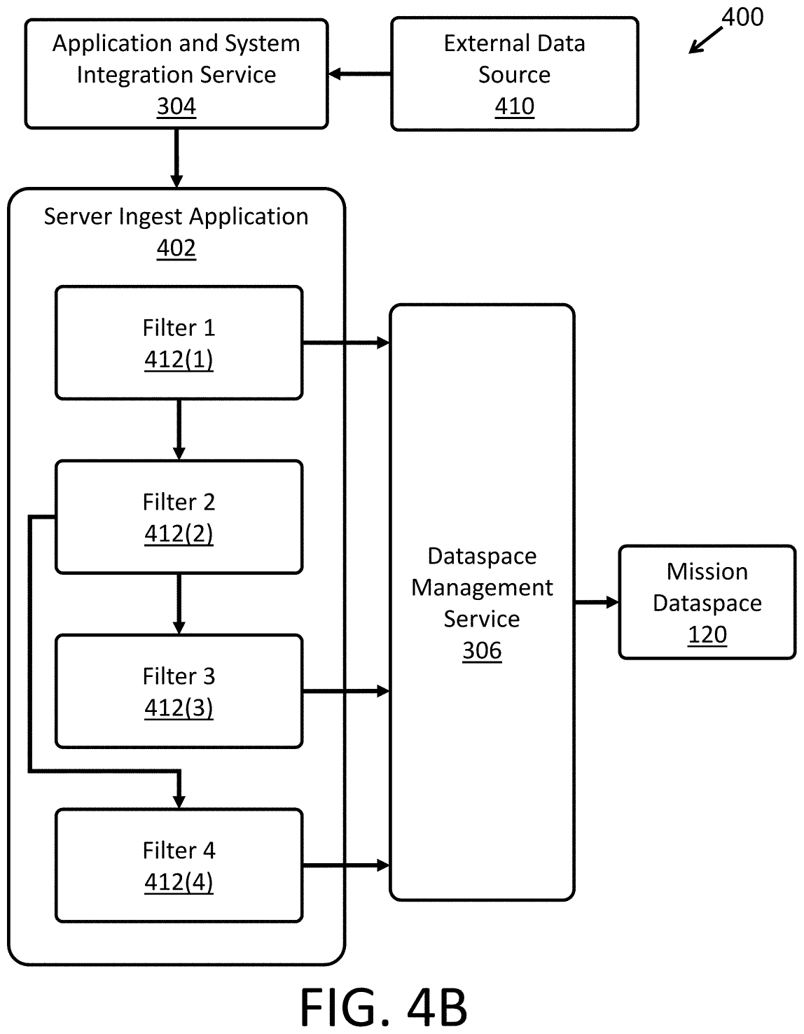

FIG. 4A depicts one embodiment of a server-side environment 106. In one embodiment, the system 100 may include a server-side environment 106. The server-side environment 106 may include one or more software applications that may carry out functions of the system 100. In one embodiment, the server-side environment 106 may include a server ingest application (SIA) 402. The SIA 402 may process data stored in the mission dataspace 120. The SIA 402 may process data in various formats such as unstructured data, semi-structured data, or structured data. In some embodiments, different implementations of the SIA 402 may process different types of data.

Structured data may include data stored in a relational database; data that adheres to a rigid data or object model; or data that conforms to a semantic ontological representation. Semi-structured data may include text files with structured elements such as tables or lists of information; emails that contain structured header information and unstructured subject or body contents; hypertext markup language (HTML) files that conform to a particular HTML specification and also contain natural language or imagery; extensible markup language (XML) files that contain data segments that are unstructured; or other data. Unstructured data may include imagery, including pictures, geospatial imagery, full motion video, or other imagery related information; data represented in an unknown binary format; audio data represented in a digital form; or other data.

The SIA 402 may write certain metadata to the data semantics segment 124. The SIA 402 may write disambiguated entities (or terms) into the data semantics segment 124.

In one embodiment, the SIA 402 may process unstructured data. Processing unstructured data may include the SIA 402 writing the data artifact containing the unstructured data to the data artifact semantics segment 122. The SIA 402 may remove duplicated data (e.g., one or more data artifacts being ingested or included in a segment of the mission dataspace 120, where the removed data artifact may contain the same content). The SIA 402 may write data artifact metadata to the data artifact semantics segment 122. The data artifact metadata may include metadata about the data artifact such as a file name, size, data source, date created or modified, or other metadata. The SIA 402 may write disambiguated data elements into the data semantics segment 124.

In some embodiments, the SIA 402 may process structured data. In one embodiment, the SIA 402 processing structured data may include the SIA 402 accessing a relational database system catalog to determine structure of entities being processed. The SIA 402 may write the processed structured data into the data semantics segment 124. The SIA 402 may write the data based on data from the catalog, such as schema, datatype, column, or other structure data. In one embodiment, the SIA 402 may write source model elements and corresponding metadata into the data model semantics segment 126 or may write source data and corresponding metadata into the data semantics segment 124. The SIA 402 may maintain one or more performance metrics for processing the structured data or may maintain health data corresponding to ingested data.

In one embodiment, the SIA 402 may process semi-structured data. Processing semi-structured data may include a combination of processing methods for structured and/or unstructured data, where the semi-structured data is deconstructed into its structured and unstructured elements for processing. For example, if a data artifact comes from a semi-structured data source, the SIA 402 may write source-specific metadata (e.g., for an email, the “from” tag) into the data semantics segment 124.

In some embodiments, the SIA 402 may execute in response to the WPMS 302 executing a workflow that includes the SIA 402 or may executed in response to the CMS 202 executing the WPMS 302 on a CCN 204. Different components of the WPMS 302 may execute on different CCNs 204(1)-(n).

In another embodiment, the SIA 402 may implement a Pipe-and-Filter architecture. This SIA 402 may include a pump component. In one embodiment, the pump may include a data source or may receive data from a data source. The data source may include the FTS of the ASIS 304, a real-time data feed, or a remote system via an integration bridge. The pump may monitor one or more data sources for available data. The pump may send data to one or more pipe components.

The SIA 402 may include a pipe component. A pipe may receive data (e.g., from the pump or a filter). The pipe may buffer received data until a downstream component (e.g., a filter) is ready to process the data. A pipe may receive data from one or more components of the SIA 402. A pipe may send data to one or more components of the WPMS 302.

The SIA 402 may include a filter component. The SIA 402 may include multiple filter components that execute simultaneously. A filter may wait for data to arrive or may periodically poll another component for available data. A filter may read data from one or more input pipes, perform its function of the data, and send the processed data to one or more output pipes. In some embodiments, the filter performing its function may include transforming or filtering the data. Transforming or filtering the data may include message processing, parsing, or tokenizing. Transforming or filtering the data may include populating a portion of the dataspace or indexing the data. In one embodiment, a filter may include a long-running logical process that may be started or monitored by the CMS 202.

In some embodiments, the SIA 402 may include a sink component. The sink may send processed data to a data target. The data target may include a file, database, or an application. In some embodiments, each of the pump, pipe, filter, and sink components may execute on a CCN 204 and managed by the CMS 202

In one embodiment, the SIA 402 may scale to respond to differing data ingest conditions. For example, in response to the system 100 receiving large numbers of external files to be placed in the dataspace, the SIA 402 may coordinate with the CMS 202 to execute multiple pumps, filters, pipes, and sinks to process the external data. Multiple instances of filters with the same functionality may execute to process the data faster than one filter with that functionality. In response to a new type of file being ingested, the SIA 402 may implement a new type of pump component or filter component to process the file. The SIA 402 (or another component) may split a file to be ingested into multiple pieces so that the components of the SIA 402 may process different parts of the file simultaneously.

In one embodiment, the server-side environment 106 may include a data enrichment analytic application 404 (hereinafter, “enrichment application 404”). The enrichment application 404 may process a previously ingested data artifact. The enrichment application 404 processing the data artifact may include extracting data elements from the data artifact and processing the data elements. Processing the data elements may include locating mentions, generating signs based on mentions, generating concepts based on source data models, disambiguating mentions using one or more concepts and generating terms based on the disambiguating, associating one or more data elements from the data artifact with signs, concepts, terms, or statements already in the mission data space 120. The enrichment application 404 may apply syntactic, semantic, and discourse processing to a data artifact or data element. The data artifact may be stored in the artifact semantics segment or the artifacts storage segment. The enrichment application 404 may identify an assertion about data elements, such as entities, events, relations, qualifications, or other factual information included in the data elements of the data artifact. The enrichment application 404 may store such data elements in the data semantics segment of the mission dataspace. The enrichment application 404 may use statistical language models, parameter files, gazetteers, artificial intelligence models, machine learning models, or other processes to enrich data in the dataspace. The enrichment application 404 may identify information about a data artifact such as a classification of the data artifact based on the data elements of the data artifact, may identify whether the data artifact includes information that is relevant to a certain topic, or identify whether the data artifact deserves further, more detailed analysis.

As an example, the enrichment application 404 may process a data artifact that is a text file. The enrichment application 404 may extract strings of text from the text file as mentions. The enrichment application 404 may determine whether a sign corresponding to the mention is already in the mission dataspace 120. If it is not, the enrichment application 404 may add the sign to the mission dataspace 120. The enrichment application 404 may disambiguate each mention by associating each mention in the text file with a concept. The enrichment application 404 may disambiguate a mention using semantic analysis, machine learning, artificial intelligence (AI), or other techniques. The enrichment application 404 may generate one or more statements based on the disambiguating or other data. The enrichment application 404 may generate metadata about the generated data elements from the text file. The enrichment application may store generated data elements or metadata in the mission dataspace 120.

In one embodiment, the server-side environment 106 may include a data exploitation analytic application 406 (hereinafter, “exploitation application 406”). The exploitation application 406 may read and analyze data from the data artifact semantics segment 122, data semantics segment 124, or data model semantics segment 126 of the mission dataspace. The exploitation application 406 may analyze the data from these segments to derive one or more patterns in the data, discover data associations or relationships between data elements, and store these derived patterns or discovered associations in the data semantics segment 124 or the data artifact semantics segment 122. The exploitation application 406 may combine or filter data extracted from multiple data artifacts to generate an assertion related to the data.

In one embodiment, the exploitation application 406 may roll back data generated by the exploitation application's 406 functionality. For example, the exploitation application 406 may derive a pattern or discover a data association or relationship between data elements of a group of data artifacts and may store data based on the pattern or association or relationship. The exploitation application 406 may perform this functionality in response to a data artifact being added to the group or a data artifact in the group being modified or removed. A data artifact in the group of data artifacts may be rolled back to a previous version or removed from the group or dataspace. In response, the exploitation application 406 may roll back the data based on the pattern, association, or relationship to a previous version of the data that pertains to the rolled back version of the data artifact or group.

In some embodiments, some of the enrichment or exploitation functionality described in relation to the enrichment application 404 or exploitation application 406 may be performed by the SIA 402 (e.g., as part of a filter component). Some of the SIA 402 functionality may be performed by the data enrichment application or exploitation application 406.

FIG. 4B depicts one embodiment of a portion 400 of the system 100. As can be seen from FIG. 4B, the system 100 may include the ASIS 304, the SIA 402, the DSMS 306, and the mission dataspace 120. The SIA 402 may include a plurality of filter components 412. The plurality of filter components 412 may include a first filter 412(1), a second filter 412(2), a third filter 412(3), and a fourth filter 412(4). The arrows of FIG. 4B depict an exemplary flow of data between the exemplary components of the system 100.

The ASIS 304 may receive a data artifact from an external data source 410. The ASIS 304 may send the received data artifact to the SIA 402. The SIA 402 may send the data artifact to the first filter 412(1). The first filter 412(1) may generate metadata about the data artifact. The first filter may send the generated metadata to the DSMS 306, which may store the metadata in the mission dataspace 120 in the artifact semantics segment 122. The first filter 412(1) may send the data artifact to the second filter 412(2).

The second filter 412(2) may remove duplicate data from the data artifact. In some embodiments, a filter 412 that removes duplicate data may not send data to the DSMS 306 as is shown in FIG. 4B. The second filter 412(2) may send the data artifact (without the duplicate data) to the third filter 412(3). The third filter 412(3) may process structured data in the data artifact. The third filter 412(3) may generate data model metadata and send the data model metadata to the DSMS 306 for storage in the data model semantics segment 126 of the mission dataspace 120.

The second filter 412(2) may also send the data artifact to the fourth filter 412(4). The fourth filter 412(4) may generate disambiguated data elements and store them in the data semantics segment 124 of the mission dataspace 120 via the DSMS 306.

### Mission Application Environment

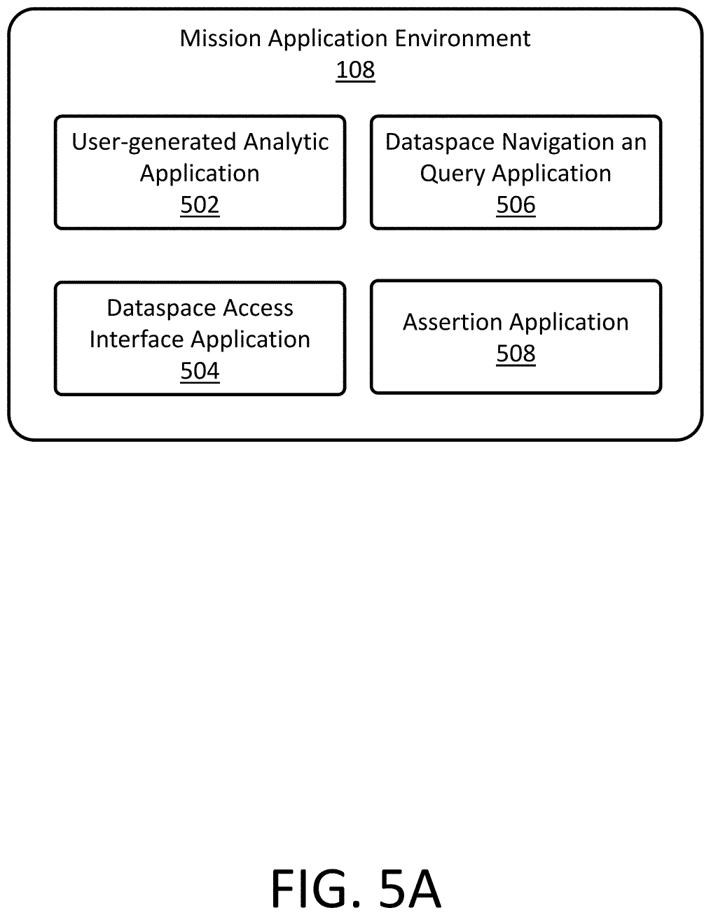

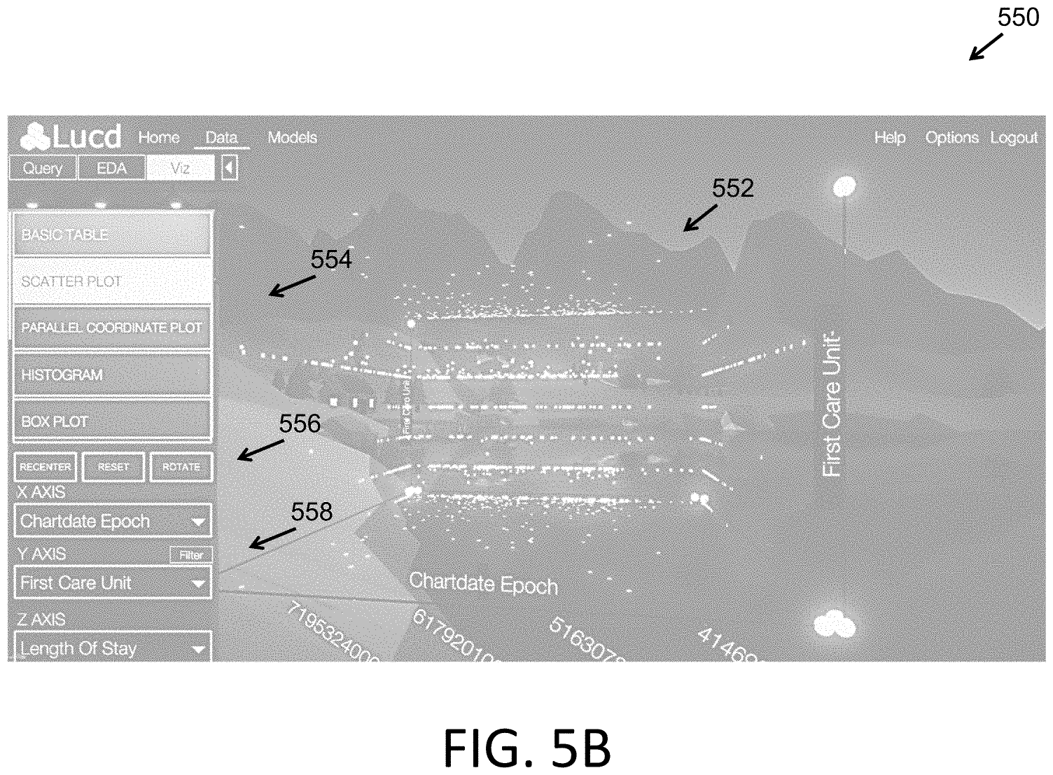

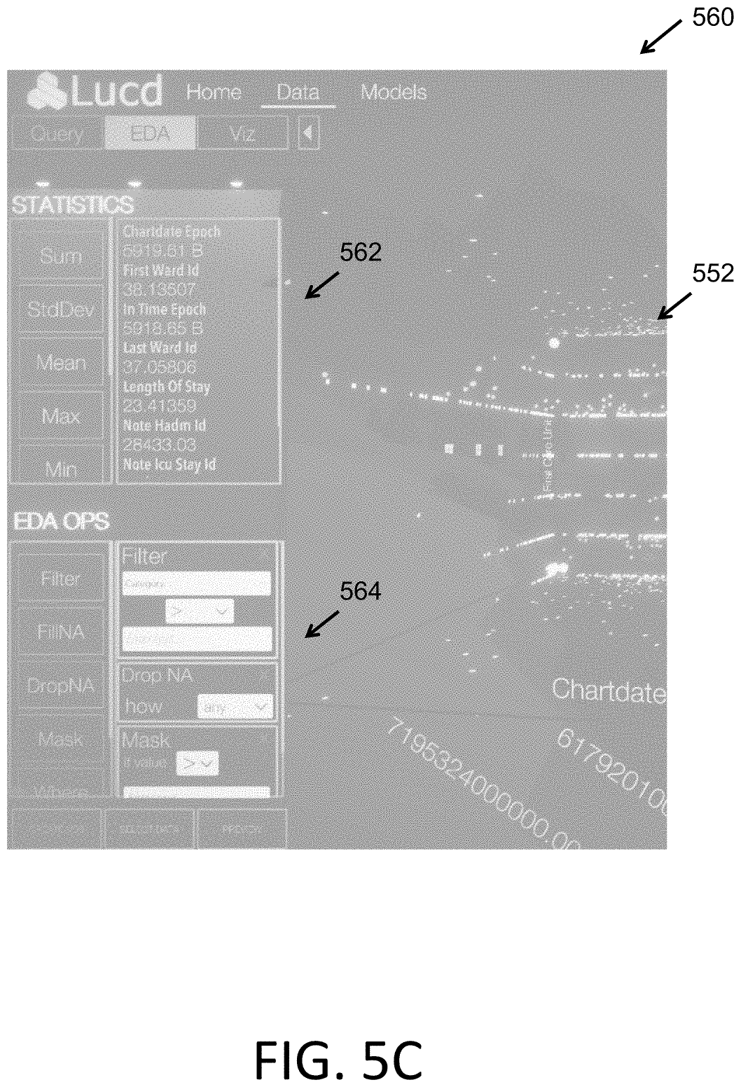

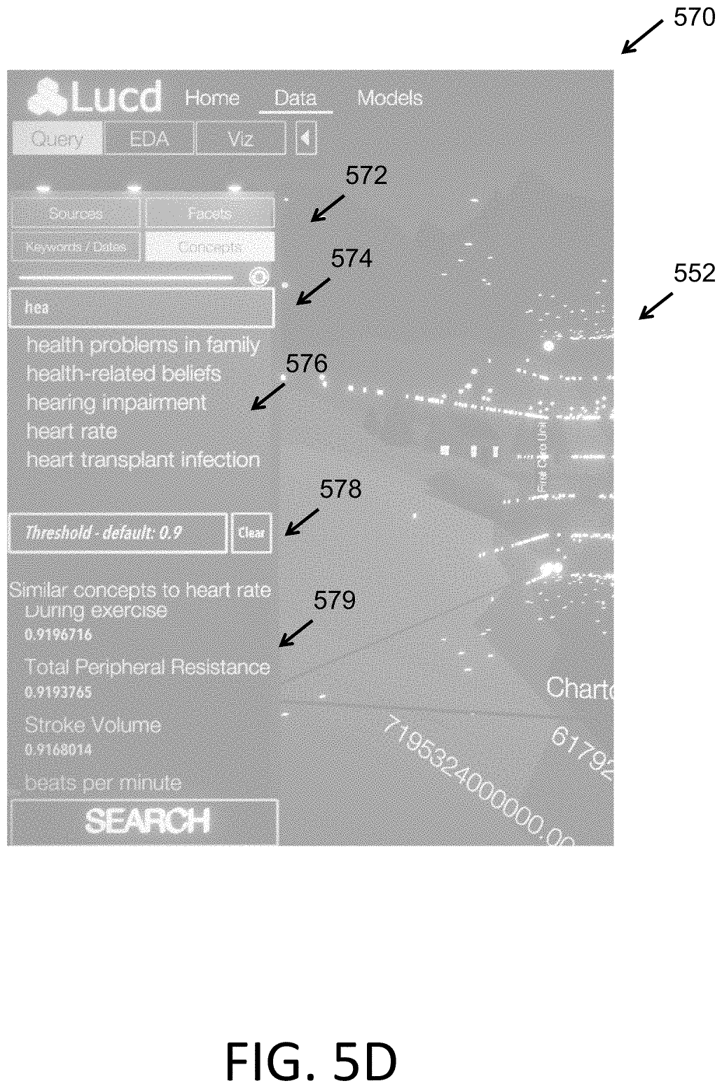

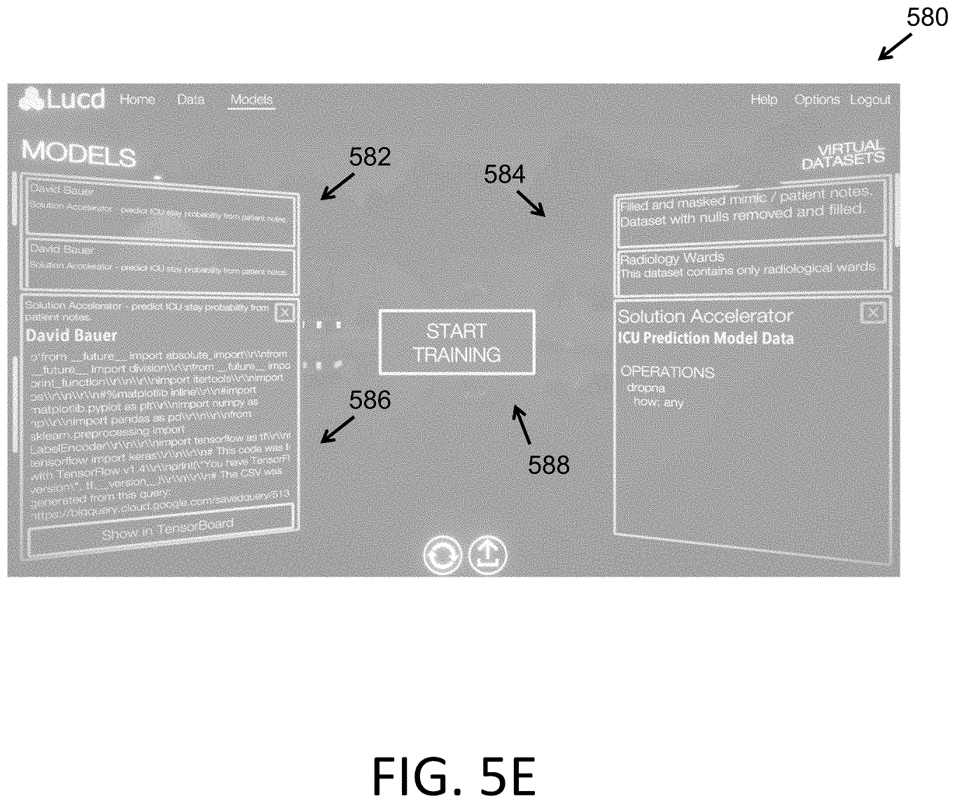

FIG. 5A depicts one embodiment of a mission application environment 108. In some embodiments, the system 100 may include a mission application environment (MAE) 108. The MAE 108 may include one or more mission applications. A mission application may include an application executing on one or more CCNs 204(1)-(n). A mission application may include an application that interacts with the mission dataspace 120. A mission application may include an application that may be generated, initiated, or used by a user of the system 100.

In one embodiment, the MAE 108 may include a user-generated analytics application 502. The user-generated analytics application may process data in the mission dataspace 120, read and analyze the data, and may derive patterns or discover relationships based on a configuration of the user-generated analytics application 502.

In one embodiment, the MAE 108 may include a dataspace access interface (DAI) 504. The DAI 504 may include an interface used by an end user for accessing information in the mission dataspace. The DAI 504 may include an application that interacts with the DSMS 306 to access the data in the mission dataspace. Accessing the data in the mission dataspace may include reading data from and writing data to the mission dataspace. The DAI 504 may execute on a CCN 204.

In some embodiments, the CAPN 210 may redirect a request for interact with the mission dataspace to the DAI 504. The DAI 504 may include a REST interface. In one embodiment, the DAI 504 may initiate a plurality of REST nodes on a plurality of CCNs 204(1)-(n). The CMS 202 may manage the plurality of REST nodes. The DAI 504 may include a load balancing component. The load balancing component may direct requests to the DAI 504 to a particular REST node. In one embodiment, the DAI 504 may include an HTTP level cache. Identical requests sent to the DAI 504 may be served from the HTTP level cache to reduce response times.

In some embodiments, the MAE 108 may include a dataspace navigation and query application (DNQA) 506. The DNQA 506 may include an application with a graphical user interface (GUI). The GUI may present data in the mission dataspace 120 in a graphical way. The GUI may allow a user to add data to or modify data in the mission dataspace in a graphical way. The GUI may include a plurality of features, including data visualizations such as charts or graphs (e.g., 2D, 3D or higher scatter graph, Q-Q graph, T-SNE, Pivot chart, Correlation graph); network representations of data; displaying data overlaid on a map, image, video or audio recording; or other visualizations. The GUI may include representations of characteristics of the data displayed as charts or graphs; statistics, or in plain form (e.g., results of a summation across all data features contained within a dataset, or a set of features contained with a search result). The GUI may include features that enable a user to modify a set of data, such as removing duplicate data items; merging similar data items; filling, filtering or removing missing data features, or other data manipulations. The GUI may include representations of data in its original form. The GUI may include the representation of data sets created through the process of searching or querying across larger data sets; created through a process of data manipulation, possibly including joining or splitting one or more data sets; created through a process of data analysis; or other processes. The GUI may include representations of process workflows and lifecycles that can be manipulated by the user, for example, executing the training, testing or serving of neural network models in the platform.

FIG. 5B depicts one embodiment of a GUI. The GUI may include a GUI of the DNQA 506 or the GUI may be part of another component of the system 100. The GUI may include one or more interaction components that may allow a user of the system 100 to interact with the data in the mission dataspace 120, search the mission dataspace 120, run analytics on data in the mission dataspace 120, execute AI, machine learning, or data models, or control other functionality of the system 100.

In one embodiment, the GUI may include a visualization view 550 as shown in FIG. 5B. The visualization view 550 may include a graph 552. The graph 552 may plot data based on data in the mission dataspace 120. The visualization view 550 may include a plurality of plot selection buttons 554. The plurality of plot selection buttons 554 may allow the user to select which kind of graph to display. The kinds of graphs may include a table, a scatter plot, a parallel coordinate plot, a histogram, a box plot, or another type of graph. The visualization view 550 may include a plurality of view configuration buttons 556. A view configuration button may include a button to re-center, reset, or rotate the view of the graph 552. The visualization view 550 may include a plurality of axis selection components 558. An axis selection component may include a drop-down box or other selection mechanism to select what data is associated which axis of the graph 552.

FIG. 5C depicts one embodiment of the GUI. The GUI may include a data view 560. The data view 560 may include the graph 552. The data view 560 may include a statistics widget 652. The statistics widget 562 may include a plurality of buttons that allow the user to select which statistic to display about the graph 552, the data associated with the graph 552, or a dataset in the mission dataspace 120. A statistic may include a sum, a standard deviation, a mean, a maximum, a minimum, or another statistic. The statistic widget may display the statistic for one or more dimensions of the graph 552, dataset, or other data. The data view 560 may include an exploratory data analysis (EDA) operations (OPS) widget 564. The EDA OPS widget 564 may include buttons, drop down boxes, or other interactive components that may allow a user to manipulate the data of the graph 552, the dataset, or other data. In one embodiment, the EDA OPS widget 564 may allow a user to filter data based on a value of the data (e.g., the value being greater than, less than, or equal to a user-selected value) (in FIG. 5C, the “Filter” button), fill empty values with a specified value (“FilINA”), drop data containing an empty value (“DropNA”), mask data that satisfy a user-specified criteria (“Mask”), drop duplicate data, or partition data based on a user-specified criteria.

FIG. 5D depicts one embodiment of a query view 570. The query view 570 may allow a user to search the mission dataspace 120, the data being visualized by the graph 552, or other data. The query view 570 may include the graph 552. The query view 570 may include a plurality of query type selection buttons 572. A query type selection button may allow a user to select what kind of data to search. For example, the plurality of query type selection buttons 572 may include a button to search for a data source, search for a data facet, search by keyword, search by date, search by concept, or other search selection functionality.

The query view 570 may include a search bar 574. The user may type his or her query into the search bar 574. The query view may include a search suggestion dropdown 576. The search suggestions dropdown 576 may auto-populate with suggested search queries based on what the user has typed in the search bar 574. The query view 578 may include a related content configuration bar 578. The user may select, in the related content configuration bar 578, a threshold cutoff for computing the distance to related content from the selected content. For example, as depicted in FIG. 5D, the user may have selected the “heart rate” concept from the search suggestions dropdown 576. Other concepts may be related to the concept of “heart rate” and the other concepts may each include a calculated distance from the “heart rate” concept. In one embodiment, a higher distance value may indicate that the concept is more closely related. The query view 570 may include a related content search result list 579. The related content search result list 579 may display the results of the related content search.

FIG. 5E depicts one embodiment of a models view 580. In one embodiment, the models view 580 may include a model selection widget 582. The model selection widget 582 may display the name of an AI, machine learning, or data analytic model that can be used to execute on selected data. The user may select a button in the model selection widget 582 to select which model to execute. The models view 580 may include a dataset selection widget 584. The dataset selection widget 584 may display available datasets that can be used with a model for training, inference calculation, or other model functionality. The dataset selection widget 584 may display a configuration for the dataset. A configuration may include a configuration about dropped values, masked values, filtered values, filled values, or other configurations. The configurations may be based on the EDA OPS widget 564.

In some embodiments, the model view 580 may include a console display 586. The console display 586 may display one or more lines of computer code that is executing, has been executed, or may be executed. The console display 586 may allow a user to view the computer code for debugging purposes or some other purpose. The model view 580 may include a start training button 588. A user may click the button to start the training of the AI, machine learning, or data analytics model. In some embodiments, the start training button 588 may change to a stop training button after the training begins.

Returning to FIG. 5A, in one embodiment, the MAE 108 may include an assertion application 508. The assertion application 508 may manage one or more assertions of the mission dataspace. In some embodiments, an assertion may include a computer program or service, a set of program instructions, or other computer functionality. The assertion may determine read in data and determine whether the data conforms to a certain condition. In response to the data not conforming to the condition, the assertion may perform an action. The action may include rejecting the data, notifying another application, service, or other component of the system 100, or another type of action.

A user may insert, modify, or remove an assertion via a CAPN 210. The CAPN 210 may provide an interface to the user based on the location of the assertion. For example, if the mission dataspace includes the assertion, then the DNAQ 506 or DAI 504 may provide the assertion insertion/modification/removal functionality. The DSMS 306 may provide an interface for the mission dataspace to the CAPN 210, DNAQ 506, or DAI 504. In some embodiments, another component of the system 100 may provide a user with an interface for assertions in the system 100.

In one embodiment, the assertion may include an assertion on data being ingested into the mission dataspace. For example, a filter component of the SIA 402 may include an assertion. The assertion may include a condition that structured data elements being ingested conforms to a certain data model. In response to one or more ingested data elements not conforming to the data model, the assertion may reject some of the ingested data and notify the user. Rejecting the data may include the data elements or a data artifact including those rejected data elements not being added to the mission dataspace.

In other embodiments, an assertion may include an assertion on data in the mission dataspace. The assertion may include a condition pertaining to a certain data artifact or one or more data elements. If the data artifact or data elements are modified in the dataspace (e.g., by a user via the DAI 504 or by another application executing on the system 100) or an attempt to modify the data artifact or data elements is made, the assertion may determine whether the modification conforms with the one or more conditions of the assertion. In response to the modified data not conforming to one or more conditions of the assertion, the assertion may reject the modifications.

In one embodiment, the enrichment application 404 may add an assertion to the mission dataspace. The assertion may be associated with a disambiguated data element, metadata, a data model, a concept, or some other type of data element. An assertion may be any information associated with a data element. Assertions may be based on implicit or explicit claims or representations of a data element. An assertion may be determined through a process of data extraction, enrichment, enhancement, analysis by mathematical or algorithmic program, or other forms of data analysis. An example of an assertion, for the data term “aspirin”, might be “medicine”. The enrichment application may associate an assertion with data the enrichment application 404 may generate as part of its data enrichment functionality.

In one embodiment, an assertion may be rolled back. The assertion application 508 may roll back an assertion by returning the assertion to a previous version or by removing the assertion. A previous version of the assertion may include one or more previous conditions that were later modified or removed. The assertion application 508 may roll back an assertion in response to the data associated with the assertion being rolled back.

### Management Environment

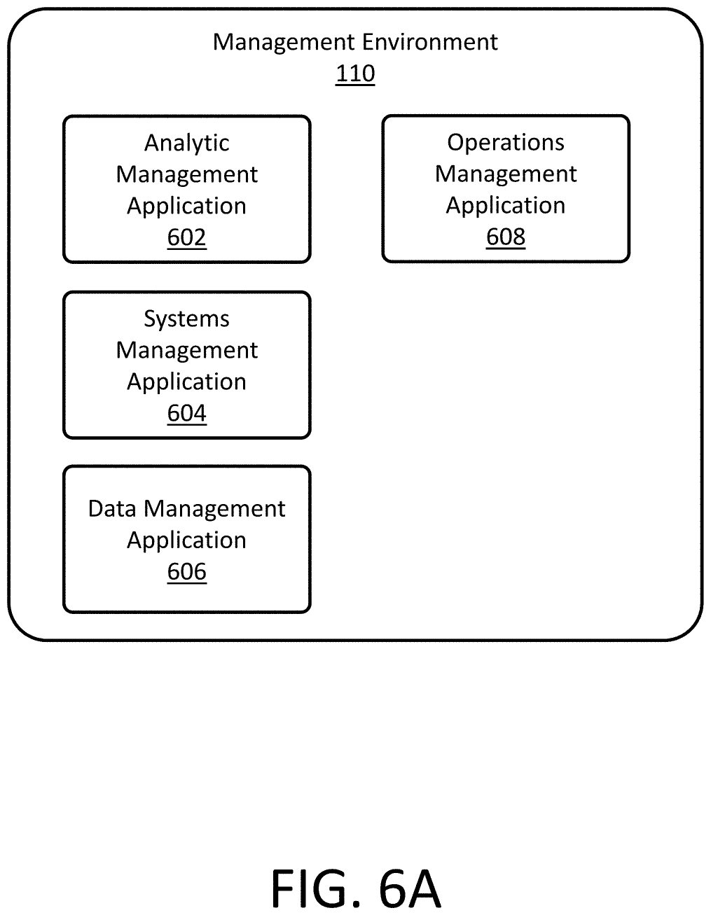

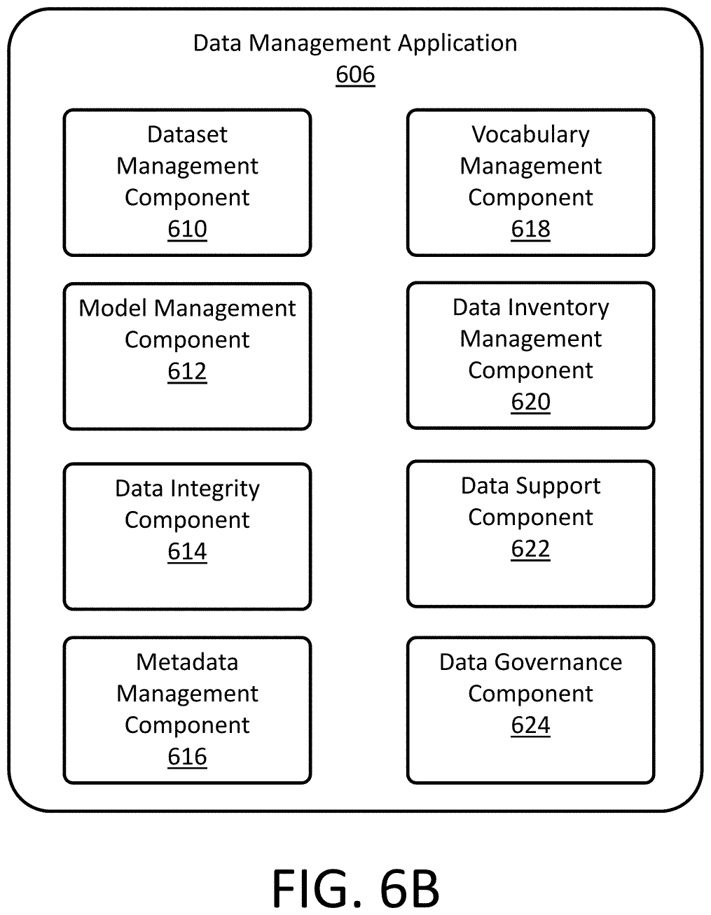

FIG. 6A depicts one embodiment of a management environment 110. In some embodiments, the system 100 may include a management environment 110. The management environment 110 may include one or more applications that manage applications executing in the system 100.

In one embodiment, the management environment 110 may include an analytic management application 602. The analytic management application 602 may manage one or more analytic applications. An analytic application may include the enrichment application 404, the exploitation application 406, or a user-generated analytic application. In one embodiment, the analytic management application 602 may manage the training of one or more analytical models. An analytical model may include a statistical language model, parameter files, gazetteer, artificial intelligence model, machine learning model, or other type of model. The analytic management application 602 may manage training data (e.g., add new training data to a training data pool, remove outdated training data), execute a training functionality of an analytical model using the training data, or perform other training data functions. As an example, the analytic management application 602 may configure an analytical model based on the deep learning optimization techniques described below. Feedback from an analytical model, configurations of an analytical model, or other data derived from the training process may be stored in the operational dataspace.

The management environment 110 may include a systems management application 604. The systems management application 604 may gather and process data related to the health, status, and events of one or more components of the cloud environment 102. The systems management application 604 may receive data from the CMS 202.

In one embodiment, the management environment 110 may include a data management application 606. FIG. 6B depicts one embodiment of a data management application 606. The data management application 606 may include a dataset management component 610. The dataset management component 610 may maintain a catalog of datasets. The dataset management component 610 may maintain metadata about a source or nature of a dataset. A dataset may include a standard dataset. The dataset management component 610 may import a dataset into a dataspace. The dataspace may include the mission dataspace or operational dataspace. The dataset management component 610 may generate or update metadata based on the imported dataset. The dataset management component 610 may manage modifications to a dataset.

The data management application 606 may include a model management component 612. The model management component 612 may include a library of data models. The model management component 612 may support change control of a data model and related metadata. Related metadata may include a data dictionary.

The data management application 606 may include a data integrity component 614. The data integrity component 614 may determine whether certain metadata is present and properly populated for a data artifact, data element, data model, or other data objects. The data integrity component 614 may support maintenance or checking of data integrity in the mission dataspace. The data integrity component 614 may include one or more assertions to perform its functionality.

In some embodiments, the data management application 606 may include a metadata management component 616. The metadata management component 616 may update metadata. The metadata may include metadata about other metadata. The metadata management component 616 may maintain a catalog of the metadata. The metadata management component 616 may support predicate management.

The data management application 606 may include a vocabulary management component 618. The vocabulary management component 618 may define a controlled vocabulary. The vocabulary management component 618 may manage one or more roles or permissions for interacting with the controlled vocabulary. Such roles or permissions may indicate who can access different parts of the vocabulary, which users can modify the vocabulary, or other roles or permissions. The vocabulary management component 618 may import portions of the controlled vocabulary from or export to external systems. The vocabulary management component 618 may import or export via the ACIS 312, import component, or export component. The vocabulary management component 618 may enrich metadata.

The data management application 606 may include a data inventory management 620 component. The data inventory management component 620 may generate an inventory of data in a dataspace. The data inventory management component 620 may collate metadata to show a user what a certain data element means or where the data element is located in a data artifact or cloud storage.

The data management application 606 may include a data support component 622. The data support component 622 may maintain a knowledge base of data questions and answers or other information about data in a dataspace. The data support component 622 may interact with a help desk component.

The data management application 606 may include a data governance component 624. The data governance component 624 may define one or more procedures for handling data in a dataspace. The data governance component 624 may store information on roles or responsibilities for data objects. A user may consult the stored information. The stored information may include data trustees on business-related issues. The data governance component 624 may provider management capabilities to permit communications to be coordinated among users for certain data objects.

In some embodiments, the management environment 110 may include an operations management application 608. The operations management application 608 may manage the one or more testing components of the system 100 (e.g., the testing service 318). The operations management application 608 may manage one or more security components (such as one or more components of the security environment 112).

In one embodiment, the operations management application 608 may include a software configuration and deployment component (SCDC). The SCDC may determine whether a piece of software, such as an application (operational or mission) that executes in the system 100, is up-to-date and current in its configurations. The SCDC may generate one or more reports based on the results of its determinations. The SCDC may retrieve software updates (e.g., from an internal data store of the system 100 or an external system) and update one or more pieces of software using the retrieved updates.

### Security Environment

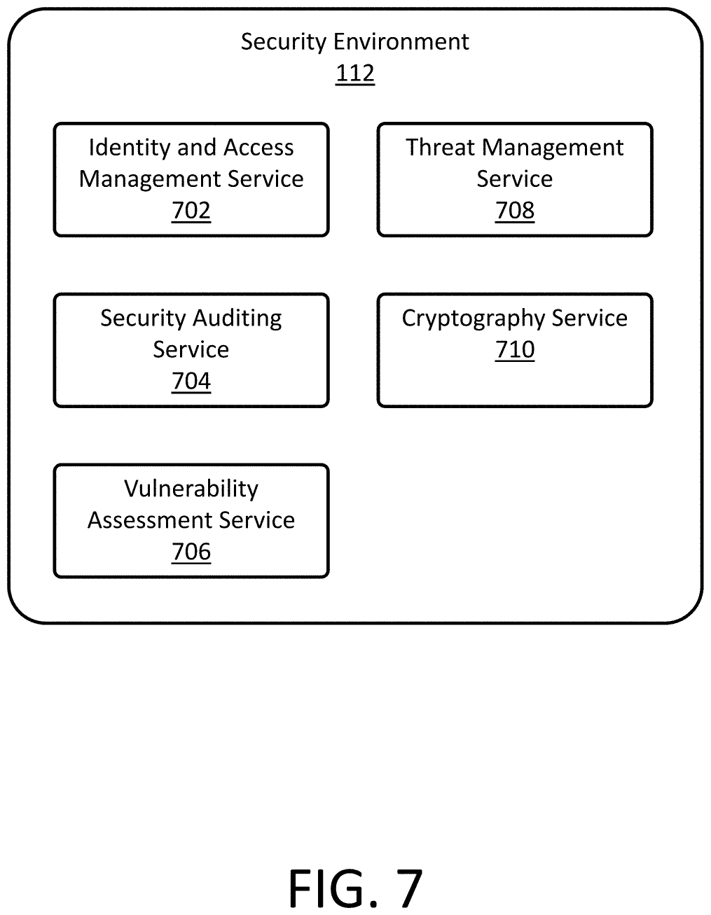

FIG. 7 depicts one embodiment, of a security environment 112. In one embodiment, the system 100 may include a security environment 112. The security environment 112 may include one or more services that may provider security functionality for the system 100. In one embodiment, the security environment 112 may include S IMP.

In one embodiment, the security environment 112 may include an identity and access management service (IAMS) 702. The IAMS 702 may enforce access control policies within the system 100. The IAMS 702 may identify users based on a unique identifier (e.g., a username or digital certificate). The IAMS 702 may associate a user with a set of access authorizations or privileges of the system 100. The IAMS 702 may use authentication mechanisms (e.g., passwords or public key infrastructure (PKI)) to establish validity of a user's identity.

In some embodiments, the system 100 may receive an access request from an external entity via the CAPN 210. The system 100 may request a digital certificate from the external entity for authentication purposes. An internal entity of the system 100, such as an application executing in the system 100, may request access and may be authenticated via supplying a user identifier to the IAMS 702. In some embodiments, the IAMS 702 may generate an audit record for each data access request.

In one embodiment, the security environment 112 may include a security auditing service 704. The security auditing service 704 may account for actions taken or attempted by an entity (e.g., user, application, job, component). Such actions may include reading from or writing to the mission dataspace 120. The security auditing service 704 may include similar functionality to the cloud logging service 216. However, the security auditing service 704 may configured to track and report security-related events and not events in general.

In some embodiments, the security environment 112 may include a vulnerability assessment service 706. The vulnerability assessment service 706 may discover, report, and mitigate security vulnerabilities of the system 100. Vulnerabilities may be associated with a physical device, piece of software, a component, an application, a service, or other piece of the system 100. The vulnerability assessment service 706 may determine whether security patches have been applies to one or more components of the system 100. The vulnerability assessment service 706 may perform malware scans, vulnerability scans, or other scans. The vulnerability service 706 may report the results of a scan.

The security environment 112 may include a threat management service 708. The threat management service 708 may process threats to the system 100 such as viruses, worms, trojans, hacking attempts, or misuse of system 100 components. The threat management service 708 may provide security monitoring, firewalls, security incident and event monitoring, incident response planning, or intrusion detection or prevention.

In some embodiments, the security environment 112 may include a cryptography service 710. The cryptography service 710 may provide cryptographic operations to applications or components in the system 100. Cryptographic operations may include encrypting data or decrypting data. The cryptography service 710 may include one or more configuration files that may configure the cryptography service 710 to use certain encryption standards, cryptography algorithms, or the like.

### Data Ingest and Fusion

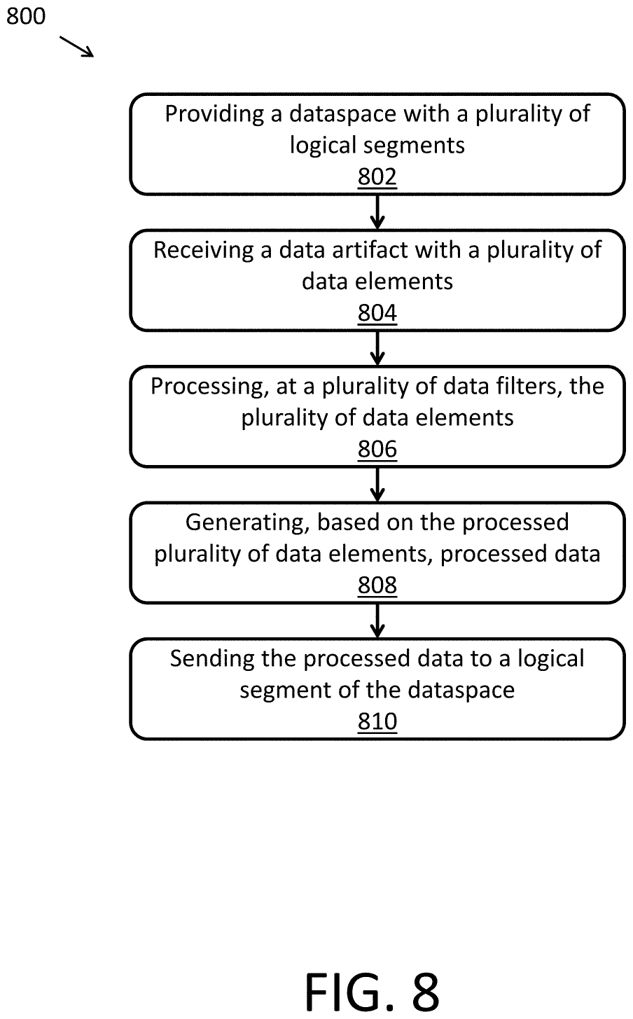

FIG. 8 depicts one embodiment of a method 800. One embodiment of the disclosure may include the method 800. The method 800 may include a method for data flow and data fusion. The method 800 may include providing 802, in a computer-readable storage device, a dataspace. The dataspace may include a plurality of logical segments. The dataspace may include dataspace data stored in the plurality of logical segments.

The method 800 may include receiving 804, from a data source external to the dataspace, a data artifact. The data artifact may include a plurality of data elements. The method 800 may include processing 806, at a plurality of data filters, the plurality of data elements. A data filter may process a data element based on a structure of the plurality of the data elements. A data filter may process a data element based on a configuration of the data filter.

The method 800 may include generating 808 processed data. Generating 808 the processed data may be based on the processed plurality of data elements. The method 800 may include sending 810 the processed data to a logical segment.

In one embodiment, the computer-readable stored device may include a CCN 204 or a CSN. The dataspace may include the mission dataspace 120. The plurality of logical segments may include the data artifact semantics segment 122, the data semantics segment 124, the data model semantics segment 126, or the data artifact storage segment 128. The dataspace data may include data stored in one of these segments.

In some embodiments, receiving 804 a data artifact from a data source external to the dataspace may include the ASIS 304 performing one or more functions. The ASIS 304 may use the FTS to request the external data or data artifact and receive the external data. The ASIS 304, executing on a CAPN 210, may receive the external data from an external application executing on an external computer system. The ASIS 304, via the DSMS 306, may load the received data into the dataspace. In some embodiments, the import/export application 308 may import data from an external system and may interact with the DSMS 306 to load the data into the dataspace.

In one embodiment, processing 806, at a plurality of data filters, the plurality of data elements may include executing a data ingest workflow. In some embodiments, the WPMS 302 may execute the data ingest workflow. The WPMS 302 may execute the data ingest workflow in response to a trigger, for example, caused by arrival of the plurality of data elements. As part of the data ingest workflow, the CMS 202 may execute the SIA 402. The SIA 402 may access the received data elements in the mission dataspace 120 through the DSMS 306. A pump component of the SIA 402 may receive the data elements, send the data elements to one or more filter components via one or more pipe components. Each filter component may filter or transform the data elements. In some embodiments, a filter component may include an instance of the ACIS 312, which may index the received data elements, data artifacts, or other ingested data.

In one embodiment, generating 808 the processed data based on the processed plurality of data elements may include assimilating the received data elements. In some embodiments, in response to receiving data elements from different data sources or in response to receiving data elements from a data source and the data in the mission dataspace 120 being in different formats, a filter component of the SIA 402 may transform the received data elements to be consistent with other received data or data already in the mission dataspace 120. The SIA 402 may send transformed data elements or analysis data to the mission dataspace 120 via the DSMS 306.

In one embodiment, transforming the received data elements may include a filter tracking an element count. Tracking an element count may include the filter storing the element count as metadata associated with the received data. The filter tracking the element count may include simple word counting in textual data elements; or tracking the total number of artifacts ingest from a given data source; or tracking the total number of assertions for a given data element; or any counting that can be performed with respect to data elements.

In some embodiments, transforming the received data elements may include a filter normalizing values included in the received data elements. For example, in one embodiment, the received data elements may include structured data with one or more columns that include multiple data values. The filter may normalize the data values in a column.

In another embodiment, generating 808 the processed data may include a filter modifying the ingested data elements to remove irregularities in the data elements. Removing irregularities may include standardizing the received data elements with data in the mission dataspace 120. For example, the dataspace may refer to global positioning system (GPS) coordinates as “coords,” and received data elements may refer to GPS coordinates as “location.” A filter component may modify the received data elements to refer to the GPS coordinates of the received data as “coords.” The filter modifying the received data elements may include the filter modifying metadata associated with the received data elements, a name of a data column, or other data of the received data elements.

In one embodiment, processing 806, at the plurality of data filters, the plurality of data elements may include receiving, at a first data filter, a first data element. Processing 806 the plurality of data elements may include selecting a portion of the first data element based on the configuration of the first data filter. Processing 806 the plurality of data elements may include sending the portion of the first data element to at least one logical segment. Processing 806 the plurality of data elements may include sending the first data element to second data filter of the plurality of data filters. For example, as discussed above in relation to the SIA 402, a filter component may receive data elements, store a data element in a logical segment of the mission dataspace 120, and forward the data elements to another filter component.

In one embodiment, generating 808 the processed data may include generating metadata corresponding to the data artifact. For example, as discussed above, a filter component of the SIA 402 may generate metadata and store the metadata in the data artifact semantics segment 122. In yet another embodiment, processing 806 the plurality of data elements may include disambiguating a first data element from a second data element. For example, a filter component of the SIA 402 or the enrichment application 404 may disambiguate ingested data elements. Generating 808 the processed data may include generating first metadata associated with a source data artifact. Generating 808 the processed data may include generating disambiguation data based on the disambiguating the first and second data elements. Sending 810 the processed data to a logical segment may include sending the first metadata to the data artifact semantics segment 122. Sending 810 the processed data to a logical segment may include sending the disambiguation data to a second logical segment, such as the data semantics segment 124. In one embodiment, the method 800 may include sending the data artifact to the data artifact semantic segment 122 or the data artifact storage segment 128.

In some embodiments, receiving 804 the data artifact may include receiving the data artifact from a semi-structured source. Generating 808 the processed data may include generating metadata associated with the semi-structured source. For example, as discussed above, the semi-structured source may include an email ingest and the SIA 402 or other component may generate metadata associated with an email, such as metadata about a sender of an email. Sending 810 the processed data to a logical segment may include sending the generated metadata to the data semantics logical segment 124.

In one embodiment, receiving 804 the data artifact may include receiving a structured data artifact. Processing 806 the plurality of data elements may include retrieving, from the data source, structure data corresponding to the plurality of data elements. For example, the SIA 402 may access a relational database system catalog to determine the structure of the plurality of data elements, as discussed above. Generating 808 the processed data may include generating metadata associated with the structured data or metadata associated with the data source. For example, the SIA 402 may generate metadata describing the structure of the data in the relational database. Sending 810 the processed data to a logical segment may include sending the structure data and metadata to the data model semantics segment 126. The method 800 may further include sending the plurality of data elements to the data semantics segment 124.

In one embodiment, receiving the structured data artifact may include receiving data from a relational database, RSS feed, or header section of an email message. In some embodiments, receiving 804 the data artifact may include receiving the data artifact from an external application executing on an external system. A an external-facing data interface may receive the data artifact. For example, the external-facing interface may include the ASIS 304 or the import/export application 308. In one embodiment, receiving 804 the data artifact may include the data artifact from a network location on an external computer system via a file transfer service. For example, a file transfer service of the ASIS 304 may receive the data artifact.

In one embodiment, the method 800 may include generating a second plurality of data filters. This may be in response to the plurality of data elements including a predetermined side. For example, as discussed above, in response to a growing about of data to be ingested, the SIA 402 may generate more filter components.

In one embodiment, the method 800 may further include selecting a portion of the dataspace data stored on a data storage device. The method 800 may include indexing the dataspace data. For example, the ACIS 312 may receive a trigger to index some newly ingested data in the mission dataspace 120 stored on a certain CSN. The method 800 may include generating a first indexing file that may include first indexing results, receiving a second indexing file from another data storage device (such as another CSN), sending the first indexing file and second index file to a third data storage device (such as a CCN 204), and merging the first and second indexing results, as described above in relation to the ACIS 312.

In one embodiment of the disclosure may include a system. The system may be similar to the system 100 discussed above. The system may include a first computing device. The first computing device may include a CSN. The first computing device may include a first processor configured to process a first set of instructions. The first computing device may include a first computer-readable storage medium. The first computer-readable storage medium may include a portion of a dataspace (such as the mission dataspace 120).

The system may include a second computing device. The second computing device may include a CCN 204(1). The second computing device may include a second processor configured to process a second set of instructions. The second computing device may include a second computer-readable storage medium that may include the second set of instructions. The second set of instructions, when executed by the second processor, may cause the second processor to receive a data artifact from a data source external to the dataspace. The data artifact may include a plurality of data elements. For example, the second set of instructions may include the ASIS 304 or the import/export application 308.

The system may include a third computing device. The third computing device may include a CCN 204(2). The CCN 204(2) may include the SIA 402. The third computing device may include a third processor that may execute a third set of instructions stored on a third computer-readable storage medium of the third computing device. The third set of instructions may include the SIA 402. The third set of instructions may cause the third processor to perform one or more steps of the method described above.

In one embodiment, the first computing device may include a cloud storage device (such as a CSN). The cloud storage device may include a distributed file system or a distributed database as described above.

In one embodiment, the third computing device may include a CCN 206. The CCN 206 may be configured to execute the third set of instructions, such as the SIA 402 in response to receiving a command from a cloud management node, such as a CCN executing a CMS 202 described above. In one embodiment, a data artifact may include data file, a portion of a relational database, or a data stream.

Another embodiment of the disclosure may include a plurality of non-transitory computer-readable storage media. The plurality of computer-readable storage media may include one or more sets of instructions. The one or more sets of instructions, when executed by one or more processors, may cause the system to perform one or more steps. The one or more steps may include one or more steps from the method above. The one or more steps may include one or more functions of the system 100 as described above. In one embodiment, the plurality of non-transitory computer readable storage media may include one or more storage devices of one or more CCNs 206(1)-(n).

In some embodiments, the system 100 may store data in a dataspace (such as the mission dataspace 120) in unconventional ways. For example, the system 100 may store data elements from unstructured, semi-structured, or structured data artifacts in the different segments of the mission dataspace 120. The data elements from these data artifacts may also be unstructured, semi-structured, or structured. This unconventional flexibility of the data representation of the mission dataspace 120 may improve the functionality of the computing system of the system 100 by providing flexibility in how the data is represented to different applications different and allowing processing to occur on different types of data elements based on the structure of the data elements.

Also unconventionally, the system 100 may configure a data filter 412 based on the structure of the ingested data. For example, the SIA 402 may ingest structured data in a first way (e.g., based on structure metadata from the source of the structured data or model semantics data from the data model semantics segment 126) and may ingest unstructured data in a different way. One or more data filters 412 may ingest the same data and process it in parallel or in sequence.

The system 100 may provide an unconventional automated workflow for the data ingested into the system 100. Whereas conventional computing systems only compute results from ingested data, the system 100 may provide a workflow to ingest the data, process the data, store the data in different segments of the mission dataspace 120, manage the data (e.g., rolling back data in the mission dataspace 120 when needed, allowing assertions to be placed on the data), execute one or more analytic applications on the data, and optimize those analytic applications for the data. This may improve a computing system by requiring minimal input from a user and performing functionality a user may not even be aware of. Also unconventionally, the system 100 may provide security for the ingested data from the moment the data enters the system 100. The system 100 may provide security for the data during execution of AI or data analytic models, dataspace searches, the enrichment application 404, or at other times while the data exists in the system 100.

The system 100 may provide one or more improvements to computer functionality. In one embodiment, the system 100 may increase the speed at which AI systems and models receive and process information. For example, the data flow and fusion method 800 of FIG. 8 (or the functionality of a component of the system 100, such as the DMS 306) may reduce the amount of duplicated data in the mission dataspace 120 (e.g., by dropping duplicate data during data ingest).

The system 100 may increase the accuracy of AI systems and models. The step of generating 808 processed data or the functionality of a component of the system 100, such as the enrichment application 404, may, in an unconventional step, extract unstructured data ingested into the dataspace 120 and place the extracted unstructured data into a data model of the mission dataspace 120 to generate structured data. This generated structured data may fill in missing values for data used in data analysis or machine learning capabilities of the system 100. Filling in the missing values and preventing data from being dropped (which occurs in conventional computing systems) may increase the accuracy of the data analysis or machine learning capabilities of the system 100.

The system 100 may provide a schema-less data model provided by the implementation of the mission dataspace 120. The data model may provide a uniform representation for data of a wide variety of types. The data elements conforming to that data model may feed into an AI system or model so that the AI system or model spends more time deriving patterns and finding relationships in the data of the system 100 and less time configuring the data to be in a usable format. The system 100 leverages different data from different sources for AI models and systems without a tradeoff in performance. The AI systems and models can derive patterns and find relationships in the data faster and more accurately than prior systems. This enables the AI models and systems to automatically learn and make predictions in ways that previously could not be automated. Furthermore, the system 100 overcomes problems specifically arising in the realm of AI, such as the problem of AI models and systems learning from and using consistent data. Furthermore, the system 100 may provide data security to the data in the mission dataspace 120 and elsewhere in the system throughout an entire workflow. The system 100 also provides an improved interface for a user that allows a user to provide data to the system 100, execute analytics on the data, and manage the data in the mission dataspace 120. The interface may allow a user who has no knowledge of computer programming to interact with the mission dataspace 120 or to execute analytics on the data.

The system 100 may provide scaling and high performance to large datasets. The system 100 may provide scaling and performance benefits as part of end-to-end lifecycle for data of the system 100 and not just during one part of the time ingested data spends in the system 100. For example, in one embodiment, in response to the parallelization of the data filters 412 or the division of the mission dataspace 120 into multiple segments 122-128 may provide scaling and performance benefits during data ingest. The enrichment application 404 may provide performance benefits during a pre-data analysis phase. Rollback, optimistic processing, and other AI model capabilities may provide performance increases during training or execution of an AI model.

### Deep Learning Optimization

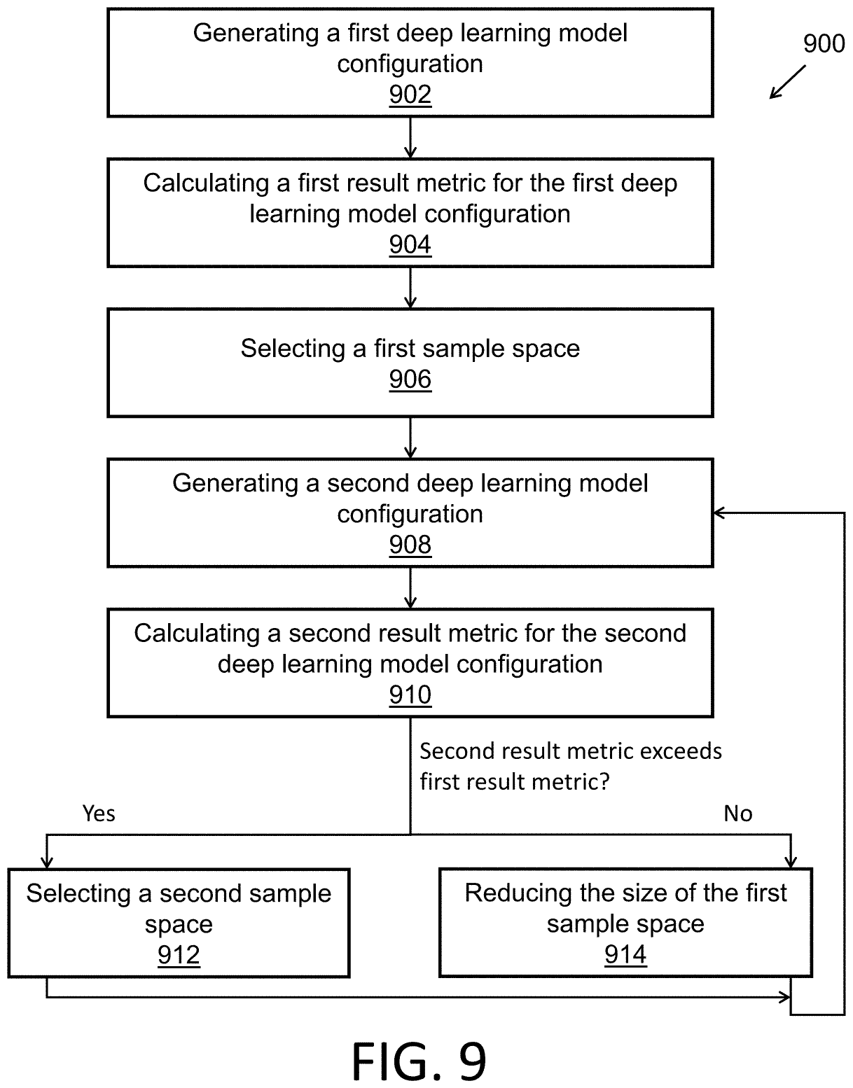

FIG. 9 depicts one embodiment of a method 900. The method 900 may include a computer-implemented method. The method 900 may include a method for optimizing a deep learning model configuration based on Random Recursive Search (RRS). As used herein, a “deep learning model” may mean a class of deep learning systems, algorithms, models, or the like. A deep learning model may include one or more parameters. The parameters may include a variety of ways to be configured. As used herein, a “parameter” of a deep learning model may mean a parameter (or hyperparameter), input feature, configuration, or the like that can be changed, and the behavior of the deep learning model may change based on the changed parameter. Each deep learning model may include one or more parameters, and the details of a parameter may depend on the type of deep learning model. As used herein, a “deep learning model configuration” may mean an instance of a deep learning model. The deep learning model configuration may include one or more parameters of the deep learning model being configured with a value or the like. In some embodiments, a deep learning model configuration may receive data as input (i.e. input data), process the input data based on the deep learning model configuration's parameters, and produce an output, such as a classification, prediction, value, or the like.

In one embodiment, a deep learning model may include a hyperparameter design space. As used herein, the “hyperparameter design space” may include one or more parameters of the deep learning model and the possible values for each of those parameters. The hyperparameter design space may include all the parameters of the deep learning model or a subset of all of the parameters. Which parameters of the deep learning model may be included in the hyperparameter design space may be based on user configuration.

As an example, in one embodiment, a deep learning model may include an artificial neural network (ANN). The ANN may include a variety of parameters. For example, a parameter of the ANN may include a weight of an edge of the ANN, a position of an edge of the ANN, the number of nodes in the ANN, the number of nodes in a layer of the ANN, the number of layers of the ANN, or the like. In one embodiment, the hyperparameter design space of the ANN may include the edge positions and the edge weights of the ANN. Thus, in this example, the hyperparameter design space of the ANN may not include the number of nodes, the number of nodes in a layer, or the number of layers in the ANN. The values of these parameters may be set and may not change during the optimization of the deep learning model. In one embodiment, a deep learning model configuration may include a specific instance of the ANN.

In some embodiments, a deep learning model configuration may include a machine learning model configuration capable of deep learning. A deep learning model may include an artificial neural network. An ANN may include a deep belief network, recurrent neural network (RNN), convolutional neural network (CNN), or the like. A deep learning model may include an estimator. A deep learning model may include other machine learning models capable of deep learning. Although the methods discussed herein refer to deep learning models, in some embodiments, the methods may be applied to a machine learning model other than a deep learning model.

In some embodiments, a deep learning model may include an ensemble of deep learning models. An ensemble may include two or more deep learning models. The two or more deep learning models may be connected in a variety of ways. In one embodiment, a parameter of an ensemble may include a type of deep learning model included in the ensemble, a position of a deep learning model in the ensemble, how the deep learning model is connected to another deep learning model, or the like.

In one embodiment, the method 900 may include generating 902 a first deep learning model configuration. In some embodiments, generating 902 the first deep learning model configuration may include generating a new deep learning model configuration. In another embodiment, generating 902 the first deep learning model configuration may include receiving a pre-configured deep learning model configuration. A pre-configured deep learning model configuration may include an instance of a deep learning model whose parameters have been previously configured before the start of the method 900. In some embodiments, generating 902 the first deep learning model configuration may include generating a value for a parameter of the first deep learning model configuration. Generating a value for a parameter of the first deep learning model configuration may include generating a value for each parameter in the hyperparameter design space of the deep learning model configuration. In one embodiment, generating the first deep learning model configuration by generating a value for each parameter in the hyperparameter design space may be called generating the first deep learning model from the hyperparameter design space.

In some embodiments, generating a value for a parameter may include determining the possible values for the parameter. Determining the possible values may include a user selecting the possible values, a range of possible values, or the like. Determining the possible values for a parameter may include determining the possible values for multiple parameters of a same type. For example, in response to the deep learning model configuration including an ANN, determining the possible values for a weight of the ANN may include determining the possible values for all the weights of the ANN. A user may select that a value of a weight in the ANN may have a value of 0 to 400, and in response, all the weights may have a possible value of 0 to 400.

In one embodiment, generating 902 the first deep learning model configuration may include generating the deep learning model configuration based on random number generation. Generating the deep learning model configuration based on random number generation may include randomly generating a parameter of the deep learning model configuration. The random generation of a parameter may include randomly selecting a value for the parameter from all possible values of the parameter, a subset of all possible values of the parameter, or the like. For example, the deep learning model configuration may include an ANN. Generating the ANN based on random number generation may include randomly generating a weight of an edge, randomly generating the position of an edge, randomly generating the number of nodes in the ANN, randomly generating the number of layers of the ANN, randomly generating which nodes belong to which layers, or the like. In some embodiments, randomly generating deep learning model configurations may be quicker at finding a deep learning model configuration that performs better at solving a problem than using some learning algorithms, such as backpropagation or the like. This may occur because learning algorithms can be slow compared to random generation of parameters. Furthermore, certain learning algorithms, like backpropagation, may seek to learn how the interaction of different parameters can lead to a better deep learning model configuration. This learning may be slow compared to randomly generating parameters and testing if the configuration of parameters leads to better results. In some embodiments, randomly generating parameters may not be affected by local minima as some learning algorithms, like backpropagation, may be.

In one embodiment, generating 902 the first deep learning model configuration may include generating multiple deep learning model configurations. Generating multiple deep learning model configurations will be discussed in more detail below.

In one embodiment, the method 900 may include calculating 904 a first result metric for the first deep learning model configuration. A result metric may include a measurement of how well a deep learning model configuration is at performing its purpose. For example, the purpose of a deep learning model configuration may include image classification. A result metric for the deep learning model configuration may include an accuracy of the deep learning model configuration at classifying an image. A result metric for the deep learning model configuration may include overfit, underfit, or the like.

In one embodiment, calculating 904 the result metric may include testing the deep learning model configuration on a testing dataset. For example, in response to randomly generating an ANN, calculating 904 the result metric of the ANN may include inputting the testing dataset into the ANN and determining the accuracy, overfit, or underfit of the ANN.

In some embodiments, the result metric may include a response surface. The response surface may include multiple dimensions, and each dimension may represent a goal (e.g. accuracy, underfit, overfit, or the like). Each point in the response surface may include a certain value for each of the dimensions. In one embodiment, the goals may be competing and the deep learning model configuration doing better in one goal may simultaneously cause the deep learning model configuration to do worse in another goal. In response, the result metric may include a measurement based on the competing goals.

In one embodiment, the method 900 may include selecting 906 a first sample space. The first sample space may be based on the first deep learning model configuration. As used herein, a “sample space” may mean a subsection of the hyperparameter design space. Each dimension of the sample space may include a range of possible values for a parameter of the deep learning model configuration. The sample space may be smaller than the hyperparameter design space, thus the range of possible values for a parameter may be smaller in the sample space. In some embodiments, selecting 906 the first sample space based on the first deep learning model configuration may include selecting the first sample space based on the first deep learning model configuration having a result metric above a predetermined threshold. The predetermined threshold may include the first deep learning model configuration having a higher result metric than other deep learning model configurations.

In another embodiment, the sample space being based on the deep learning model configuration may include the sample space being centered on the deep learning model configuration. The sample space being centered on the deep learning model configuration may include the range of possible values for a dimension in the sample space having its center value be the value of the deep learning model configuration's parameter corresponding to that dimension. In some embodiments, the size of the range for each dimension may be different.

In one embodiment, the method 900 may include calculating an exploitation threshold. Calculating an exploitation threshold may include calculating the threshold based on user configuration, an average result metric, or the like. In some embodiments, selecting 906 the first sample space may include selecting the first sample space in response to the first metric exceeding the exploitation threshold. In one embodiment, a reason for having an exploitation threshold may include to prevent the method 900 from selecting deep learning model configurations with only a small increase in its result metric than the result metric of the deep learning model around which the first sample space is based. In some embodiments, it may be faster, more advantageous, or the like to generate another deep learning model configuration than to re-center, recalculate, or the like for a sample space.

In one embodiment, the method 900 may include generating 908 a second deep learning model configuration. The second deep learning model configuration may be within the first sample space. The second deep learning model configuration being within the first sample space may include the parameters of the second deep learning model configuration having values within the ranges of the dimensions of the first sample space.

In one embodiment, generating 908 the second deep learning model configuration may include generating a new deep learning model configuration with values within the first sample space. In another embodiment, generating 908 the second deep learning model configuration may include adjusting the one or more parameters of the first deep learning model configuration. In some embodiments, generating 908 the second deep learning model configuration may include generating multiple second deep learning model configurations within the first sample space, as discussed below. In one embodiment, generating the second deep learning model configuration by generating or adjusting a value for each parameter in the first sample space may be called generating the first deep learning model from the first sample space.

In one embodiment, the method 900 may include calculating 910 a second result metric for the second deep learning model configuration. Calculating 910 the second result metric may be similar to calculating 904 the first result metric.

In some embodiments, in response to the second result metric exceeding the first result metric, the method may include selecting 912 a second sample space. The second sample space may be based on the second deep learning model configuration. In some embodiments, selecting 912 the second sample space may include centering the second sample space around the second deep learning model configuration. Centering the second sample space around the second deep learning model configuration may be similar to centering the first sample space around the first deep learning model configuration. In some embodiments, the second sample space may be the same size as the first sample space. In another embodiment, the second sample space may be larger or smaller than the first sample space.

In some embodiments, the second result metric exceeding the first result metric may include the second result metric exceeding the first result metric by a threshold amount. The threshold amount may include an amount based on user configuration. For example, a user configuration may include selecting the second sample space in response to the second result metric exceeding the result metric by 0.00001. Thus, in response to the first result metric being 87.665435623 and the second result metric being 87.665435625, the second result metric does not exceed the first result metric by 0.00001 and the second deep learning model configuration will not be selected to be the center of the second sample space. In one embodiment, a reason for having the threshold may include to prevent the method 900 from selecting deep learning model configurations with only a small increase in its result metric than another result metric. In some embodiments, it may be faster, more advantageous, or the like to generate another deep learning model configuration than to re-center, recalculate, or the like a sample space.

It should be noted that one result metric exceeding another result metric may not necessarily include one result metric having a higher value than the other. In some embodiments, the second result metric exceeding the first result metric may include that the deep learning model configuration corresponding to the second metric performs better than the deep learning model configuration corresponding to the first result metric. For example, in one embodiment, a result metric may include number of misclassifications. Thus, the lower the number of misclassifications, the better the deep learning model configuration. Thus, in some embodiments, a result metric exceeding another result metric may include a result metric being lower than another result metric.

In another embodiment, in response to the second result metric not exceeding the first result metric, the method 900 may include reducing 914 the size of the first sample space. Reducing 914 the size of the first sample space may include reducing the range of possible values for one or more parameters of the first deep learning model configuration. In some embodiments, the first sample space may continue to be centered around the first deep learning model configuration.

In some embodiments, reducing the size of the first sample space may assist in finding another deep learning model configuration with a higher result metric than the first deep learning model configuration. This may be because the method 900 is searching in a smaller area, and thus, has a higher likelihood of finding something better within that area.

In some embodiments, in response to either selecting the second sample space or reducing the size of the first sample space, the method 900 may include generating a third deep learning model configuration within the new sample space (i.e. the second sample space or the reduced first sample space) and continuing the search process. Thus, the method 900 may return to step 908 and use another deep learning model configuration to continue searching for a deep learning model configuration with a higher result metric as depicted in FIG. 9. The method 900 may repeat until stopping criteria is met.

In one embodiment, a stopping criteria may include not finding deep learning model configuration with a corresponding result metric with an improvement over a current best result metric. A stopping criteria may include not finding a deep learning model configuration with a corresponding result metric with an improvement over a certain threshold. A stopping criteria may include adjusting the threshold after a predetermined number of deep learning model configurations have been generated. In some embodiments, in response to meeting the stopping criteria, the method 900 may include selecting the deep learning model configuration with the highest result metric as the output deep learning model configuration. In response to selecting the output deep learning model configuration, the method 900 may cease. The method 900 ceasing may include the method 900 ceasing temporarily.

In some embodiments, the output deep learning model configuration may perform well on input data that it has not encountered previously. However, the output deep learning model configuration may encounter a set of input data that may be significantly different from the input data the output deep learning model configuration may have used previously or encountered as testing data. In response, the output deep learning model configuration may be less accurate or perform worse on this new set of input data. Thus, in one embodiment, further optimization may assist the output deep learning model configuration to perform well on the new set of input data.

In an embodiment, the method 900 may include calculating a threshold result metric. A result metric of a deep learning model configuration below the threshold result metric may indicate that the deep learning model configuration may benefit from further optimization. The method 900 may include calculating a third result metric. The third result metric may be for the output deep learning model configuration. The third result metric may be based on additional training set data. Calculating the third result metric may be similar to calculating 904 the first result metric. The method 900 may include, in response to determining that the third result metric is below the threshold result metric, selecting a third sample space. The third sample space may be based on the output deep learning model configuration. Selecting the third sample space may be similar to selecting 906 the first sample space. In one embodiment, the method 900 may include continuing one or more steps of the method 900 until a stopping criteria is met and a new output deep learning model configuration is selected.

In an embodiment, it may be beneficial to generate some deep learning model configurations using different computational approaches. Determining which computational approach may be used may be based on the level of the hyperparameter design space the deep learning model configuration is being generated from, a capability of a computational approach, or the like. In one embodiment, generating a deep learning model configuration at a higher level may include using a first computational approach, and generating a deep learning model configuration at a lower level may include using a second computational approach.

As used herein, a “level” of the hyperparameter design space may include the hyperparameter design space itself, or a subsection of the hyperparameter design space. A level may be higher, lower, or at the same level as another level. In some embodiments, whether a level is higher or lower than another level may be based on a size of the level. For example, a higher level may include a larger size in the hyperparameter space than a lower level, with the hyperparameter design space itself being the highest level. The hyperparameter design space may include a first level, the first sample space may include a second level that is lower than the first level, and the reduced first sample space may include a third level lower than the second level. The examples herein of higher or lower levels of the hyperparameter design space are only for illustrative purposes.

In some embodiments, a computational approach may include software. The software may include a software library, e.g. a dataflow programming library or the like. A computational approach may include an algorithm or the like (e.g. an algorithm that approximates, an algorithm that produces an accurate output, or the like). In another embodiment, a computational approach may include computer hardware, e.g. a central processing unit (CPU), a graphics processing unit (GPU), an application-specific integrated circuit (ASIC), or the like. In some embodiments, a computational approach may include a portion of software (e.g. a function, subroutine, or the like) or a portion of hardware. A computational approach may include a hardware representation (e.g. a 16 bit integer data type, a 64 bit floating point data type, or the like). Some computational approaches may include different capabilities such as speed, accuracy, memory usage, storage usage, network usage, or the like.

In one embodiment, when generating a deep learning model configuration from a higher level of the hyperparameter design space, it may be beneficial to generate the deep learning model configuration quickly. This may be because, initially, it may be more advantageous to generate several deep learning model configurations to increase the probability of generating a deep learning model configuration that may yield a high result metric. In response, generating a deep learning model configuration using a computational approach that may include a lower accuracy capability, but a high-speed capability may be advantageous. However, at a lower level of the hyperparameter design space (such as the first sample space, the reduced first sample space, a second reduced sample space, or the like), computational accuracy may be more beneficial than speed. In response, generating a deep learning model configuration using a computational approach that may include a high accuracy capability may be advantageous.

In one embodiment, generating 902 the first deep learning model configuration may include generating the first deep learning model using a first computational approach. Generating 908 the second deep learning model configuration may include generating the second deep learning model using a second computational approach. In one embodiment, the first computational approach may include a higher speed capability than the second computational approach. In another embodiment, the second computational approach may include a higher accuracy capability than the first computational approach.

For example, in some embodiments, a GPU may include a high speed capability, but may not include, compared to a CPU, a high accuracy capability. A CPU may include a high accuracy capability, but may not include, compared to a GPU, a high speed capability. In response, generating 902 the first deep learning model configuration may include using a GPU to generate the first deep learning model configuration. In response, generating 902 the first deep learning model configuration may include generating the first deep learning model configuration quickly in order to find an initial first sample space that is likely to yield a good search area in the hyperparameter design space. Generating 908 the second deep learning model configuration may include using a CPU to generate the second deep learning model configuration. In response, generating 908 the second deep learning model configuration may include generating the second deep learning model configuration using more accurate calculations.

In some embodiments, the method 900 may be balancing improving the deep learning model configuration with computing resources (e.g. processor consumption, memory consumption, non-volatile storage consumption, power consumption, computing time, or the like). Initially, improvements to the deep learning model may be worth the computing resources, but as the rate of improvement slows, it may be more advantageous to stop searching for a better deep learning model configuration than to expending a large amount of computing resources to find a small improvement.

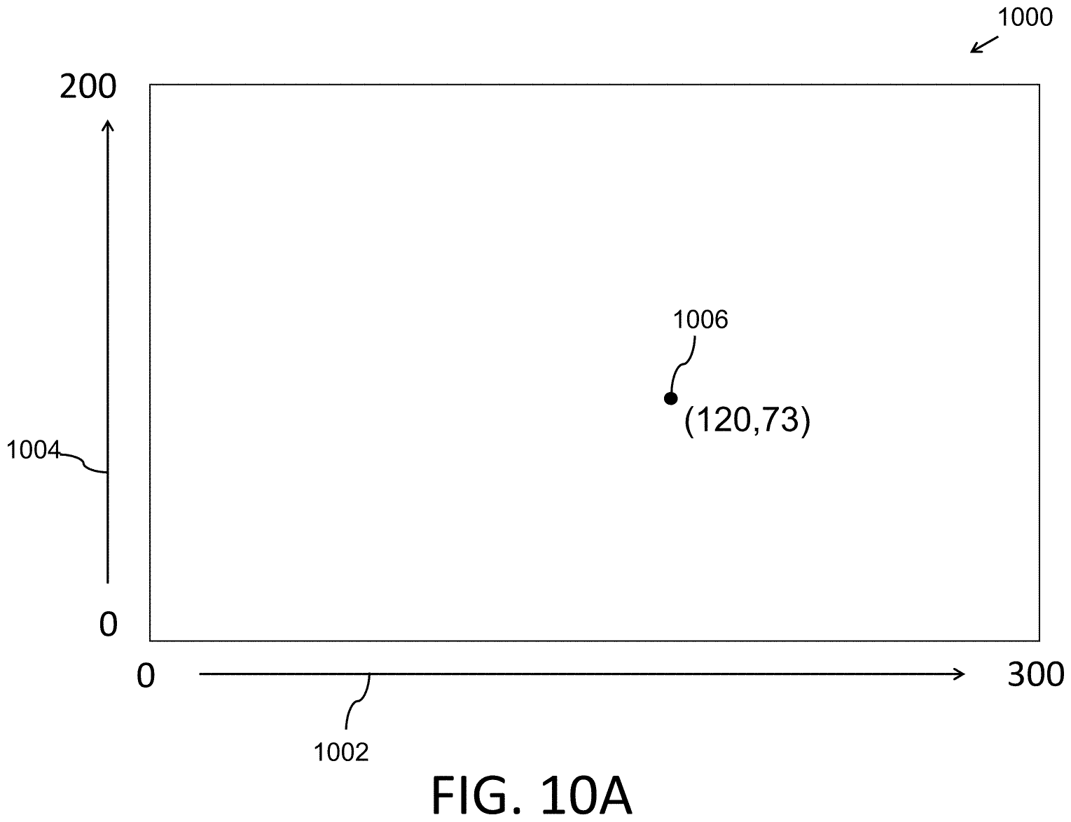

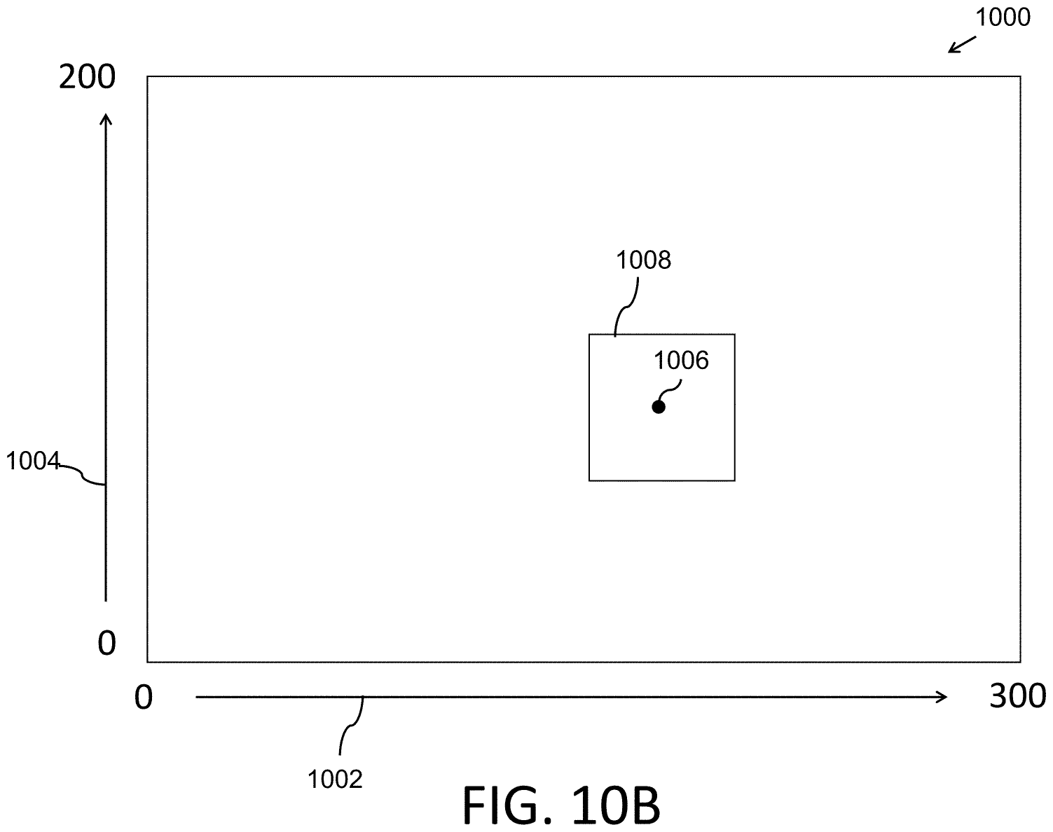

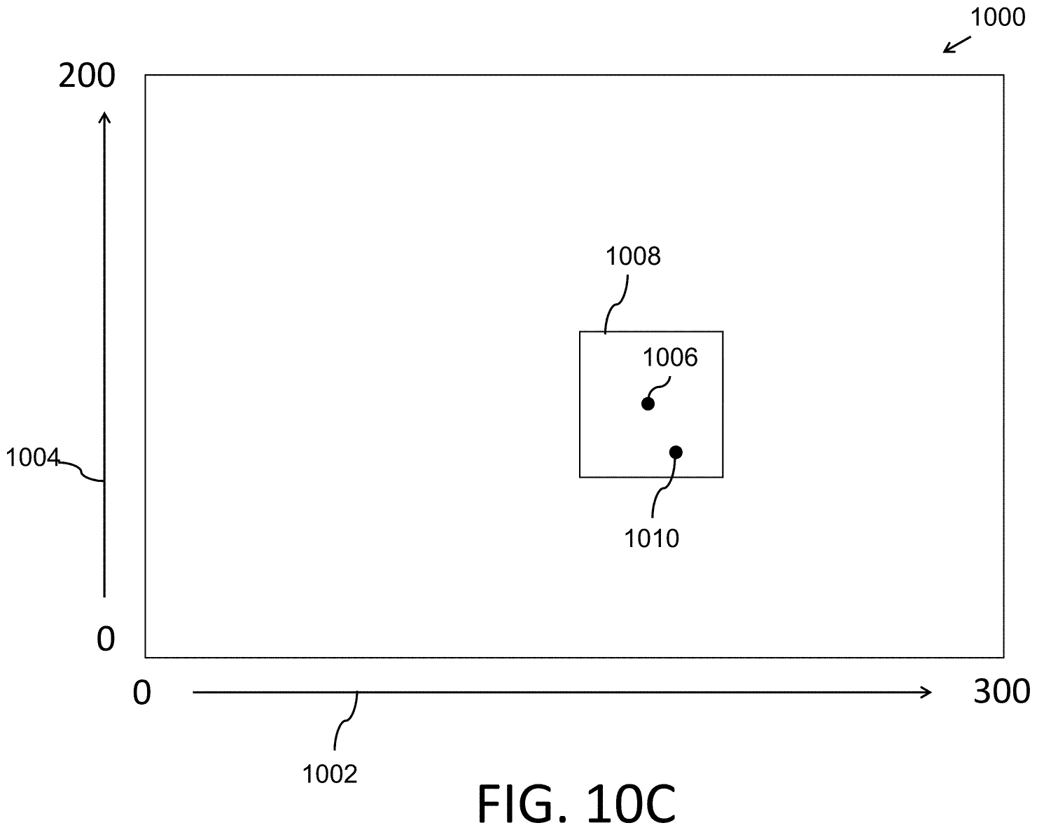

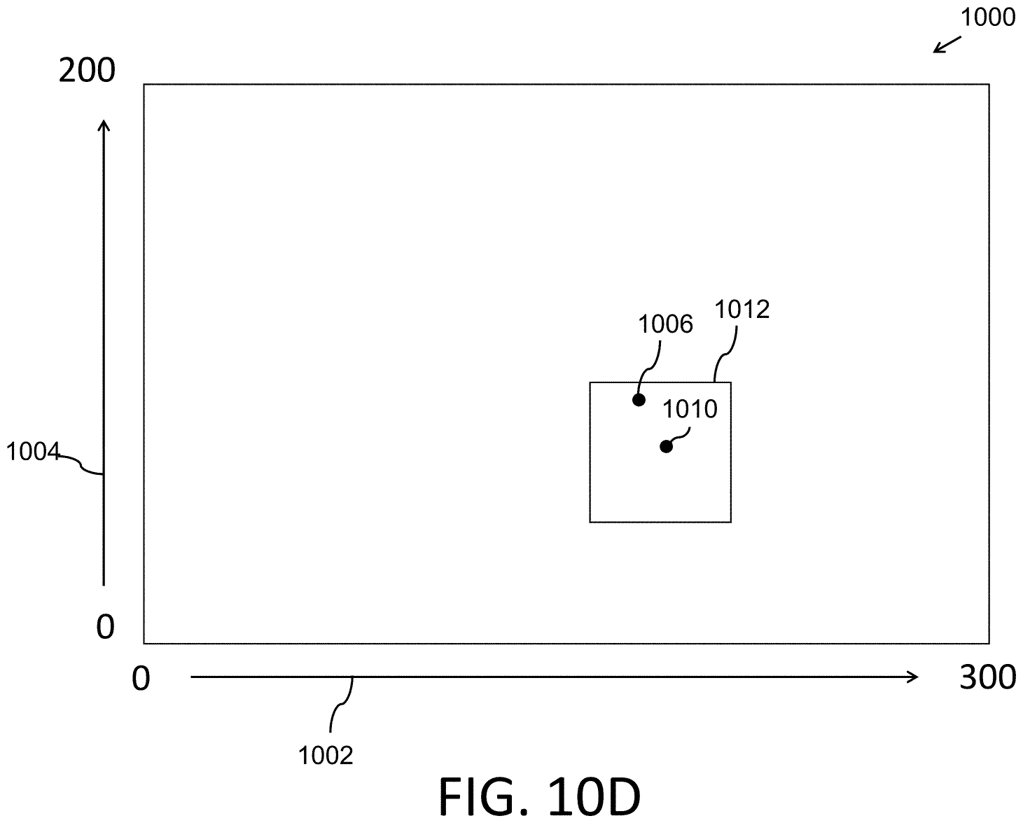

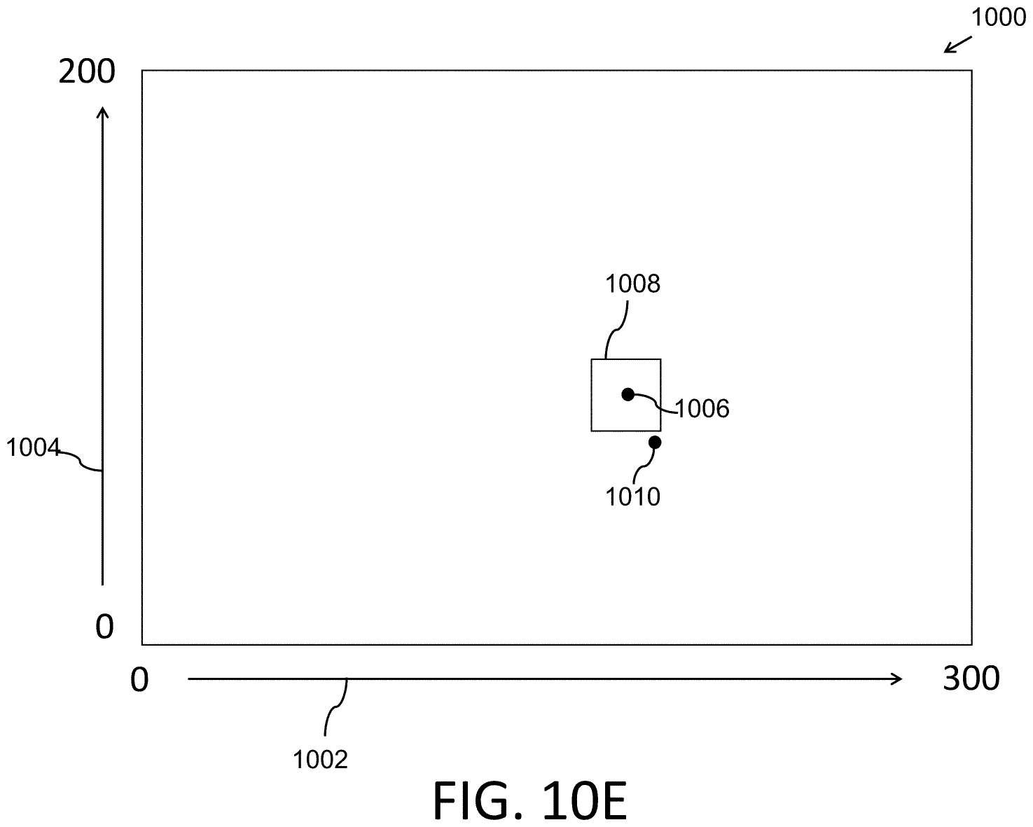

FIG. 10A depicts one embodiment of a representation of a hyperparameter design space 1000. The hyperparameter design space 1000 may include one or more dimensions and each dimension may include a parameter of the first deep learning model configuration. A dimension may include the range of all possible values for the parameter. For example, as shown in FIG. 10A, a hyperparameter design space 1000 may include a first dimension 1002 and a second dimension 1004. The first dimension 1002 may correspond to a first parameter of a deep learning model configuration and the second dimension may correspond to a second parameter of the deep learning model configuration. The first parameter may have a range of possible values from 0 to 300 and the second parameter may have a range of possible values from 0 to 1000. The hyperparameter design space 1000 may include a point 1006. The point 1006 may correspond to a deep learning model configuration. FIG. 10A may include the result of generating 902 a first deep learning model configuration of method 900. In FIG. 10A, the point may correspond to a deep learning model configuration whose first parameter has a value of 120 and whose second parameter has a value of 73.

It should be noted that FIG. 10A, for illustrative purposes, depicts a very simple hyperparameter design space 1000. For many deep learning model configurations, these configurations may include thousands of parameters. For example, as discussed above regarding an ANN, a hyperparameter design space 1000 may include a dimension for each weight of an edge, a dimension for each edge position, a dimensions for a number of nodes, or the like. Thus, a visual representation of a hyperparameter design space for such configuration would likely be impossible.

FIG. 10B depicts one example of a hyperparameter design space 1000. The hyperparameter design space 1000 may include one embodiment of the result of selecting 906 a first sample space of the method 900. For example, the hyperparameter design space 1000 may include a first sample space 1008. The first sample space 1008 may be smaller than the hyperparameter design space 1000. The first sample space 1008 may be centered on the point 1006. For example, the point 1006 corresponding to the first deep learning model configuration may have values for the first dimension 1002 and the second dimensions 1004 of 120 and 73 respectively. The range of the first sample space for each dimension may include 50 possible values. Thus, in response to the range being 50 possible values and the center being at (120,73), the ranges of possible values for the first and second parameters in the first sample space are 95 to 145 and 48 to 98 respectively.

FIG. 10C depicts one embodiment of a hyperparameter design space 1000. FIG. 10C may depict one embodiment of the result of generating 908 a second deep learning model configuration of the method 900. In response to the first sample space 1008 having a range of 50 values in each dimension centered around the values 120 and 73, the second deep learning model configuration's first and second parameters may be 132 and 55 respectively. This may correspond to a second point 1010 in the hyperparameter design space 1000.

FIG. 10D depicts one embodiment of a hyperparameter design space 1000. FIG. 10D may depict one embodiment of the result of selecting 912 a second sample space of the method 900 of FIG. 9. For example, in response to the second result metric of the second point 1010 exceeding the result metric of the first point 1006, the method 900 may include selecting 912 a second sample space 1012 centered around the second point 1010.

FIG. 10E depicts one embodiment of a hyperparameter design space 1000. FIG. 10E may depict one embodiment of the result of reducing 914 the size of the first sample space of the method 900 of FIG. 9. For example, as depicted in FIG. 10E, in response to the result metric of the second deep learning model configuration that corresponds to the second point 1010 not exceeding the first result metric, the range of possible values for the parameters, represented by the first sample space 1008, may be reduced from 50 values to 30 values. Thus, the range of possible values for the first and second parameters would still be centered around 120 and 73, but the possible values would be 105 to 135 and 58 to 88.

In one embodiment, the hyperparameter design space 1000 may include a first level of the hyperparameter design space. Generating 902 the first deep learning model configuration may include using a first computational approach. For example, the computation approach may include a high speed capability. The first sample space 1008 may include a second level. The second level may be lower than the first level. Generating 908 the second deep learning model configuration may include using a second computational approach. The second computational approach may include a lower speed capability than the first computational approach, but a higher accuracy capability. The reduced first sample space 1008 of FIG. 10E may include a third level. The third level may be lower than the second level. Generating a third deep learning model configuration from the reduced first sample space 1008 may include using a third computational approach. The third computational approach may include a higher accuracy capability than the second computational approach.

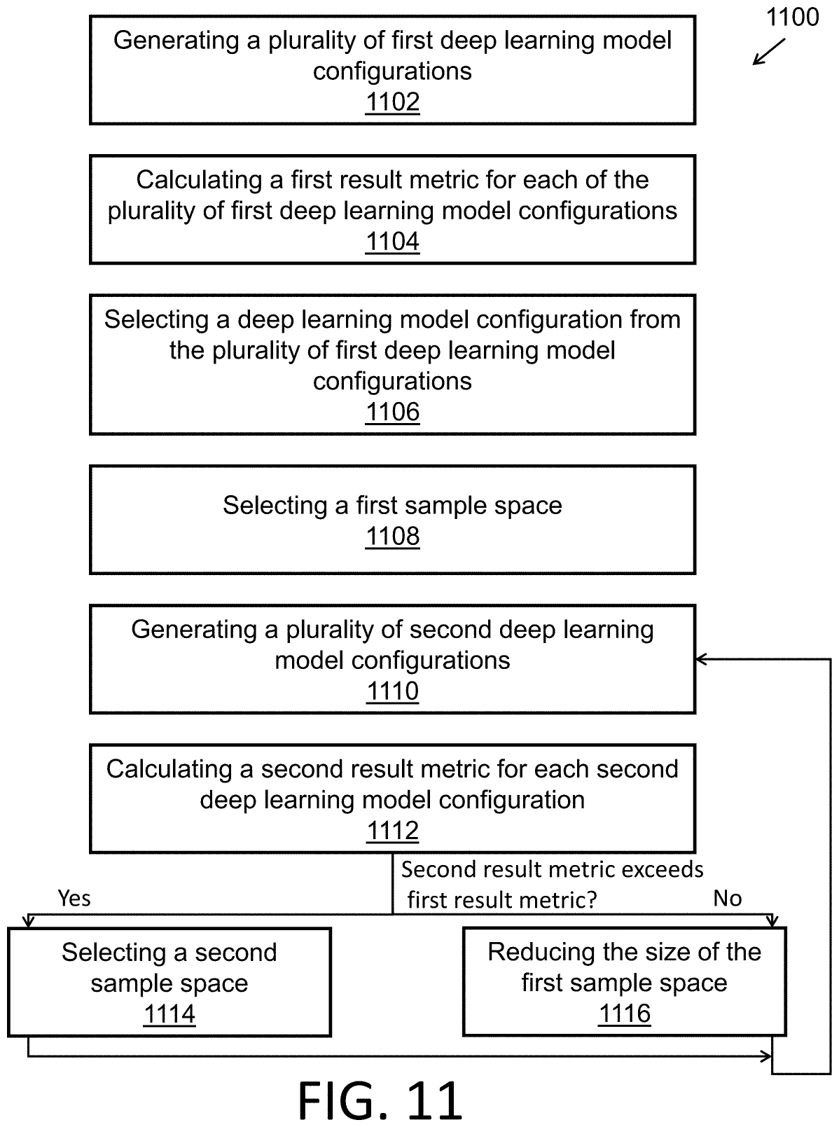

FIG. 11 depicts one embodiment of a method 1100. The method 1100 may include generating 1102 a plurality of first deep learning model configurations. Generating 1102 a plurality of first deep learning model configurations may be similar to generating 902 a first deep learning model configuration of the method 900 as described above. In one embodiment, generating 1102 the plurality of first deep learning model configurations may include generating a predetermined number of deep learning model configurations. The predetermined number may be based on a confidence interval. The confidence interval may include a user-defined confidence interval.

In some embodiments, each of the deep learning model configurations of the plurality of first deep learning model configurations may include different values for each of its parameters. For example, generating multiple deep learning model configurations may include randomly generating two ANNs. The first ANN may include a variety of randomly generated nodes randomly grouped into layers, a variety of edges each with its own randomly generated weight and randomly connected to nodes of the ANN. The second ANN may include randomly generated nodes and edges in randomly generated positions within the ANN with different values for these parameters than the first ANN.

In another embodiment, generating 1102 the plurality of first deep learning model configurations may include generating two or more of the first deep learning model configurations in parallel. Generating two or more of the first deep learning mode configurations in parallel may include using a compute cluster, supercomputer, or the like. Generating 1102 the plurality of first deep learning model configurations may lend itself to generating the deep learning model configurations concurrently since each deep learning model configuration may be generated independently of the others and may not be dependent on the others.

In some embodiments, the method 1100 may include calculating 1104 a first result metric for each of the plurality of first deep learning model configurations. Calculating 1104 a first result metric for each first deep learning model configuration may be similar to calculating 904 the first result metric for the first deep learning model configuration of method 900 of FIG. 9 as described above. In one embodiment, calculating 1104 the first result metric for each of the plurality of first deep learning model configurations may include calculating two or more result metrics in parallel. Calculating two or more result metrics in parallel may include using a compute cluster, supercomputer, or the like.

In one embodiment, the method 1100 may include selecting 1106 a deep learning model configuration from the plurality of first deep learning model configurations. In some embodiments, selecting 1106 the deep learning model configuration may include selecting the deep learning model configuration based on the result metric of the selected first deep learning model configuration. For example, selecting 1106 the deep learning model configuration from the plurality of first deep learning model configurations may include selecting the deep learning model configuration with a result metric above a predetermined threshold. In one embodiment, selecting the deep learning model configuration with a result metric above the predetermined threshold may include selecting the deep learning model configuration with highest result metric of the result metrics of the plurality of first deep learning model configurations.

In another embodiment, the method 1100 may include selecting 1108 a first sample space. The first sample space may be based on the selected first deep learning model configuration. In some embodiments, selecting 1108 the first sample space may be similar to selecting the first sample space 906 of the method 900 described above.

In some embodiments, the method 1100 may include generating 1110 a plurality of second deep learning model configurations. Each second deep learning model configuration may be within the first sample space. In one embodiment, generating 1110 the plurality of second deep learning model configurations may include generating a predetermined number of second deep learning model configurations. The predetermined number may be based on a confidence interval. The predetermined number may include the same number of first deep learning model configurations or may include a different number. In another embodiment, 1110 the plurality of second deep learning model configurations may include generating two or more of the second deep learning model configurations in parallel. Generating two or more of the second deep learning model configurations in parallel may include using a compute cluster, supercomputer, or the like.

In one embodiment, the method 1100 may include calculating 1112 a second result metric for each second deep learning model configurations of the plurality of second deep learning mode configurations. Calculating 1112 the second result metric for each second deep learning model configuration may be similar to calculating 1104 the first result metric for each first deep learning model configuration described above. In some embodiments, calculating 1112 the second result metric for each second deep learning model configuration may include calculating two or more second result metrics in parallel. Calculating two or more second result metrics in parallel may include using a compute cluster, supercomputer, or the like.

In another embodiment, the method 1100 may include, in response to a second result metric exceeding the first result metric, selecting 1114 a second sample space. The second sample space may be based on the second deep learning model configuration corresponding to the second result metric that exceeds the first result metric. Selecting 1114 the second sample space may be similar to selecting 912 a second sample space of method 900 described above.

In one embodiment, in response to no second result metric of the plurality of second deep learning model configurations exceeding the first result metric, the method 1100 may include reducing 1116 the size of the first sample space. In some embodiments, reducing 1116 the size of the first sample space may be similar to reducing 914 the size of the first sample space of method 900 described above.

In one embodiment, generating one or more deep learning model configurations may include efficient generation of a deep learning model configuration. The efficiency may be based on random generation or the like. The generation may be more efficient than tracking parameters of a deep learning model configuration and tracking the effectiveness of certain parameters' interactions with other parameters. Furthermore, certain steps such as generating deep learning model configurations, testing the deep learning model configurations, or the like may be done in parallel using a compute cluster, supercomputer, or the like. By randomly generating deep learning model configurations and by focusing the generation around deep learning models with high result metrics, an optimized initial deep learning model configuration can be found. Furthermore, by using an existing deep learning model configuration as a basis for optimization, an even more optimized version of that deep learning model configuration may be found.

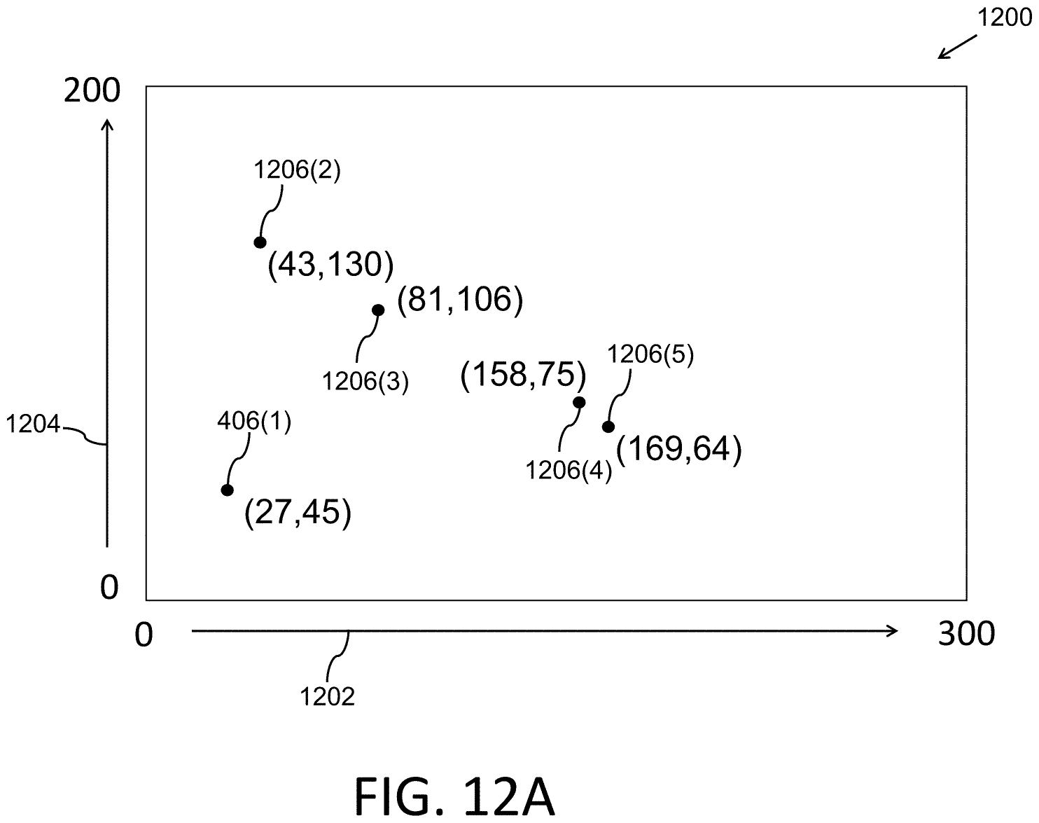

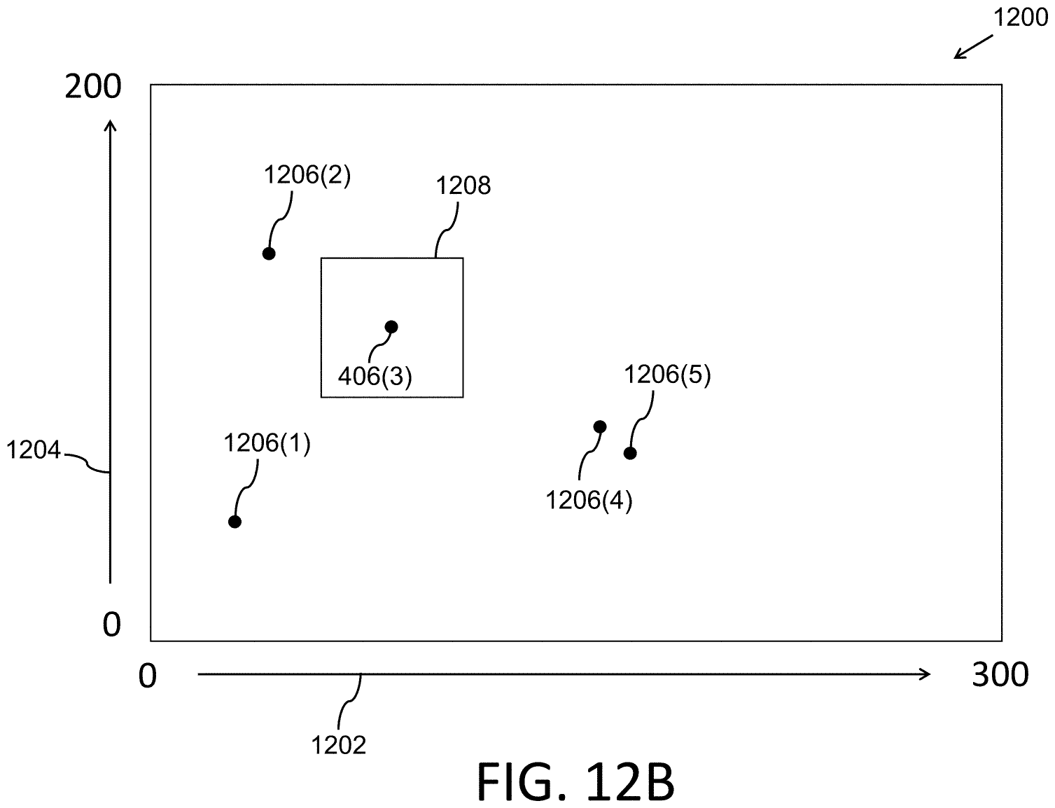

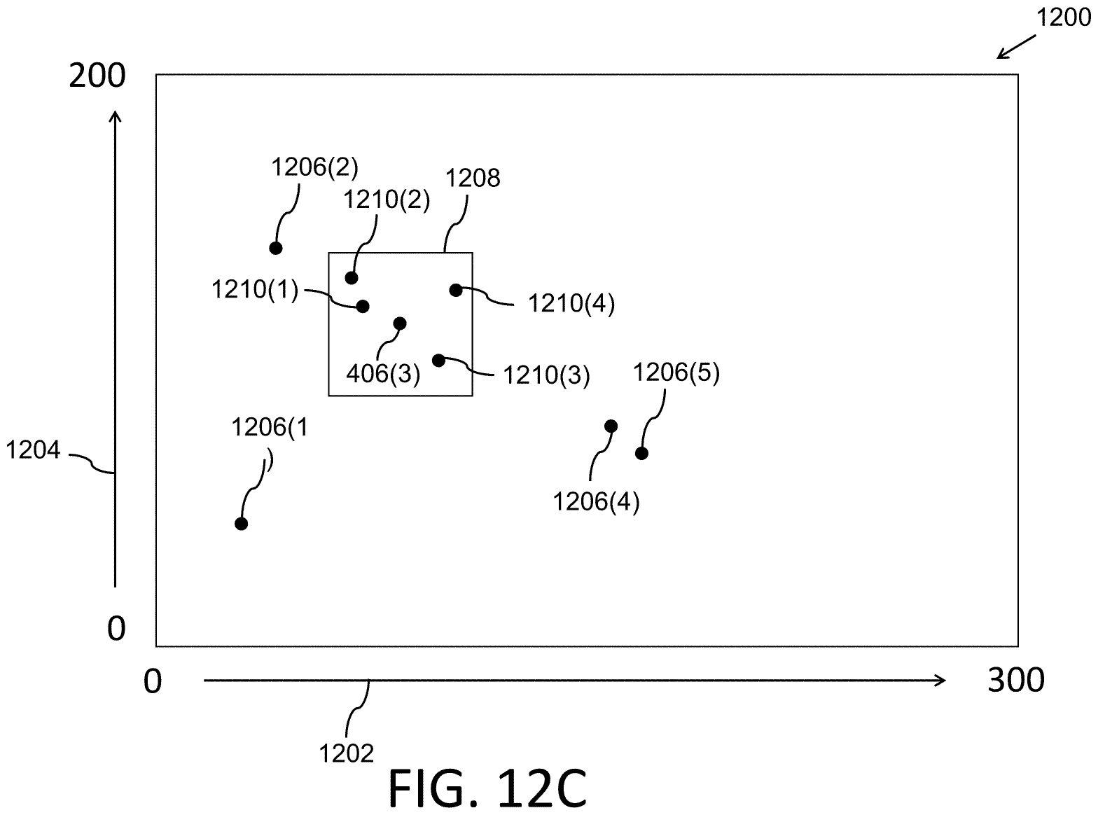

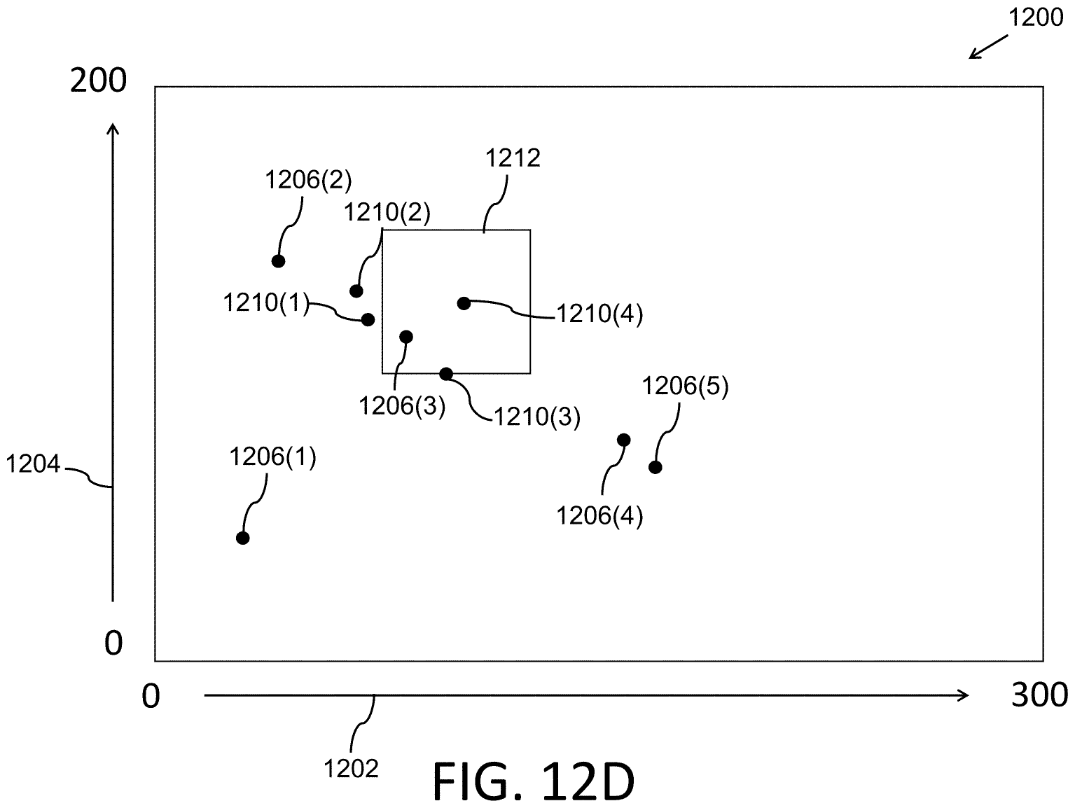

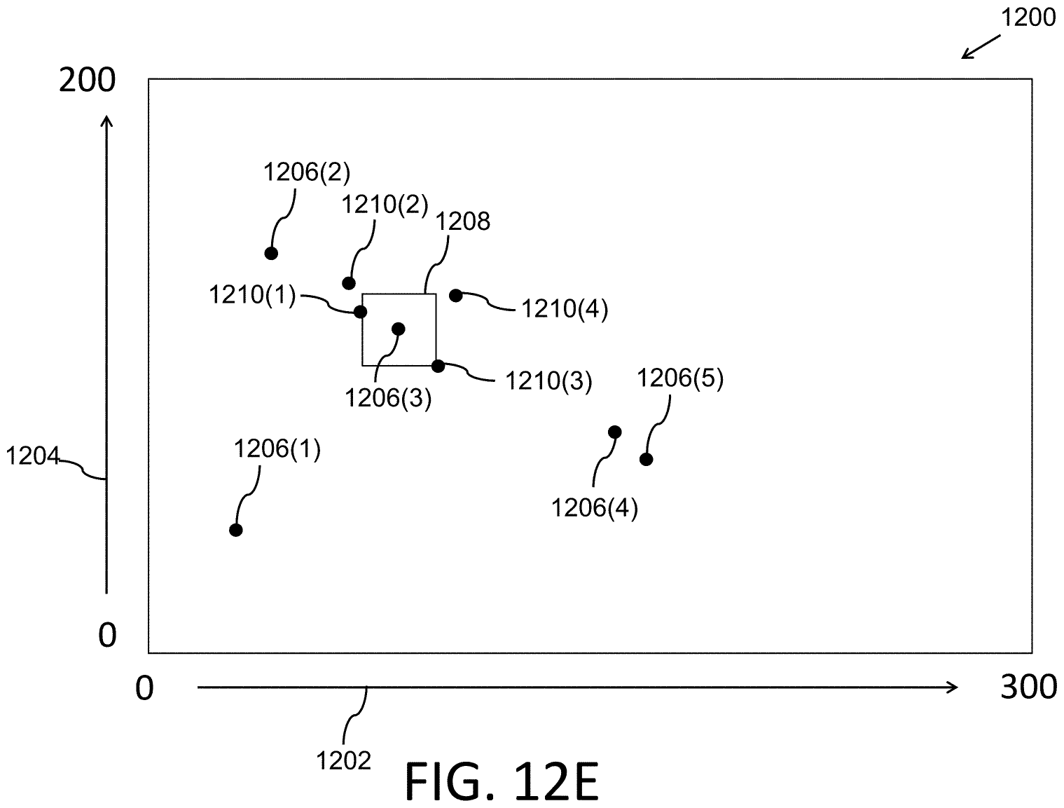

FIG. 12A depicts one embodiment of a hyperparameter design space 1200. The hyperparameter design space 1200 may include a hyperparameter design space similar to the hyperparameter design space 1000 of FIGS. 10A-E discussed above. For example, the hyperparameter design space 400 may include a first dimension 1202 and a second dimension 1204 each corresponding to possible values of a parameter of a deep learning model configuration. The hyperparameter design space 1200 may include a plurality of points 1206(1)-(5). A point 1206 may correspond to a deep learning model configuration of the plurality of first deep learning model configurations. Each first deep learning model configuration may include different values for parameters than other first deep learning model configuration as seen in FIG. 12A where each point has different values in the first dimension 1202 and second dimension 1204. FIG. 12A may depict the result of one embodiment of generating 1102 a plurality of first deep learning model configurations. In one embodiment the result metrics for the deep learning model configurations corresponding to the points 1206(1)-(5) may be 41, 36, 86, 44, and 52 respectively. In response, selecting 306 the deep learning model configuration may include selecting the deep learning model configuration corresponding to the point 1206(3).

FIG. 12B depicts one embodiment of a hyperparameter design space 1200. FIG. 12B may depict one embodiment of the result of selecting 1108 a first sample space. For example, in response to the deep learning model configuration that corresponds to the point 1206(3) having the highest result metric, the first sample space 1208 may be based on the deep learning model that corresponds to the point 1206(3). The first sample space 1208 may be centered around the point 1206(3). In some embodiments, the first sample space 1208 may include other deep learning model configurations of the plurality of first deep learning model configurations.

Continuing the above example, as depicted in FIG. 12C, in one embodiment, generating 1110 a plurality of second deep learning model configurations may include generating a plurality of deep learning model configurations corresponding to the points 1210(1)-(4). Each of the points 1210 may be within the first sample space 1208. In one embodiment, calculating 1112 a second result metric for each second deep learning model configuration may include calculating a result metric for each deep learning model configuration corresponding to the points 1210(1)-(5). These result metrics may include, respectively, 77, 65, 85, and 92. Since 92 exceeds the result metric of the deep learning model configuration that corresponds to the point 1206(3) (i.e. 86), in response, the second sample space 1212 may be based on the deep learning model configuration corresponding to the point 1210(4), as is depicted in FIG. 12D.

FIG. 12E depicts one embodiment of the hyperparameter design space 400. However, instead of the result metric of the deep learning model configuration corresponding to the point 1210(4) being 92 as it was in the example of FIG. 12D above, the result metric for the point 1210(4) may be 27. Thus, the second result metrics may include 77, 65, 85, and 27. In one embodiment of reducing 1116 the size of the first sample space, in response to no result metric exceeding the first result metric (i.e. 86), the first sample space 1208 may reduce in size. The first sample space 1208 may remain based on the selected first deep learning model configuration corresponding to the point 1206(3).

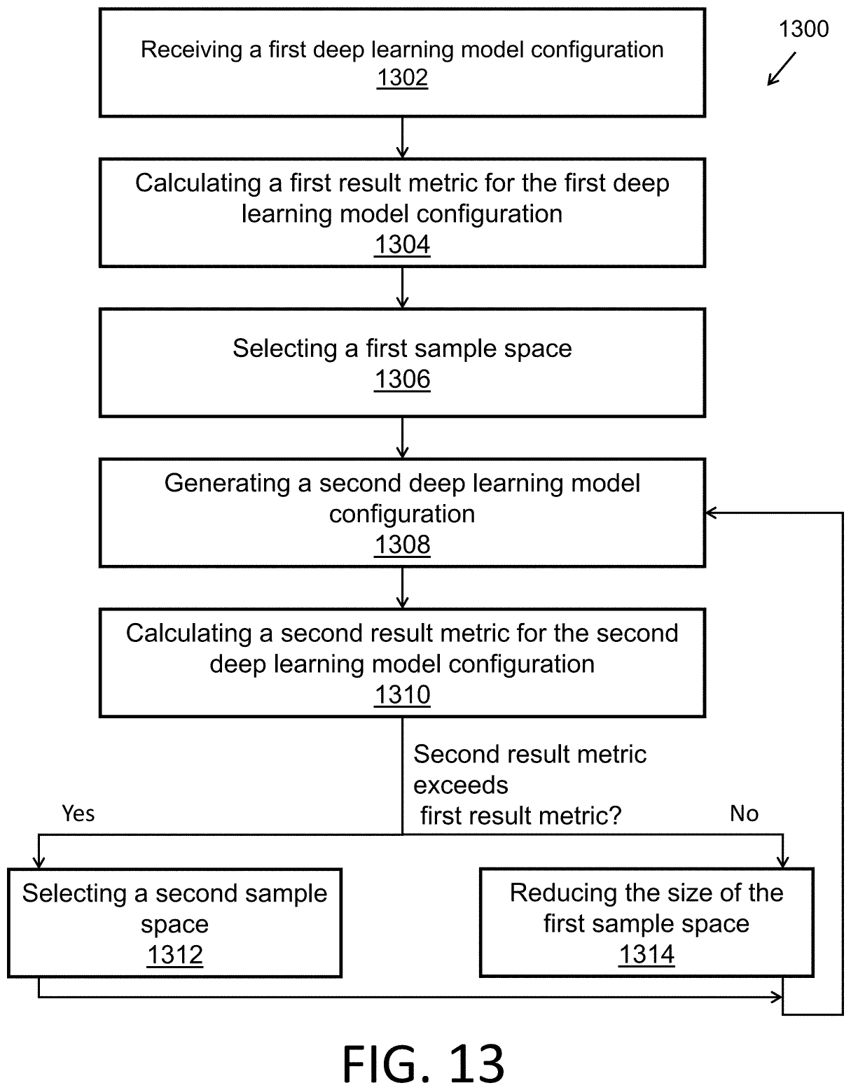

FIG. 13 depicts one embodiment of a method 1300. The method 1300 may include a computer-implemented method for improving a deep learning model configuration. The method 1300 may include receiving 1302 a first deep learning model configuration. In some embodiments, receiving 1302 a first deep learning model configuration may include receiving a pre-configured deep learning model. For example, a user may have a deep learning model that has been generated through training on training data. The user may want to improve the deep learning model, but training the model on more training data may not be effective. Generating more training data may be difficult and time-consuming. Training the model on the additional training data may yield minimal increases in the results of the model. Improvements to the model may result from the model having different parameter values than it currently has, including having different parameter values for parameters that do not change during the training process. In some embodiments, since the pre-configured model may already be yielding good results, using the pre-configured model as a starting point may be helpful.

The method 1300 may include calculating 1304 a first result metric for the first deep learning model configuration. Calculating 1304 the first result metric may be similar to calculating 904 the first result metric of the method 900 or calculating 1104 a first result metric for each of a plurality of first deep learning model configurations of the method 1100. In one embodiment, the method 1300 may include selecting 1306 a first sample space. The first sample space may be based on the first deep learning model configuration. Selecting 1306 the first sample space may be similar to selecting 906 the first sample space of the method 900 or selecting 1108 the first sample space of the method 1100.

The method 1300 may include generating 1308 a second deep learning model configuration. The second deep learning configuration may be within the first sample space. Generating 1308 the second deep learning model configuration may be similar to generating 908 the second deep learning model configuration of the method 900 or generating 1110 a plurality of second deep learning model configurations of the method 1100.

In one embodiment, generating 1308 the second deep learning model configuration may include adjusting a parameter of the deep learning model configuration. Adjusting a parameter of the deep learning model may include changing the value of a parameter without generating a new deep learning model configuration. In some embodiments, it may be more efficient to change the parameters values of a deep learning model configuration than to generate a new deep learning model configuration whose parameter values are equal to the parameter values of the changed deep learning model. In one embodiment, adjusting a parameter the first deep learning model configuration may include adjusting a weight of an edge of a neural network of the first deep learning model configuration. The adjusting the weight may include adjusting the weight within a predetermined amount. The predetermined amount may include an amount based on the range of the first sample space in the dimension corresponding to the weight of that edge.

In another embodiment, adjusting a parameter the first deep learning model configuration may include adding an edge to a neural network of the first deep learning model configuration. Adding the edge may include adding a predetermined number of edges. The predetermined number may be based on the first sample space in the dimension corresponding to a number of edges. The position of an added edge may include a position based on the first sample space in the dimension corresponding to a position of an edge. In some embodiments, adjusting a parameter the first deep learning model configuration may include removing an edge from a neural network of the first deep learning model configuration. Removing the edge may include removing a predetermined number of edges. The predetermined number may be based on the first sample space in the dimension corresponding to a number of edges. The position of a removed edge may include a position based on the first sample space in the dimension corresponding to a position of an edge.

In one embodiment, the first deep learning model configuration may include an ensemble. The ensemble may include multiple learning model configurations. Adjusting a parameter of the first deep learning model configuration may include removing a learning model from the ensemble. For example, the first deep learning model configuration may include an ensemble that includes four ANNs, each ANN having a different set of parameters. The ensemble may be configured to output the majority result of the ANNs. In one embodiment, adjusting a parameter of the first deep learning model may include removing one ANN from the ensemble. Removing an ANN may include removing the ANN with the least accuracy on a testing dataset.

In one embodiment, adjusting a parameter of the first deep learning model configuration may include adding a learning model to the ensemble. For example, adding a learning model to the ensemble may include adding an ANN to the ensemble from the example above. The added ANN may include an ANN whose edge positions and edge weights are based on random generation. The parameters of the randomly generated ANN may be within the first sample space's dimensions corresponding to those parameters.

Adjusting a parameter of the first deep learning model configuration may include repositioning a learning model in the ensemble. For example, in some embodiments, an ensemble may include multiple learning models and a first learning model may feed its output into a second learning model as input. In one embodiment, repositioning a learning model in the ensemble may include positioning the second learning model to feed its output as input to the first learning model. In some embodiments, the input and output data formats or the like may adjust so that the different learning models are compatible with each other regarding input and output.

In some embodiments, the method 1300 may include calculating 1310 a second result metric for the second deep learning configuration. Calculating 1310 the second result metric may be similar to calculating 910 the second result metric of the method 900 or calculating 1112 a second result for each second deep learning model configuration of the method 1100. In another embodiment, the method 1300 may include, in response to the second result metric exceeding the first result metric, selecting 1312 a second sample space, wherein the second sample space is based on the second deep learning model configuration. Selecting 1312 the second sample space may be similar to selecting 912 the second sample space of the method 900 or selecting 1114 the second sample space of the method 1100. The method 1300 may include, in response to the second result metric not exceeding the first result metric, reducing 1314 the size of the first sample space. Reducing 1314 the size of the first sample space may be similar to reducing 914 the size of the first sample space of the method 900 or reducing 1116 the size of the first sample space of the method 1100.

In one embodiment, a deep learning model may include an analytical model, such as the data enrichment model of the MAE. The analytic management model may perform one or more of the methods described above to train the analytical model.

Optimistic Event Processing

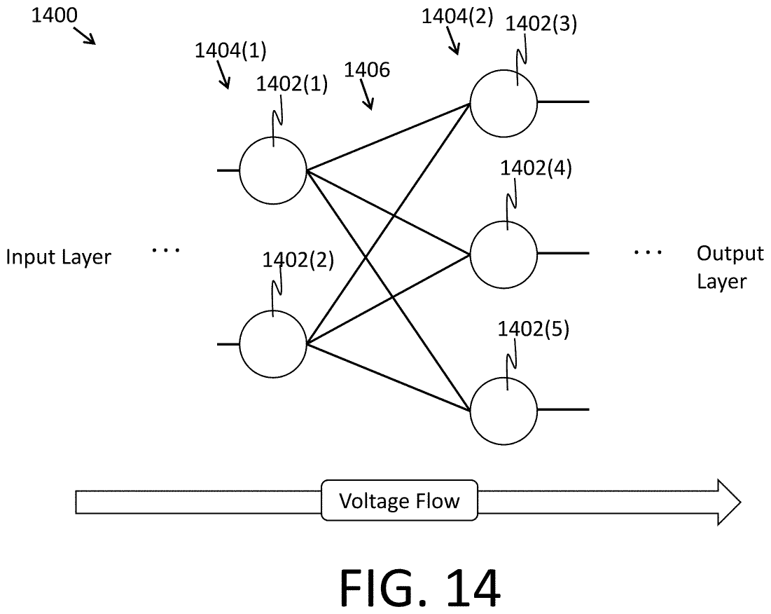

FIG. 14 depicts one embodiment of a portion of an artificial neural network (ANN) 1400. The ANN 1400 may include a multi-layer perceptron (MLP), a deep belief network, a recurrent neural network (RNN), a convolutional neural network (CNN), spiking neural network (SNN), or the like. In one embodiment, the ANN 1400 may include a plurality of neurons 1402 such as the neurons 1402(1)-(5) of FIG. 14. As described herein, an unspecified neuron may be referred to as a neuron 1402.

In some embodiments, the ANN 1400 may include a plurality of layers 1404 of neurons 1402, such as the layers 1404(1)-(2) of FIG. 14. One or more neurons 1402 of the plurality of neurons 1402 may be grouped a layer 1404. For example, a first layer 1404(1) may include the neurons 1402(1)-(2), and a second layer 1404(2) may include the neurons 1402(3)-(5). The ANN 1400 may include an input layer and an output layer (not depicted in FIG. 14). In the exemplary embodiment depicted in FIG. 14, the input layer may be located to the left the layer 1404(1), and the output layer may be located to the right of the layer 1404(2). During use of the ANN 1400, such as during training, inference calculation, or the like, voltage may flow from the input layer, through one or more hidden layers, and toward the output layer. Voltage may include output from a neuron 1402, synapse 1406, or another component of the ANN 1400.

As used herein, a first layer 1404 (and the one or more neurons 1402 of that layer) may be deemed “downstream” from a second layer 1404 in response to the second layer 1404 being disposed between the input layer and the first layer 1404. For example, the first layer 1404 may include the layer 1404(2) and the second layer 1404 may include the layer 1404(1). Thus, the first layer 1404(2) may be downstream of the layer 1404(1). As used herein, a first layer 1404 may be deemed “upstream” from a second layer 104 in response to the first layer 1404 being disposed between the input layer and the second layer 1404. For example, the first layer 1404 may include the layer 1404(1) and the second layer 1404 may include layer 1404(2). Thus, the layer 1404(1) may be upstream from the layer 1404(2).

In one embodiment, the ANN 1400 may include a plurality of synapses 1406. A synapse may connect a neuron 1402 of one layer to a neuron 1402 of another layer. For example, a synapse of the plurality of synapses 1406 may connect the neuron 1402(1) to the neuron 1402(3). In some embodiments, a synapse may include a weight. The weight may include a value that adjusts a voltage that travels through the synapse. Adjusting the voltage based on the weight may include multiplying the voltage by the weight, or the like. In one embodiment, a first neuron 1402(1) may connect to each neuron 1402(3)-(5) of the layer immediately downstream from the first neuron. In some embodiments, the first neuron 1402(1) may connect to a subset of the neurons 1402(3)-(5) of the layer immediately downstream from the first neuron.

In one embodiment, a neuron 1402 may include a membrane potential. The membrane potential may include the current amount of voltage stored in the neuron 1402. A voltage integration function of the neuron 1402 may calculate the membrane potential of the neuron 1402. The voltage integration function may use as input one or more voltage amounts received from connected upstream synapses. The voltage integration function may use as input the current membrane potential of the neuron 1402. The voltage integration function may use one or more random values as input. The output of the integration function may include a new membrane potential of the neuron 1402. As an example, the integration function may include (output value)=(current membrane potential)+(voltage amount from synapse)+(random value). In some embodiments, the integration function may include a linear function, a sigmoid function, or the like.

As an example, the neuron 1402(3) may receive voltage from the neuron 1402(2) through a connecting synapse of the plurality of synapses 1406. The connecting synapse may adjust the voltage from the neuron 1402(2) based on the weight of the connecting synapse to generate a second voltage. The synapse may send the second voltage to the neuron 1402(3). The neuron 1402(3) may use the received voltage as input to the voltage integration function. For example, the current membrane potential of the neuron 1402(3) may include a value of 0.6. The voltage received from the synapse may include a value of 0.2. In response, the voltage integration function may calculate the membrane potential of the neuron 1402(3) to be 0.6+0.2=0.8.

In one embodiment, a neuron 1402 may include a threshold membrane potential. The threshold membrane potential may include a value. In response to the membrane potential of the neuron 1402 exceeding the threshold membrane potential, the neuron 102 may produce an output. The output may include a firing message. The firing message may include a voltage. The neuron 1402 may send the firing message to a downstream neuron 1402. The voltage of the firing message may include a numeric value resulting from the integration function, a predetermined value, or the like. In some embodiments, the threshold membrane potential of a neuron may be based on a predetermined threshold membrane potential, training, a hyperparameter search, or the like.

In one embodiment, components of the ANN 1400 may communicate with each other using messages. In one embodiment, a message may include a timestamp. The timestamp may include the time the message was generated, sent, or the like. The timestamp may include a date and time (e.g. “1 Jan. 2018 14:03:37”), a time since the beginning of executing the ANN 1400, or the like. The timestamp may include a timestamp from a computing device that generates the message, a timestamp from an overarching computing system that schedules, coordinates, or the like the components of the ANN 1400. In some embodiments, a message may include a value. For example, in one embodiment, a message from a synapse (i.e. a “synapse message”) may include the value of the voltage received by the synapse that has been adjusted based on the weight of the synapse.

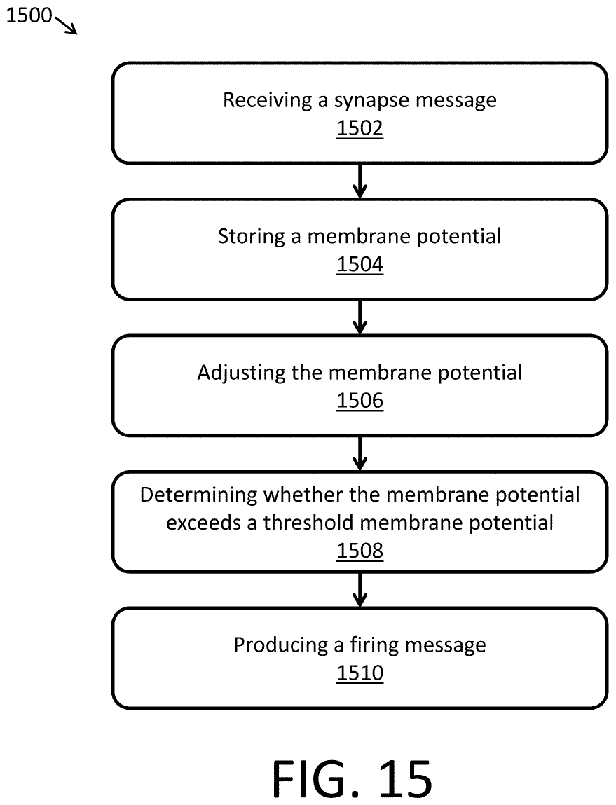

FIG. 15 depicts one embodiment of a method 1500. The method 1500 may include a computer-implemented method. The method 1500 may include a method for artificial neural network optimistic event processing. In one embodiment, the method 1500 may include receiving 1502 a synapse message. A neuron may receive the synapse message. In some embodiments, the neuron may store the received synapse message. The neuron may store one or more received synapse messages in a sequence in which they arrive, in which the neuron processes the synapse messages, or the like. Storing the one or more synapse messages in the sequence may allow the neuron to perform reverse computations as explained below.

In one embodiment, the method 1500 may include storing 1504 a membrane potential of the receiving neuron. The membrane potential may include the membrane potential of the neuron prior to receiving or processing the synapse message. In some embodiments, the storing 1504 the membrane potential may include associating the stored membrane potential with the received synapse message. Storing 1504 the membrane potential may include storing the membrane potential value in a data structure or the like.

In one embodiment, the method 1500 may include adjusting 1506 the membrane potential of the neuron. Adjusting 1506 the membrane potential may be in response to receiving the synapse message, a sequence of synapse messages, or the like. In one embodiment, adjusting 1506 the membrane potential of the neuron may include executing the voltage integration function of the neuron. The receiving neuron may use a voltage value included in the synapse message, sequence of synapse messages, or the like as input for the neuron's integration function. In one embodiment, adjusting 1506 the membrane potential may include adding a random amount to the membrane potential. Adding a random amount to the membrane potential may include using a randomly generated value as part of the voltage integration function.

In some embodiments, the method 1500 may include adjusting the membrane potential of the neuron based on a leak voltage amount. The neuron may include a leak function that calculates the leak voltage amount. Adjusting the membrane potential of the neuron based on the leak voltage amount may include adding the leak voltage amount to the membrane potential of the neuron.

The leak function may include calculating a leak value amount. The leak value amount may include a constant value, a value that may change each time the leak function executes, or the like. In one embodiment, the leak value amount may include a negative value. Whether the leak value amount includes a positive value, a negative value, or a zero value may be based on random number generation. In one embodiment, the leak function may include calculating a time difference between the current time and a time the neuron last produced a firing message. In some embodiments, the neuron may calculate the time difference in response to the neuron receiving a synapse message, receiving another type of message, a timer elapsing, or the like. In one embodiment, the leak function may include calculating a leak voltage amount. The leak voltage amount may be based on the time difference. In some embodiments, the leak voltage amount may include multiplying the leak value amount by the time difference. For example, in one embodiment, the time difference may be 2 and the leak value amount may include a value of 1.2. Thus, the leak voltage amount may include a value of 2.4.

In one embodiment, the neuron may execute the leak function without the neuron receiving a synapse message. In another embodiment, the neuron may execute the leak function in response to receiving a synapse message. In some embodiments, the neuron may execute the leak function in response to receiving another type of message, in response to a timer expiring, or the like. For example, in one embodiment, in response to adjusting 1506 the membrane potential of the neuron, the neuron may execute the leak function or may set a timer to execute the leak function in response to the timer expiring.

In some embodiments, the method 1500 may include determining 1508 whether the membrane potential exceeds a threshold membrane potential of the neuron. The determining 1508 may be in response to a predetermined amount of time expiring since adjusting 1506 the membrane potential of the neuron. The predetermined amount of time may include a time interval, a number of processor cycles, or another way to track time.

In one embodiment, in response to the membrane potential exceeding the threshold, the method 1500 may include producing 1510 a firing message. In some embodiments, producing 1510 the firing message may include the neuron producing an output. In one embodiment, in response to producing 1510 the firing message, the method 1500 may include reducing the membrane potential of the neuron.

For example, in one embodiment, a synapse message may include a voltage sent from a first neuron 1402(1) to a second neuron 1402(3) that has been calculated using the weight of the synapse. The timestamp of the synapse message may include the time the synapse message was sent. The neuron 1402(3) receiving the synapse message may store its current membrane potential. The neuron 1402(3) may use the voltage of the synapse message as input for its integration function. In one embodiment, in response to the integration function of the neuron 1402(3) resulting in a membrane potential that exceeds the threshold membrane potential of the neuron 1402(3), the neuron 1402(3) may fire. In response to the neuron 1402(3) firing, the neuron may send a firing message to each connecting downstream synapse.

In some embodiments, producing 1510 the firing message may include producing the firing message without receiving a second synapse message from a connecting, upstream synapse. A neuron may connect with multiple upstream synapses. The neuron may receive one or more synapse messages from these upstream synapses at different times. Receiving each synapse message may be similar to the step of receiving 1502 the synapse message. The neuron may adjust its membrane potential based on the received one or more synapse messages, which may be similar to the step of adjusting 1506 the membrane potential. The neuron may determine whether its membrane potential exceeds its threshold membrane potential, which may be similar to the step of determining 1508 whether the membrane potential exceeds the threshold membrane potential. The neuron may make this determination even though it may not have received a synapse message from every connected upstream synapse. The neuron may make this determination even though other neurons in the same layer may not have received one or more synapse messages from their respective connected upstream synapses.

In one embodiment, producing 1510 the firing message may include scheduling the firing message to be sent at a later time. Scheduling the firing message may not include generating the firing message immediately after the determining 1508. In some embodiments, an ANN (such as the ANN 1400) may be configured such that multiple neurons may send their respective firing messages (in response to a neuron's membrane potential exceeding its threshold membrane potential) at substantially the same time. This may aid the ANN in having at least a portion of the firing messages arrive at their respective destinations in a correct order as indicated by their respective time stamps. In one embodiment, a random value may be added to the firing message time interval or the synapse message time interval. The random value may prevent two or more messages from arriving at a component of the ANN simultaneously. Preventing simultaneous arrival of messages may prevent ambiguity when performing reverse-computations, or the like as explained below.

In some embodiments, the method 1500 may include, in response to producing 1510 a firing message, resetting the membrane potential of the neuron. In one embodiment, resetting the membrane potential of the neuron may include reducing the membrane potential of the neuron by a predetermined amount. The predetermined amount may include an amount derived from training, a hyperparameter search, or a user configuration.

In some embodiments, the method 1500 may include determining whether the membrane potential of the neuron is below a second threshold membrane potential. The second threshold membrane potential may be called a “negative threshold,” a “reset threshold,” or the like. Determining whether the membrane potential of the neuron is below the negative threshold may be in response to producing 1510 the firing message, in response to the neuron performing the leak function, or the like. In response to the membrane potential being below the second threshold membrane potential, the method 1500 may include setting the membrane potential of the neuron to a predetermined membrane potential, adding a predetermined value to the membrane potential, or the like.

In one embodiment, the method 1500 may include scheduling a membrane potential determination for the neuron. Scheduling the membrane potential determination may be in response to receiving 1502 the synapse message. Scheduling the membrane potential determination may include selecting a later time, processing cycle, or the like to perform the determining 1508 step of the method 1500. In some embodiments, scheduling the membrane potential determination in response to receiving 1502 the synapse message may result in the neuron determining 1508 whether its membrane potential exceeds the threshold membrane potential only after the neuron has received a synapse message. Scheduling the membrane potential determination may include scheduling the membrane potential determination in response to a membrane potential determination not already being scheduled.

In some embodiments, scheduling the membrane potential determination may result in more efficient computing resource use, which may improve the functionality of one or more computing devices executing the method 1500. For example, if the neuron has not received a synapse message, the membrane potential of the neuron may not have substantially changed, and checking the membrane potential may use processing power, memory, or the like that may be used for other functions. Furthermore, in an exemplary embodiment, a time interval between a synapse scheduling a synapse message and sending the synapse message may be smaller than a time interval between scheduling a membrane potential determination and performing the membrane potential determination of the step 1508 of the method 1500. This may result in a neuron receiving multiple synapse messages, but only performing the step 1508 once instead of for each message.

In some embodiments, the method 1500 may include determining whether to remove stored data associated with the neuron. The stored data associated with the neuron may include a stored synapse message, a stored membrane potential, or other stored data regarding the neuron. Removing the stored data may free up memory, computing storage, or other resources of a processor device or computing device the neuron may be executing on so that the resources can be used for other data.

In one embodiment, determining whether to remove stored data associated with the neuron may include calculating a global time. The global time may include the time of an earliest unprocessed message in the ANN or the overarching computing system executing the ANN. In some embodiments, each component of the ANN may send the timestamp of its earliest unprocessed message to the overarching computing system. Each component may send the timestamp in response to a request received from the overarching computing system or may send the timestamp periodically. The overarching computing system may determine which received timestamp is the earliest. The global time may include the earliest timestamp.

In one embodiment, determining whether to remove stored data associated with the neuron may include the neuron receiving the global time. The overarching computing system may send the earliest received timestamp to each component of the ANN, including the neuron. In another embodiment, determining whether to remove stored data associated with the neuron may include comparing each stored message, stored membrane potential, or other stored data to the global time. In response to the timestamp of the stored message, membrane potential, or the other stored data being earlier than the global time, the neuron may remove the stored message, membrane potential, or other stored data.

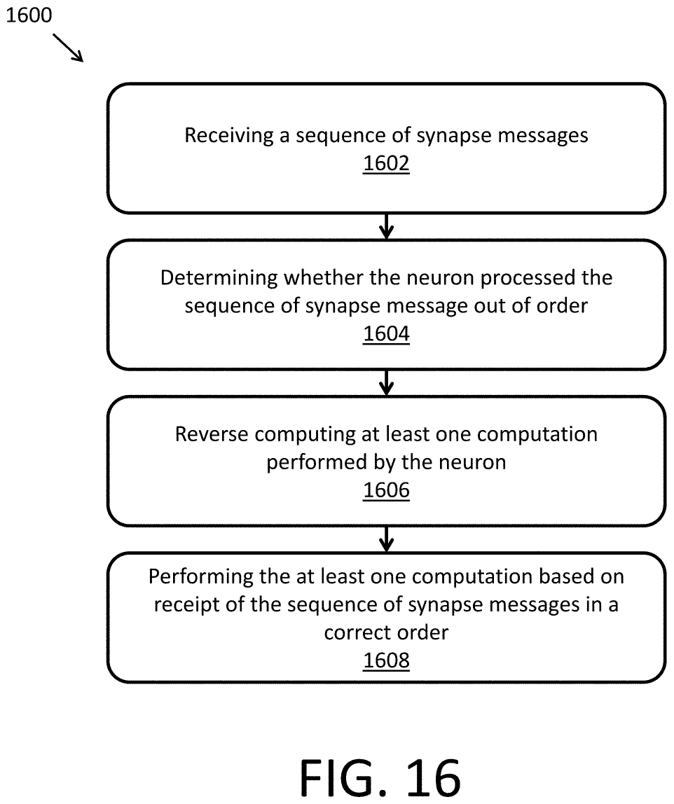

FIG. 16 depicts one embodiment of a method 1600. The method 1600 may include a computer-implemented method. The method 1600 may include a method for artificial neural network optimistic event processing. The method 1600 may include receiving 1602, at a neuron of an ANN (such as the ANN 1400), a sequence of synapse messages. In some embodiments, the sequence of synapse messages may include one or more synapses messages and the order in which the one or more synapse messages arrived at the neuron. Each synapse message may include a timestamp of the time the synapse message was sent. In some embodiments, the neuron may process the synapse messages in the order in which the synapse messages arrive at the neuron. In some embodiments, the synapse messages of the sequence of synapse messages may arrive at the neuron at different times.

In some embodiments, the method 1600 may include determining 1604, based on the timestamp of each synapse message, whether the neuron processed the sequence of synapse messages out of order with respect to the timestamps. Processing a synapse message may include the neuron performing the voltage integration function based on the voltage of the synapse message, performing the leak function, or the like. In some embodiments, the neuron processing the sequence of synapse messages out of order may include the neuron processing one or more synapse messages of the sequence in an order other than the order in which they were sent. In one embodiment, in response to the neuron process the sequence of synapse messages out of order, the neuron may perform the integration function using an incorrect input, which may result in the neuron firing too early, firing too late, or the like. The neuron firing too early, firing too late, or the like may result in an inaccurate output from the ANN.

In one embodiment, the method 1600 may include reverse-computing 1606 at least one computation performed by the neuron in response to processing the sequence of synapse messages out of order. Reverse-computing the at least one computation may be known as reversing the at least one computation. The at least one computation may include the voltage integration function, the leak function, or the like. Reverse-computing the at least one computation may include undoing an effect of the computation. In one embodiment, reverse-computing 1606 at least one computation performed by the neuron may include reverting the membrane potential of the neuron to the value of the membrane potential before the neuron performed the at least one computation. Reverting the membrane potential of the neuron may include restoring the value of the membrane potential to the value that was stored in response to receiving the out-of-order synapse message. In some embodiments, reverse-computing the at least one computation may include executing a predetermined function that corresponds to the at least one computation. For example, in one embodiment, a neuron may be configured with a certain voltage integration function and may also be configured with a corresponding reverse voltage integration function that undoes the effect of the voltage computation function.

In some embodiments, the method 1600 may include performing 1608 the at least one computation based on receipt of the sequence of synapse messages in a correct order as determined by the timestamp of each synapse message in the sequence of synapse messages. In one embodiment, the correct order may include an ascending order of timestamps of the sequence of synapse messages. In some embodiments, performing 1608 the at least one computation may include the neuron performing the voltage integration function. However, in this embodiment, in response to the neuron processing the sequence of synapse messages in the correct order, the membrane potential of the neuron may be different after each time the neuron performs the voltage integration function than when the neuron performed the voltage integration function on the sequence of synapse messages out of order. In some embodiments, performing 1608 the at least one computation may include the neuron performing the leak function or another function.

In one embodiment, reverse 1606 computing the at least one computation may include reverse-computing at least one computation corresponding to a first synapse message of the sequence of synapse messages. The first synapse message may include a timestamp after the timestamp of a most-recently received synapse message. Performing 1608 the at least one computation in the correct order may include performing a computation corresponding the most-recently received synapse message and the at least one computation in an order with respect to the timestamps of the most-recently received synapse message and the first synapse message.

In one embodiment, the method 1600 may include producing at least one anti-message. Producing the at least one anti-message may be in response to reverse-computing a computation. An anti-message may be configured to cancel a message. The anti-message may cancel the message in response to the message having not been yet processed by the receiving component of the ANN. An anti-message may be configured to cause a component of the ANN to reverse-compute a computation. In some embodiments, the anti-message may correspond to the reverse-computed computation the caused the anti-message to be produced.

For example, in response a neuron reverse-computing the voltage integration function (e.g., in response to processing one or more synapse messages out of order), the neuron may send one or more anti-messages to two downstream neurons. The first downstream neuron may receive the anti-message, determine that it has not yet processed the message from the upstream neuron, and may cancel the message from the upstream neuron. The cancelled message may correspond to the voltage summation function that was reverse-computed by the upstream neuron (e.g., the upstream neuron produced the message in response to the resulting membrane potential exceeding the threshold membrane potential). Cancelling the message may include removing the message from a queue of messages waiting to be processed by the downstream neuron.

Continuing the example, the second downstream neuron may have processed the message from the upstream neuron prior to receiving the anti-message from the upstream neuron. In response to receiving the anti-message, the second downstream neuron may reverse-compute a computation that was triggered by the upstream neuron's message. In some embodiments, in response to reverse-computing the computation, the second downstream neuron may send one or more of its own anti-messages.

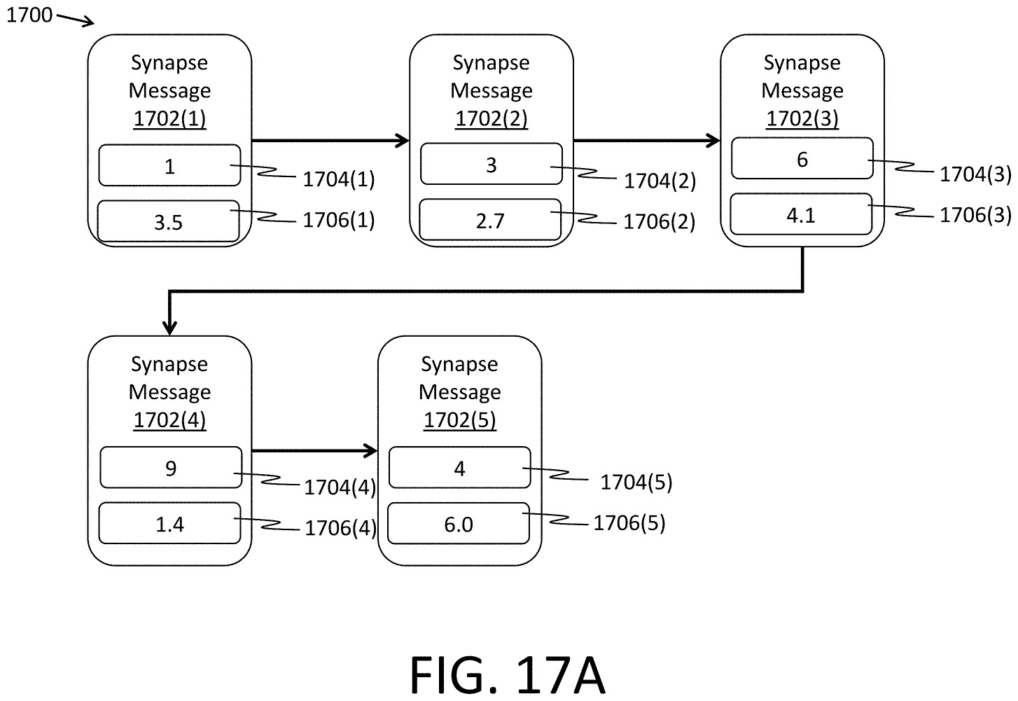

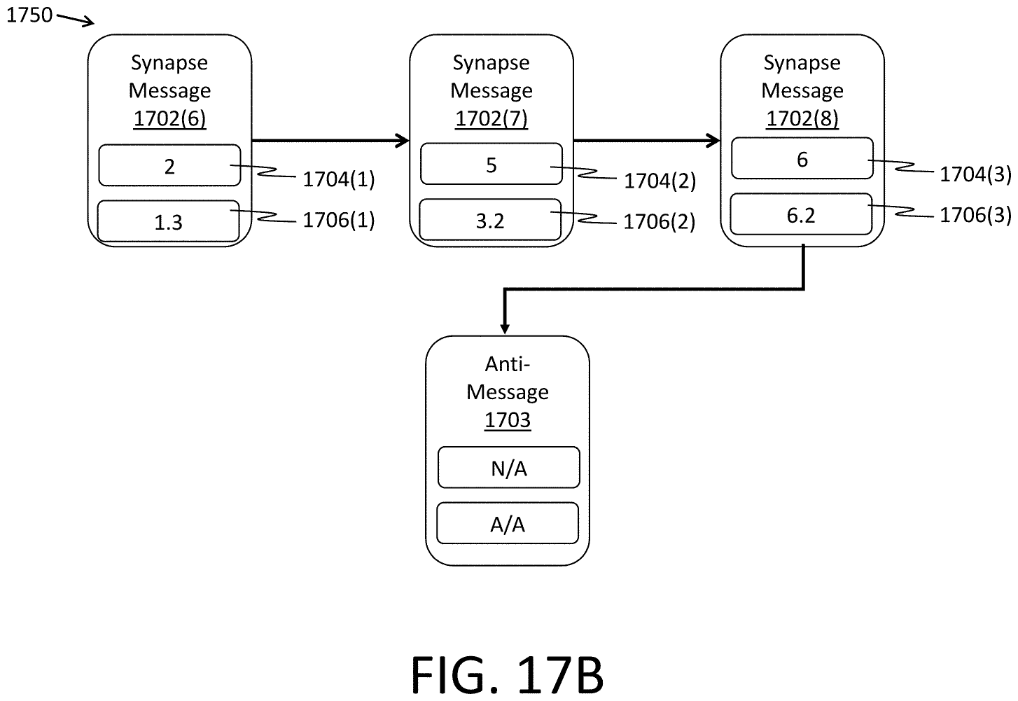

FIG. 17A depicts one embodiment of a sequence 1700 of synapse messages received by a neuron. The sequence 1700 may include the synapse messages 1702(1)-(5). Each synapse message 1702 may include a timestamp 1704 and a voltage value 1706. The sequence 1700 may include the order the neuron received the synapse messages 1702. In the example, the neuron received synapse message 1702(1) first, then synapse message 1702(2), then synapse message 1702(3), then synapse message 1702(4), and then the most recently received synapse message 1702(5). Before the neuron received the synapse message 1702(5), the neuron received the synapse messages 1702(1)-(4) in a correct order (as indicated by the ascending order of the timestamps 1704(1)-(4)). However, the synapse message 1702(5) includes the timestamp 1704(5) with a value before the value of the timestamp 1704 of at least one of the previously received synapse messages 1702 (i.e. in the example of FIG. 17A, the synapse messages 1702(3) and 1702(4)). This indicates that the neuron received the sequence 1700 of synapse messages out of order.

In response, the neuron may reverse-compute the computations it performed in response to processing the synapse messages 1702(3) and 1702(4). Reverse-computing the computations may include reverting the membrane potential to the value of the membrane potential of the neuron before receiving the synapse message 1702(3). In response to performing the reverse-computations, the neuron may perform the computations corresponding to the synapse messages 1702(3)-(5) that it has received in the order indicated by the timestamps 1704(3)-(5). In some embodiments, performing the computations may include determining, after performing the integration function, whether the membrane potential of the neuron exceeds the threshold membrane potential of the neuron.

FIG. 17B depicts one embodiment of a sequence 1750 of synapse messages 1702 received by a second neuron (e.g., a different neuron than the first neuron that received the sequence 1700 of synapse messages in FIG. 17B). The sequence 1750 may include the synapse messages 1702(6)-(8). The synapse messages 1702(6)-(8) may have been received by the second neuron. Similar to the synapse messages 1702(1)-(5) of FIG. 17A, the sequence messages 1702(6)-(8) may each include a timestamp 1704 or a voltage value 1706.

In some embodiments, in response to reverse-computing the computations corresponding to the synapse messages 1702(3) and 1702(4), the first neuron may send one or more anti-messages 1703. For example, in response to receiving the synapse message 1702(3), the first neuron may have used the voltage value 1706(3) as input for its integration function. In response, the first neuron may have determined that its resulting membrane potential exceeded its threshold membrane potential and may have sent a firing message to a second synapse to be received at the second neuron. However, since the synapse message 1702(5) should have been received before the synapse message 1702(3), the first neuron may have sent a firing message at the incorrect time and, thus, may have adjusted its membrane potential with the incorrect voltage value 1706, or the like. In response, the first neuron reverse-computing the computation corresponding to the synapse message 1702(3) may include sending an anti-message 1703. The first neuron may send the anti-message 1703 to the second neuron (i.e., a neuron that may have received the firing message at the wrong time or with the wrong timestamp 1704 or wrong voltage value 1706). The anti-message 1703 may include messages data fields left unfilled (e.g., N/A values) corresponding to the firing message sent to the synapse. The second neuron may receive the anti-message, reverse-compute any corresponding computations, and may send one or more anti-messages in response to one or more synapse messages corresponding to the reverse computations. In some embodiments, the anti-message 1703 may include data indicating which synapse messages 1702(6)-(8) to reverse computer or data indicating up to which point in the sequence 1750 is correct.

In another embodiment, a neuron and one or more connecting synapses downstream from the neuron may perform a fan-out message delivery method. The fan-out delivery method may include the following. A first neuron may be coupled to one or more downstream synapses. A downstream synapse may include a synapse that receives a firing message from the first neuron. A downstream synapse may be coupled to a second neuron and the second neuron may be downstream from the first neuron. In one embodiment, a method may include producing, at the first neuron, a firing message. The firing message may be for a synapse of the one or more downstream synapses. In one embodiment, a “firing message being for a synapse” may include the firing message having the synapse as its destination, target, or the like. Producing the firing message may include the first neuron producing an output. In one embodiment, in response to the synapse receiving the firing message, the method may include producing a synapse message for the second neuron. The method may include producing the firing message for a second synapse of the one or more downstream synapses. In one embodiment, producing the synapse message for the second neuron and producing the firing message for the second synapse may include a synapse producing the synapse message and the firing message. Each synapse producing these two messages (in some embodiments, with the exception of the last synapse not producing the firing message) may result in fewer total messages being produced and may result in lower memory usage.

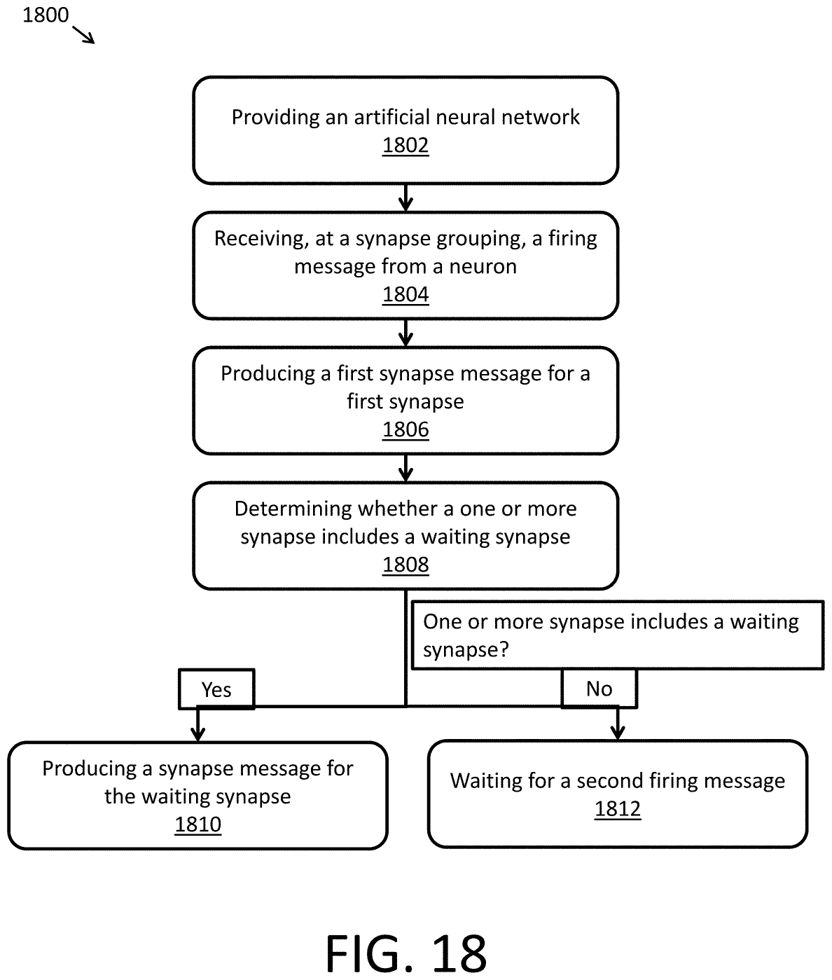

FIG. 18 depicts one embodiment of a method 1800. The method 1800 may include a computer-implemented method. The method 1800 may include a method for artificial neural network optimistic event processing. In one embodiment, the method 1800 may include providing 1802 the ANN (such as the ANN 100). The ANN may include a synapse group. The synapse group may include one or more synapse. The one or more synapse may be coupled to a neuron. The one or more synapse may be downstream of the neuron.

In one embodiment, the synapse group may include a logical process (explained below). The logical process may include the one or more synapse. In some embodiments, the one or more synapse may include synapses downstream from a single neuron or multiple neurons. In one embodiment, the synapses may include all synapses downstream of a single neuron or a portion of the synapses downstream of a single neuron. The synapse group logical process may receive one or more messages destined for a synapse included in the synapse grouping.

In one embodiment, the method 1800 may include receiving 1804, at the synapse group, a firing message from the neuron. The firing message may include an output of the neuron. The firing message may include a value of the output of the neuron. In some embodiments, the method 1800 may include, in response to receiving the firing message, producing 1806 a first synapse message for a first synapse of the one or more synapse. As used herein, a “synapse message for a first synapse” may include a synapse message originating from the first synapse. The first synapse message may include the value of the output of the upstream neuron adjusted based on the weight of the first synapse.

In some embodiments, the method 1800 may include determining 1808 whether the one or more synapse includes a waiting synapse. In one embodiment, the waiting synapse may include a synapse that has not had a respective synapse message produced for it in response to the firing message. In one embodiment, in response to determining that the one or more synapse includes the waiting synapse, the method 1800 may include producing 1810 the synapse message for the waiting synapse. Producing 1810 the synapse message may include scheduling the synapse message to be sent at a later time. In some embodiments, producing 1810 the synapse message may be similar to producing 210 the firing message.

In some embodiments, in response to determining that the one or more synapse does not include at least one waiting synapse, the method 1800 may include waiting 1812, at the synapse group, for a second firing message from the neuron. In one embodiment, waiting 1812 at the synapse group does not necessarily include the synapse group doing nothing, idling, or the like. For example, the synapse group may receive firing messages from other neurons and may process those firing messages.

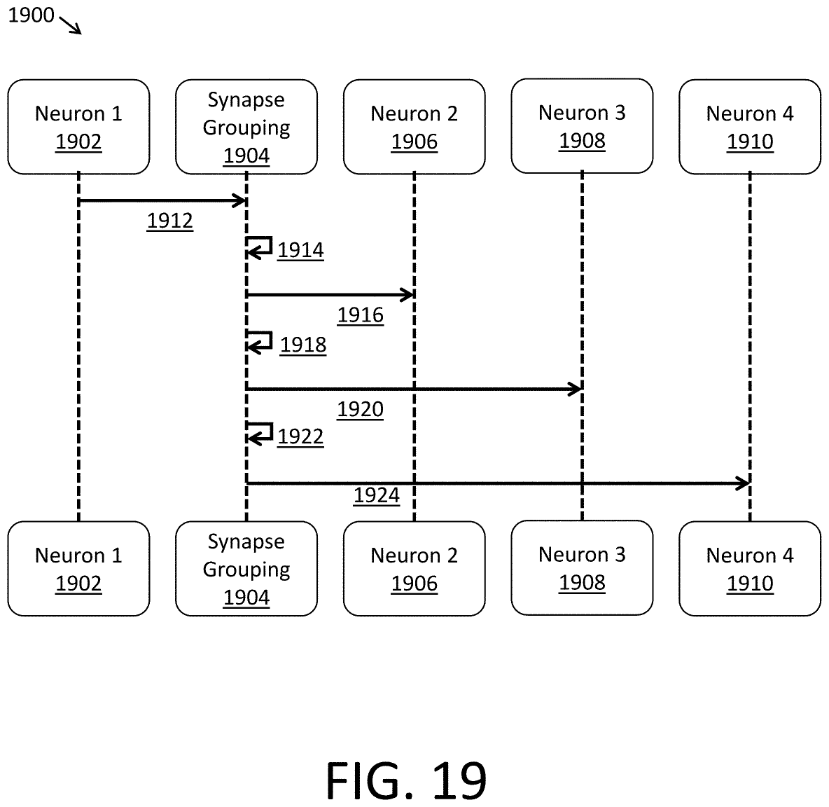

FIG. 19 depicts a flow diagram 1900 of one embodiment of a synapse group processing a firing message received from a neuron. The flow diagram 1900 includes first neuron 1902, a synapse group 1904, a second neuron 1906, a third neuron 1908, and a fourth neuron 1910. The first neuron 1902 is upstream from the second, third, and fourth neurons 1906, 1908, 1910 and is connected to each of these neurons through a first, second, and third, synapse. The synapse group 1904 includes the first, second, and third synapses.

The flow begins, and at 1912, the first neuron 1902 sends a firing message to the synapse group 1904. The voltage of the firing message may include a value of 1.4. At 1914, the synapse group 1904 may adjust the voltage of the firing message based on the weight of the first synapse of the synapse group 1904. In this embodiment, adjusting the voltage of the firing message may include multiplying the voltage by the weight of the first synapse. The weight of the first synapse may include a value of 0.6. In response, the resulting voltage includes the value of 0.84. At 1916, the synapse group 1904 may produce a first synapse message for the first synapse. The first synapse message may include the resulting voltage value of 0.84. The first synapse message may be destined for the second neuron 1906.

At 1914 or after 1916, the synapse group 1904 may determine whether the first, second, and third synapses include a waiting synapse. In response to the second and third synapses not having yet sent a synapse message in response to the synapse group 1904 receiving the firing message from the first neuron 1902, the synapse group 1904 may determine that first, second, and third synapses do include a waiting synapse.

At 1918, the synapse group 1904 may adjust the voltage of the firing message based on the weight of the second synapse by multiplying the voltage of the firing message (1.4) by the weight of the second synapse (in this example, 1.1). At 1920, the synapse group 1904 may produce a synapse message with the resulting voltage of 1.54 destined for the third neuron 1908. At 1918 or after 1920, the synapse group 1904 may determine whether the first, second, and third synapses include a waiting synapse. The synapse group 1904 may determine that the third synapse is a waiting synapse.

At 1922, the synapse group 1904 may adjust the voltage of the firing message based on the weight of the third synapse by multiplying the voltage of the firing message (1.4) by the weight of the third synapse (in this example, 0.8). At 1924, the synapse group 1904 may produce a synapse message with the resulting voltage of 1.12 destined for the fourth neuron 1910. At 1922 or after 1924, the synapse group 1904 may determine whether the first, second, and third synapses include a waiting synapse. In response to the first, second, and third synapses having each sent a synapse message in response to the firing message from the first neuron 1902, the synapse group 1904 may determine that the first, second, and third synapses do not include a waiting synapse. In response, the synapse group 1904 may wait for a second firing message.

In one embodiment, using a synapse group logical process instead of one logical process per synapse may reduce the amount of memory used by logical processes. This may allow embodiments with a larger ANN, which may be able to perform more accurately, faster, more efficiently, or the like. Using a synapse group logical process may reduce the number of synapse messages sent between processing cores, over the data network, or the like. This may reduce congestion over the system bus, data network, or the like, which may decrease the chances of a message arriving at a logical process late, and thus, may decrease the number of times a logical process may perform reverse computations.

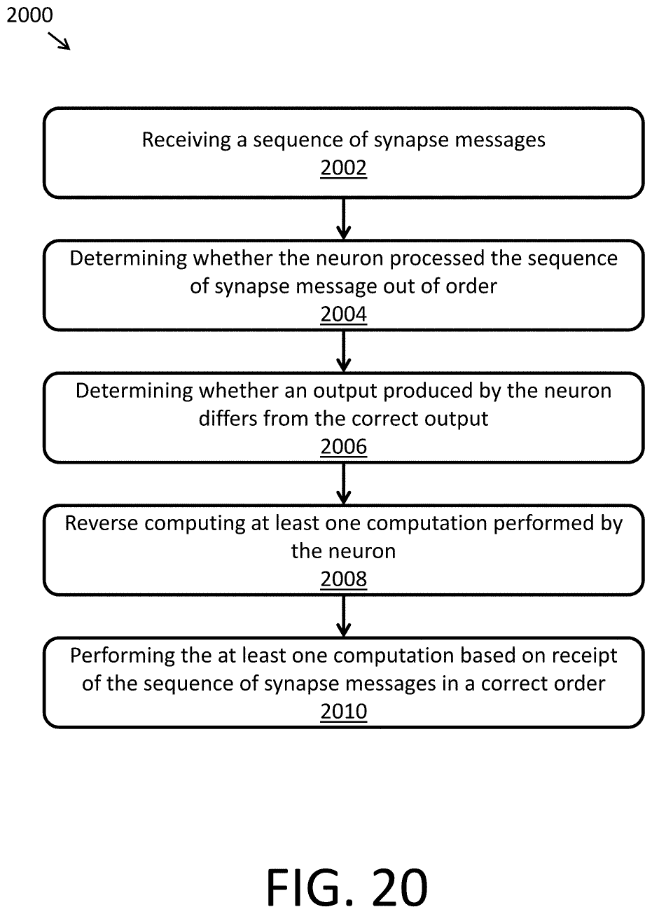

FIG. 20 depicts one embodiment of a method 2000. The method 2000 may include a computer-implemented method. The method 2000 may include a method for artificial neural network optimistic event processing. The method 2000 may include receiving 2002, at a neuron of an artificial neural network, a sequence of synapse messages. Each synapse message may include a timestamp of the time the synapse message was sent. In one embodiment, receiving 2002 the sequence of synapse messages may be similar to the step of receiving 1602 the sequence of synapse messages of the method 1600. The neuron may be configured to produce a correct output when the neuron processes the synapse messages in a correct order with respect to the timestamps of the synapse messages. The correct output may include a firing message sent at a certain time and with a certain voltage that would result from the neuron processing the sequence of synapse messages in a correct order as indicated by the timestamps of the synapse messages.

In some embodiments, the method 2000 may include determining 2004, based on the timestamp of each synapse message, whether the neuron processed the sequence of synapse messages out of order with respect to the timestamps. In one embodiment, determining 2004 whether the neuron processed the sequence of synapse messages out of order may be similar to the step of determining 1604 whether the neuron processed the sequence of synapse messages out of order of the method 1600.

In one embodiment, in response to the neuron processing the sequence of synapse messages out of order, the method 2000 may include determining 2006 whether an output produced by the neuron in response to processing the sequence of synapse messages out of order (i.e. “the actual output”) differs from the correct output. An output may include a firing message produced by the neuron. In some embodiments, a neuron may process a sequence of synapse messages out of order, but it may not cause the actual output to be substantially different from the correct output. In response to the actual output not being substantially different from the correct output, the neuron may discard the out of order message.

For example, a neuron may receive a first synapse message with a timestamp of “4.” The neuron may process the first synapse message by adjusting its membrane potential based on the voltage of the first synapse message and the voltage integration function of the neuron. Next, the neuron may determine that the membrane potential of the neuron exceeds the threshold membrane potential and may produce a firing message. The firing message may include a voltage. The voltage may include a constant value that the neuron includes each firing message and may not be based on the neuron's membrane potential at the time of producing the firing message. Next, the neuron may receive a second synapse message with a timestamp of “3,” which may indicate that the second synapse message should have been received before the first synapse message. However, since the voltage of the firing message would have been the same whether the neuron had received both synapse messages, or only one, the actual output of the neuron may not have been affected by the neuron processing the out-of-order synapse messages. In response, the neuron may discard the second synapse message.

In another example, processing the sequence of synapse messages may cause the actual output to differ from the correct output. For example, a neuron may receive a first synapse message with a timestamp of “7.” The neuron may process the first synapse message by adjusting its membrane potential based on the voltage of the first synapse message and the voltage integration function of the neuron. Next, the neuron may calculate a leak voltage and add it to the membrane potential. Next, the neuron may determine that the membrane potential of the neuron does not exceed the threshold membrane potential (and, thus, the neuron does not produce a firing message). Next, the neuron may receive a second synapse message with a timestamp of “3,” which may indicate that the second synapse message should have been received before the first synapse message. Furthermore, the second synapse message may include a voltage that, if the neuron had received the second synapse message earlier, would have caused the membrane potential of the neuron to exceed the threshold membrane potential (and, thus, produce a firing message) earlier. Thus, the actual output differs from the correct output.

In some embodiments, in response to the output produced by the neuron differing from the correct output, the method 2000 may include reverse-computing 2008 at least one computation performed by the neuron in response to processing the sequence of synapse messages out of order. In one embodiment, the method 2000 may include performing 2010 the at least one computation based on receipt of the sequence of synapse messages in the correct order to produce the correct output. Reverse-computing 2008 the at least one computation and performing 2010 the at least one computation may be similar to the steps of reverse-computing 306 the at least one computation performed by the neuron and performing 1608 the at least one computation of the method 1600, respectively.

In one embodiment, the output produced by the neuron in response to processing the sequence of synapse message out of order may differ from the correct output for a variety of reasons. In some embodiments, the actual output being different from the correct output may include the neuron producing the output at a time different than a time the neuron would have produced the correct output. In another embodiment, the actual output differing from the correct output may include the neuron producing the output with a voltage of a firing message different than a voltage of a firing message of the correct output. For example, a neuron may receive a first synapse message with a timestamp of “5” and a second synapse message with a timestamp of “7.” The neuron may process the first and second synapse messages and adjust its membrane potential based on the voltages of the first and second synapse messages and the voltage integration function of the neuron. The adjusted membrane potential may be 13.4. The neuron may determine that the membrane potential 13.4 exceeds the threshold membrane potential and produce a firing message. The firing message may include the voltage 13.4. Afterwards, the neuron may receive a third synapse message with a timestamp of “6.” Had the neuron received the first, second, and third synapse messages in the correct order, the firing message would have included a voltage of 15.3. Thus, in this example, the actual output includes the voltage 13.4 and the correct output would have included the voltage 15.3, and thus the actual output differs from the correct output.

In one embodiment, a neuron may discard a received out of order synapse message for a variety of reasons. The neuron may discard a received synapse message in response to the actual output of the neuron not substantially differing from the correct output, as explained above. The neuron may discard a received synapse message in response to a user configuration of the neuron, the ANN, or other component of the ANN. The neuron may discard a received synapse message in response to the time difference between the timestamp of the message and the time the message arrived at the neuron being more than a threshold time difference. For example, the threshold time difference may include 10. In response to the timestamp of the received synapse message being 7 and the time the message arrived at the neuron being 23, the difference may be 15, which is more than the threshold time difference of 10. In response, the neuron may discard the received synapse message.

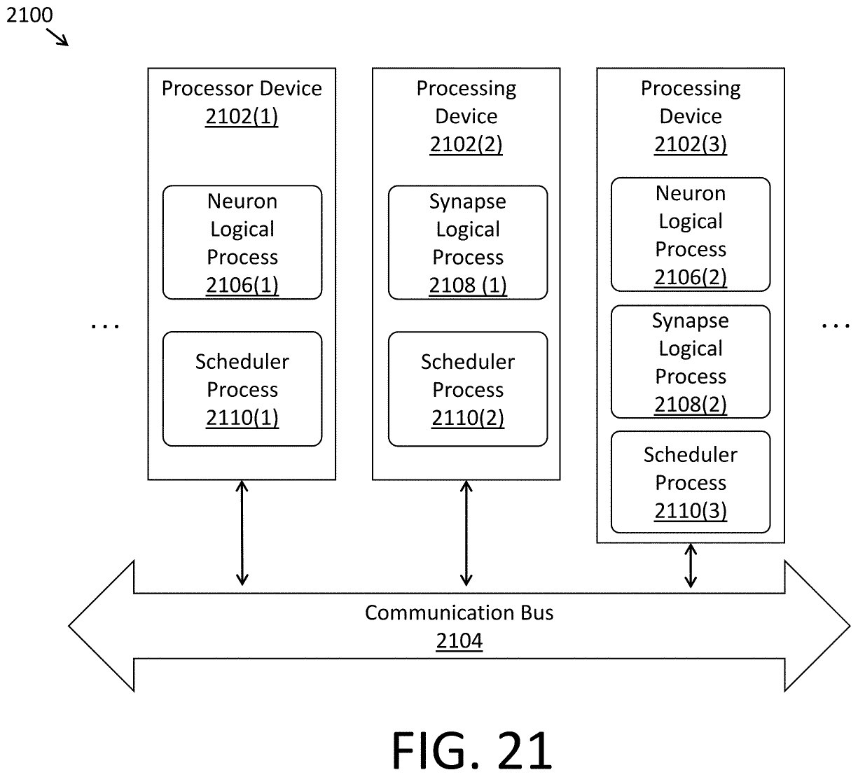

FIG. 21 depicts one embodiment of a system 2100. In one embodiment, the system 2100 may include one or more processor devices 2102, such as the processor devices 2102(1)-(3) of the FIG. 21. The one or more processor devices 2102 may include at least two processor devices 2102(1)-(2). A processor device 2102 may be in data communication with at least one other processor device 2102. A processor device 2102 may be in data communication with another processor device 2102 through a communication bus 2104.

In one embodiment, a processor device 2102 may include a central processing unit (CPU) (including a CPU core), a graphics processing unit (GPU), a multi-core processor, a dataflow engine, or the like. A processor device 2102 may include an application-specific integrated circuit (ASIC). A processor device 2102 may include an asynchronous processor. Examples of an asynchronous processor may include a neuromorphic processor, a non-Von Neumann-type processor, or the like. The system 2100 may include multiple types of processor devices 2102. A processor device 2102 may execute one or more processes, software modules, program instructions, or the like.

In one embodiment, a logical process may include a computer process, computer program, software module, program instructions, a portion thereof, or the like. A logical process may include a component of the ANN. For example, in one embodiment, a logical process may include a neuron. A logical process that includes a neuron may be called a “neuron logical process” 2106. In another embodiment, a logical process may include a synapse. A logical process that includes a synapse may be called a “synapse logical process” 2108.

In some embodiments, a logical process may communicate with another logical process through a message. The message may include data, a timestamp of the time the message was sent, or the like. A message may be similar to a message as described above in relation to synapse messages, firing messages, or the like. A message may be sent between logical processes executing on the same processor device 2102. A message may be sent between logical processes executing on different processor devices 2102 through the communication bus 2104. The communication bus 2104 may include one or more software or hardware components that may communicate a message from one processor device 2102 to another processor device 2102. For example, the communication bus 2104 may include circuitry between two processor devices 2102 that reside on the same computing device, a data network connecting different computing devices, or the like.

In one or more embodiments, a logical process may be configured to perform one or more steps, functions, or the like. The logical process may perform these steps, functions, or the like in response to being executed by a processor device 2102. In some embodiments, the steps, functions, or the like may include one or more steps of the method 1500, the method 1600, the method 1800, the method 2000, or the like.

In some embodiments, the system 2100 may include one or more neuron logical processes 2106, such as the neuron logical processes 2106(1)-(2) of the FIG. 21. The one or more neuron logical processes 2106 may include at least two neuron logical processes 2106. A neuron logical process 2106 may include a neuron of an artificial neural network (ANN), such as the ANN 100. A processor device 2102 may include a neuron logical process 2106 executing on the processor device 2102.

In some embodiments, the system 2100 may include one or more synapse logical processes 2108, such as the synapse logical processes 2108(1)-(2) of the FIG. 21. A synapse logical process 2108 may include a synapse of an ANN. The synapse may connect to a neuron of a neuron logical process 2106. A processor device 2102 may include the synapse logical process 2108 and may execute the synapse logical process 2108. The synapse logical process 2108 may send one or more synapse messages to a neuron logical process 2106. The synapse logical process 2108 may receive a firing message from a neuron logical process 2106.

In some embodiments, the system 2100 may include multiple processor devices 2102, each processor device 2102 executing at least one neuron logical process 2106 or synapse logical process 2108. In one embodiment, a processor device 2102 may include multiple logical processes executing on the processor device 2102. For example, as depicted in FIG. 21, the processor device 2102(3) may execute the neuron logical process 2106(2) and the synapse logical process 2108(2). More than one logical process of the same type may execute on a single processor device 2102. The number of processor devices 2102, logical processes, or the like of the system 2100 may include tens, hundreds, thousands, millions, or the like. In one embodiment, the system 2100 may include a supercomputer, compute cluster, or the like. The system 2100 may be configured to perform one or more functions of an ANN such as training, a hyperparameter search, inference calculations, or the like.

In one embodiment, a neuron logical process 2106 may be executed by a processor device 2102. The neuron logical process 2106, when executed by the processor device 2102, may be configured to perform one or more steps, functions, or the like. In some embodiments, the neuron logical process 2106 may be configured to receive a first synapse message. The first synapse message may include a voltage. In one embodiment, the neuron logical process 2106 being configured to receive the first synapse message may be similar to receiving 1502 a synapse message of the method 1500.

In some embodiments, the neuron logical process 2106 may be configured to adjust a membrane potential of the neuron of the neuron logical process 2106. The logical process 2106 may adjust the membrane potential based on the voltage of the synapse message that the neuron logical process 2106 received. In some embodiments, the neuron logical process 2106 adjusting the membrane potential of the neuron may be similar to adjusting 1506 the membrane potential of the neuron of the method 1500.

In one embodiment, the neuron logical process 2106 may be configured to determine whether the membrane potential of the neuron exceeds a threshold membrane potential of the neuron. In some embodiments, the neuron logical process 2106 may be configured to determine whether the membrane potential of the neuron exceeds a threshold membrane potential of the neuron may be similar to determining 1508 whether the membrane potential exceeds the threshold membrane potential of the method 1500.

In some embodiments, in response to the membrane potential of the neuron exceeding the threshold membrane potential, the neuron logical process 2106 may be configured to produce an output. The output may include a firing message. In one embodiment, the neuron logical process 2106 may be configured to produce the output without receiving a second synapse message from a connecting, upstream synapse. In some embodiments, a neuron logical process 2106 may receive one or more synapse messages from one or more synapse logical processes 2108, and the synapses of the one or more synapse logical processes 2106 may be upstream and connected to the neuron of the neuron logical process 2106. The neuron may receive one or more synapse messages from some, but not all, the upstream, connected synapses. However, based on at the voltages of the synapse messages the neuron has received, the neuron may determine that the neuron's membrane potential exceeds the threshold membrane potential of the neuron. Thus, the neuron may not need to wait to receive a synapse message from the other upstream, connected synapses to produce an output. In one embodiment, a neuron may not need to wait until other neurons in the same layer have determined whether their respective membrane potentials exceed their respective threshold membrane potentials to send a firing message.

In some embodiments, the system 2100 may include one or more scheduler processes 2110, such as the scheduler processes 2110(1)-(3). Each processor device 2102 may include a scheduler process 2110. Each scheduler process 2110 may be configured to determine an execution order for at least one logical process executing on the processor device 2102.

In one embodiment, a scheduler process 2110 may include a computer process or the like that schedules one or more processes to execute on the processor device 2102. The scheduling may include ordering the processes in an execution order. The execution order, how long each process runs during its scheduled time, or the like may be based on system 2100 configurations, processor device 2102 configurations, operating system configurations, or the like. In some embodiments, multiple logical processes may execute on a single processor device 2102. For example, as depicted in FIG. 21, the processor device 2102(3) may include a neuron logical process 2106(2) and a synapse logical process 2108(2). The scheduler process 2110(3) of the processor device 2102(3) may determine in what order the neuron logical process 2106(2), the synapse logical process 2108(2), and other processes executing on the process device 2102(3) may execute, how long each process may execute, or the like.

In one embodiment, a scheduler process 2110 may be configured to determine, based on a timestamp of a synapse message of a sequence of synapse messages, whether the neuron logical process executing on the processor device of the scheduler process received the sequence of synapse messages out of order with respect to the timestamps. A processor device 2102, a neuron logical process 2106, or the like may receive a sequence of synapse messages. The processor device 2102, a neuron logical process 2106, or the like may receive the sequence of synapse messages faster than the neuron logical process 2106 may process them. However, the sequence of synapse messages may arrive out of order with respect to the timestamp of each synapse message. In some embodiments, in response to determining that the neuron logical process 2104 received sequence of synapse messages out of order, the scheduler process 2110 may sort the sequence of synapse messages received by the neuron logical process 2106 in a correct order as indicated by the timestamps of the sequence of synapse messages.

For example, the processor device 2102(1) may receive three synapse messages. The timestamp of the first synapse message may include the time “4,” the timestamp of the second synapse message may include the time “7,” and the timestamp of the third synapse message may include the time “5.” The neuron logical process 2106(1) may be processing other received messages and may not begin processing the first, second, or third synapse messages immediately upon receipt. The scheduler process 2110(1) may sort the first, second, and third synapse messages. In response, the neuron logical process 2106(1) may, in response to finishing processing its previous messages, process the first synapse message, then the third synapse message, and then the second synapse message.

In another example, the processor device 2102(1) may receive three synapse messages. The timestamp of the first synapse message may include the time “4,” the timestamp of the second synapse message may include the time “7,” and the timestamp of the third synapse message may include the time “5.” However, the processor device 2102(1) may receive the third synapse message much later than the first and second synapse messages. In response, the neuron logical process 2106(1) may process the first and second synapse messages before processing the third synapse message. The neuron logical process 2106(1), in response to determining that the neuron logical process 2106(1) received the first, second, and third synapse messages out of order, may reverse-compute the second synapse message and may send a corresponding anti-message as described in relation to the method 1600.

In some embodiments, an ANN may include an axon. The axon may connect to a neuron and may be downstream from the neuron. The axon may connect to the one or more downstream synapses of the neuron. In one embodiment, a logical process for an axon (i.e. an “axon logical process”) may receive a firing message from the neuron. The axon logical process may send the firing message to each connecting downstream synapse logical process, synapse group logical process, or the like. In some embodiments, by using an axon logical process, a neuron logical process may not send a message to each connecting downstream neuron, but only to the downstream connecting axon. This may allow the neuron logical process to use less time, memory, processing time, or the like producing and sending messages, and more time processing received messages, reverse-processing, or the like.

In some embodiments, the ANN discussed herein may differ from a simulated ANN. A simulation is concerned with a subset of the behavior of an ANN. The subset behavior may include behavior being tested to determine whether the theoretical behavior may occur in an actual implementation. As a result, a simulated ANN simulates a portion of the data used to execute an implementation of an ANN. For example, a simulated ANN does not include overhead data or overhead processing used to configure the implemented ANN. Overhead data may include data used to create a neuron or a synapse, a neuron logical process or synapse logical process, a firing message or a synapse message, or other components of the implementation of the ANN. Overhead processing may include the processing performed by a processor device to create the aforementioned components of the implemented ANN, the processing performed to switch between processes on the processor device, or other processing performed in the execution of the implemented ANN.

A simulated ANN is concerned with the adherence of the simulation to certain conditions in order to test the theoretical behavior. As a result, certain functions of an implementation of an ANN are not present in a simulated ANN. This is because the implementation of an ANN is more concerned with obtaining results and is less concerned with testing correct behavior. For example, in a simulated ANN, a neuron would not determine whether the actual output of the neuron differs from the correct output to determine whether to reverse-compute one or more computations. The simulation would reverse-compute each time a sequence of synapse messages was received out of order because the simulation of the ANN is simulating the neurons of the ANN sending the firing messages at the correct times. Other behaviors of a simulated ANN may not be present in an implemented ANN.

As can be seen from the foregoing embodiments, an ANN of one or more of the embodiments described herein may improve the functionality of a computing device and may include non-conventional steps, functions, components, or arrangements of components.

For example, a neuron of an ANN according to the one or more embodiments may perform its integration function, leak function, or the like in an asynchronous manner. The neuron executing in an asynchronous manner may include the neuron not waiting to receive input from all connected upstream synapses before producing a firing message, unlike a conventional ANN. The neuron executing in an asynchronous manner may include the neuron not waiting for all of the neurons in the same layer to receive all of their respective inputs, unlike a conventional ANN. In some embodiments, this may result in a neuron of the ANN not expending computing resources when the neuron has not received any input, unlike a conventional, synchronous ANN. This may result in a faster execution of one or more functions of the ANN, which is an improvement of computer functionality. This improvement in computer functionality may be due to these non-conventional steps, functions, or components and may not be due to faster computer hardware. The asynchronous functionality of the ANN, such as may be described above in relation to the methods 200, 300, 500, or 700 may occur during training of the ANN or during inference calculation in the ANN.

In some embodiments, the neuron process messages from other components of the ANN as they arrive at the neuron, and in the case of a sequence of messages that arrive out of order, the neuron may include the non-conventional steps of reverse-computing the out-of-order messages and processing the messages in a correct order.

In some embodiments, a analytic model (such as an AI model of the enrichment application 404 or the exploitation application 406 of FIG. 4A) may implement one or more steps of the methods described above or one or more components of the optimistic event processing systems described herein. Other components of the system 100 may use the systems and methods of optimistic event processing.

Rollback

In one embodiment, a method for rollback in the system 100 may include a state-saving rollback method. The state-saving rollback method may include providing, at a data storage, a first set of data. The state-saving rollback method may include receiving a second set of data. The state-saving rollback method may include saving the first set of data, the first set of data including prior data. In one embodiment, saving the first set of data may include incremental state saving or may include full copy saving. The state-saving rollback method may include storing, at the data storage, a third set of data based on the first and second sets of data. The state-saving rollback method may include receiving a trigger to rollback. The state-saving rollback method may include restoring the first set of data to the data storage. In one embodiment, the data storage may include the cloud storage of the cloud environment 102. The first set of data may include the dataspace of the system 100 or a portion of the dataspace. In some embodiments, the first set of data may include an empty data set or no data in response to, for example, the dataspace being empty. In some embodiments, the first set of data may include data in the dataspace being used by or associated with a mission application, management application, or data management application. In some embodiments, the data storage may include computer memory (e.g., the computer memory of a CCN executing an application), or another device of the system capable of storing data.

In one embodiment, receiving the second set of data may include one or more steps of a method for data flow and data fusion as discussed herein. In some embodiments, receiving the second set of data may include the step of receiving external data. For example, the ASIS 304 may receive external data and store the received data in the dataspace via the DSMS 306. In another example, the import component may receive data from another instance of a system 100 and insert the received data into the dataspace via the DSMS 306. In one embodiment, receiving the second set of data may include the ASIS 304 receiving external data (e.g., from user input or an external system) and providing the external data to an application executing in the system.

In some embodiments, receiving the second set of data may include analyzing the second set of data. Analyzing the second set of data may include the step of analyzing the received data of the method for data flow and data fusion. Analyzing the second set of data may include performing an element count on the second set of data or normalizing values of a data column within the second set of data. In one embodiment, receiving the second set of data may include receiving a command to remove data from the first set of data.

In another embodiment, saving the first set of data may include storing the first set of data in a predetermined data storage location called the “rollback state storage.” Storing the first set of data in the rollback state storage location may include copying or moving the first set of data from the data storage to the rollback state storage location. Storing the first set of data in the predetermined data storage location may include designating the portion of the data storage storing the first set of data as rollback state storage or a previous version of the second set of data.

In one embodiment, saving the first set of data may include incremental state saving. Incremental state saving may include saving a portion of the dataspace. The saved portion of the dataspace may include the first set of data. Saving the first set of data may include the DSMS 306, CUSS 206, CSSS 208, CSN, or another cloud environment 102 or information environment component copying the first set of data into a rollback state storage portion of the cloud storage of the cloud environment 102 or designating the storage location in the cloud environment 102 of the first set of data as rollback state storage. In some embodiments, incremental state saving may include saving metadata about the first set of data. The metadata may include a timestamp for the date and time the first set of data was saved to the rollback state storage, data that corresponds the first set of data with the second set of data (i.e., the data that may have triggered the incremental state save), or other state data for the first set of data.

In one embodiment, storing, at the data storage, a third set of data based on the first and second sets of data may include updating data stored in the data storage based on the received second set of data. Storing the third set of data may include designating the third set of data as the official or current version of the data. In some embodiments, storing the third set of data may include updating the dataspace based on the received second set of data. For example, if the second set of data includes data that is being inserted into the dataspace (e.g., new data added to the dataspace), then the third set of data may include the first set of data combined with the second set of data. If the second set of data includes data that modifies the first set of data, then the third set of data may include the first set of data modified by the second set of data. If the second set of data includes data that removes at least a portion of the first set of data, then the third set of data may include an empty data set or the first data set without the removed portion. In one embodiment, the DSMS 306 may coordinate the CUSS 206 or the CSSS 208 to store data in, modify the data of, or remove data from the dataspace.

In some embodiments, restoring the first set of data to the data storage may include copying or moving the first set of data from the rollback state storage location to the data storage. Restoring the first set of data may include removing the third set of data from the dataspace. Restoring the first set of data may include designating the first set of data as the official or current version of the data or removing that designation from the third set of data.

In one embodiment, restoring the first set of data may include restoring multiple saved first sets of data to the dataspace until a specified saved first set of data is restored. Restoring the multiple first sets of data may include restoring the saved first sets of data in a reverse order of when they were saved to the rollback state storage. In some embodiments, restoring the first set of data may include selecting a certain first set of data from the multiple saved first sets of data and restoring the selected first set of data.

In one embodiment, a method for state-saving rollback may full copy saving. Full copy saving may include saving the entire dataspace as the first set of data. In some embodiments, saving the first set of data may include full copy saving. Full copy saving may include saving the entire dataspace. For example, the DSMS 306 may copy the data in the dataspace to the rollback state storage of the cloud storage or designating the storage location of the dataspace as rollback state storage. Full copy saving may include saving metadata about the dataspace.

In some embodiments, saving the first set of data may include saving metadata associated with the first set of data in a rollback history. The rollback history may track changes to a portion of the dataspace, a file, or the entire dataspace and store data about those changes in an order (e.g., from the most recent changes to the least recent). In one embodiment, the system 100 may include multiple rollback histories, each rollback history being associated with a different file, portion of the dataspace, a CSN, other data storage. Saving the first set of data may include updating multiple rollback histories that are associated with the first set of data. The rollback history may be stored on a CSN, on a data storage attached to the node executing the DSMS 306, or data storage attached to another device of the information environment.

As discussed above, in some embodiments, the exploitation application 406 may derive a pattern or discover data associations between data elements in one or more data artifacts. The exploitation application 406 may store data based on the pattern or data associations in the mission dataspace 120, the operational dataspace, or another data storage location in the system 100. In response a data artifact being rolled back or removed, the pattern or association data generated by the exploitation model may also be rolled back. Also as discussed above, in one embodiment, the assertion application 508 may rollback an assertion. The assertion may be located in the mission dataspace 120 or some other data storage location. The assertion may be associated with data stored in the mission dataspace 120. In response to the data associated with the assertion being rolled back, the assertion may also be rolled back.

Although much of the above discusses a method for state-saving rollback in relation to the dataspace of the system 100, the method for state-saving rollback may apply to other data storage. For example, in one embodiment, the first set of data may include data associated with an application executing on the system 100, such as a membrane potential of a neuron in an ANN as described above in relation to optimistic event processing. A CCN 204 or a job executing on a CCN 204 (for example, a job coordinating the multiple neurons of the ANN) may include the one or more rollback histories, rollback state storage, or other rollback data or components described herein.

As an example of the state-saving rollback method, a first set of data may include a text file stored in Cloud Unstructured Storage on a first CSN. The ASIS 304 may have moved the text file from outside the system into the system, the SIA 402 component may have ingested the text file, and the DSMS 306 may have stored the ingested text file in the Cloud Unstructured Storage on the first CSN. The DSMS 306 may receive a second set of data using the same or a similar process. The second set of data may include a new, updated version of the text file of the first set of data. The DSMS 306 may copy or move the original text file from the first CSN to second CSN that includes rollback state storage. The DSMS 306 may store metadata in the rollback state storage that associates the original text file with the updated text file, the first CSN, a storage location of the first CSN, or other data. The DSMS 306 may store metadata in a rollback history associated with the text file. The DSMS 306 may store the updated text file on the first CSN and may update any file references to the text file to the updated text file. The DSMS 306 may receive a trigger to rollback the original version of the text file. The DSMS 306 may determine from one or more rollback histories the location of the original text file on the second CSN. The DSMS 306 may remove the updated text file and move the original text file from the second CSN to the first CSN. The DSMS 306 may update any references to the text file to the original text file in the first CSN.

One embodiment of a method for rollback may include a reverse-computing rollback method. The method for reverse-computing rollback may include providing, at a data storage, a first set of data. The method for reverse-computing rollback may include receiving a second set of data. The method for reverse-computing rollback may include generating a third set of data based on the first set of data, the second set of data, and a forward computation. The method for reverse-computing rollback may include replacing, at the data storage, the first set of data with the third set of data. The method for reverse-computing rollback may include receiving a rollback trigger. The method may include, in response to receiving the rollback trigger, generating the first set of data based on a reverse computation corresponding to the forward computation. The method may include replacing, at the data storage, the third set of data with the generated first set of data.

In some embodiments, the data storage may include the cloud storage of the cloud environment 102, the dataspace, a computer memory, or another data storage location as described above in relation to the state-saving rollback method. In one embodiment, the step of providing the first set of data or receiving the second set of data may include one or more steps that may be similar to one or more steps of the state-saving rollback method.

In one embodiment, the forward computation may include a set of computer program instructions or may include other computer functionality. The forward computation may receive one or more inputs. The one or more inputs may include the first set of data, the second set or data, or other data. In some embodiments, generating the third set of data based on the first set of data, the second set of data, and the forward computation may include using the first and second sets of data as inputs to a set of computer program instructions, and the set of instructions may generate the third set of data.

In some embodiments, replacing, at the data storage, the first set of data with the third set of data may be similar to the step of replacing the first set of data with the third set of data of the method for state-saving rollback. In one embodiment, replacing the first set of data with the third set may include storing metadata associated with the first, second, or third sets of data or storing at least a portion of the first or second sets of data in a rollback history.

In one embodiment, the reverse computation may include a second set of computer program instructions or other computer functionality. The reverse computation may correspond to or be associated with the forward computation. The reverse computation may be configured such that executing the reverse computation with one or more inputs, such as the third set of data or the second set of data, may generate the first set of data. In some embodiments, generating the first set of data based on a reverse computation corresponding to the forward computation may include executing the reverse computation. The reverse computation may use the third set of data as input. The reverse computation may use the second set of data as input. In some embodiments, replacing the third set of data with the first set of data may be similar to the step of replacing the first set of data of the method for state-saving rollback.

As an example of the reverse-computation rollback method, a first set of data may include a set of numbers. The set of numbers may be associated with a mission application executing in the system. The set of numbers may be stored in the memory of a CCN executing the mission application. The second set of data may include a number. The mission application may receive the number from a user via a component of the overarching system such as a tactical edge application, CAPN, or other component. The mission application may be configured (e.g., via the mission application's program code) with a forward computation. The forward computation may include adding the received number to each number of the set of numbers of the first set of data. The mission application may execute the forward computation and multiply each number of the set of numbers by the received number. The CCN executing the mission application may store the received number and metadata in a rollback history. The rollback history may be stored in the memory or attached storage of the CCN executing the mission application, another CCN, or a CSN associated with the CCN executing the mission application. The mission application may generate the third set of data by adding the received number to each number of the set of numbers. The mission application may replace the first set of numbers with the generated set of numbers resulting from the forward computations. The mission application may receive a rollback trigger (e.g., from the user or from another application executing on a CCN). In response to the trigger, the mission application may retrieve the stored number from the rollback history. The mission application may retrieve a reverse computation associated with the forward computation that was used to generate the third set of data. In this example, the reverse computation may include subtracting the received number from each number of the resulting set of numbers. The reverse computation may be part of the computer program instructions of the mission application. The mission application may execute the reverse computation using the received number and the resulting set of numbers as input to generate the original set of numbers. The mission application may replace the third set of data with the resulting original set of numbers.

In one embodiment, the method for reverse-computation rollback may include generating the third set of data based on the first set of data and the forward computation without receiving a second set of data. For example, the first set of data may include a set of numbers associated with an executing application, and the forward computation may include multiplying each number of the set of numbers by 2. The resulting third set of data may include each number of the first set of data multiplied by 2. The reverse computation associated with the forward computation may include dividing by 2. Generating the first set of data based on the reverse computation may include dividing each number of the third set of data by 2.

Although much of the above discusses forward computation and reverse computation as mathematical operations, the forward and reverse computations may include other types of data manipulation. For example, a forward computation may include a logical or software neuron's (such as a neuron 1402 of the FIG. 14) firing based on integration operations which may be realized as event messages scheduled within the system 100. In other embodiments, a forward computation may include a dataspace insertion operation as part of a data collection or insertion task, which then the associated reverse computation may perform the correct dataspace deletion or removal operation.

The rollback provided by the system 100 may differ from conventional computing system functionality in a variety of ways. For example, components of an AI, machine learning, or data analytics model of the system 100 may execute without waiting for each other even though these components may be interdependent. In some embodiments, the system 100 may perform one or more unconventional steps associated with rollback. For example, unconventional functions of the system 100 may include rolling back data in the mission dataspace 120, rolling back a data model, rolling back an assertion on data in the mission dataspace 120, or rolling back a data analytics model. Such functionality, along with other functionality described herein may improve the functionality of the a computer system such as the system 100. For example, by rolling back data stored in the mission dataspace 120, the system 100 can quickly and efficiently remove data from the system 100. The removed data may include data that was initially ingested into the system, but should not have been based on determining that the ingested data was prematurely ingested and processed. Rolling back data may enable the system 100 to automatically remove data from use by a dataspace or an AI model or system without human intervention. Rollback overcomes problems specifically arising in the realm of AI, such as the problem of AI models and systems using incorrect data as a basis for their functionality.

In one embodiment, the system 100 may improve the functionality of a computing system. For example, the rollback functionality of the system 100 may enable an AI model to optimistically execute, allowing components of the AI model that are dependent on each other to execute without having to wait on each other for results. This may reduce the amount of time the AI model spends stalled. The frequency an AI model spends rolling back may be small compared to the stalling experienced by a conventional AI model. This optimistic execution improves parallel processing capabilities of the system 100. Rollback also enables recovery operations for an AI model or data in the mission dataspace 120 in response to computer failure due to hardware or software failures.

The system 100 may execute an AI or machine learning model, which may be part of the exploitation application 406 or a user-generated analytic application 502, on multiple cores. In some embodiments, the system 100 may utilize 65,000 cores or more to increase computational speed by six orders of magnitude or more over conventional computing systems and may increase accuracy by ten orders of magnitude or more. Optimistic execution of the AI or machine learning models may lead to these increases in computing speed and accuracy. The system 100 may utilize the multiple cores such that the system 100 outperforms a conventional computer system that uses special-purpose hardware, such as GPUs.

As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

In some embodiments, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM″ or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processor devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processor device receives computer readable program instructions from the network and forwards the computer readable program instructions for storage in a computer readable storage medium within the respective computing/processor device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute on a supercomputer, a compute cluster, or the like. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, code segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Although certain methods have been described with examples of a certain component of a system performing a step of the method, the example should not be read to limit the method step to being performed by the example component. In some embodiments, other components described herein may also perform a method step as described by the functionality of the component.

Thus, although there have been described particular embodiments of the present invention of new and useful systems and method for an artificial intelligence data fusion platform, it is not intended that such references be construed as limitations upon the scope of this invention.

What is claimed is:

1. A computer-implemented method, comprising:
providing, in a computer-readable storage device, a dataspace, wherein the dataspace includes
a plurality of logical segments, and
dataspace data stored in the plurality of logical segments;
receiving, from a data source external to the dataspace, a data artifact, wherein the data artifact includes a plurality of data elements;
processing, at a plurality of data filters, the plurality of data elements, wherein a data filter of the plurality of data filters processes a data element of the plurality of data elements, based on
a structure of the plurality of the data elements, and
a configuration of the data filter;
generating, based on the processed plurality of data elements, processed data; and
sending the processed data to at least one logical segment of the plurality of logical segments of the dataspace.

2. The method of claim 1, wherein processing, at a plurality of data filters, the plurality of data elements comprises:
receiving, at a first data filter of the plurality of data filters, a first data element of the plurality of data elements;
selecting a portion of the first data element based on the configuration of the first data filter;
sending the portion of the first data element to the at least one logical segment; and
sending the first data element to a second data filter of the plurality of data filters.

3. The method of claim 1, wherein processing, at the plurality of data filters, the plurality of data elements comprises at least one of:
processing, at a first data filter of the plurality of data filters, a first data element of the plurality of data elements based on a mathematical analysis of the plurality of data elements;
processing, at the first data filter, the first data element based on an algorithm based on a mathematical function; or
processing, at the first data filter, the first data element based on the generated processed data.

4. The method of claim 1, wherein generating processed data comprises generating metadata corresponding to the data artifact.

5. The method of claim 4:
wherein
processing the plurality of data elements comprises disambiguating a first data element from a second data element of the plurality of data elements,
generating the processed data comprises generating
first metadata associated with a source data artifact, and
disambiguation data based on the disambiguating the first and second data elements, and
sending the processed data to at least one logical segment comprises
sending the first metadata to a first logical segment of the plurality of logical segments, the first logical segment including a data artifact semantics segment, and
sending the disambiguation data to a second logical segment of the plurality of logical segments, the second logical segment including a data semantics segment; and
further comprising sending the data artifact to the first logical segment.

6. The method of claim 5, wherein:
receiving the data artifact comprises receiving the data artifact from a semi-structured source;
generating the processed data comprises generating second metadata associated with the semi-structured source; and
sending the processed data to at least one logical segment comprises sending the second metadata to the second logical segment.

7. The method of claim 4, wherein:
receiving the data artifact comprises receiving a structured data artifact;
processing the plurality of data elements comprises retrieving, from the data source, structure data corresponding to the plurality of data elements of the structured data artifact,
generating the processed data comprises generating
second metadata associated with the structure data, and
third metadata associated with the data source, and
sending the processed data to at least one logical segment comprises
sending the structure data and the second metadata to a third logical segment of the plurality of logical segments, the third segment including a data model semantics segment, and
sending the third metadata to the second logical segment; and
further comprising sending the plurality of data elements to the second logical segment.

8. The method of claim 7, wherein receiving the structured data artifact comprises receiving at least one of:
data from a relational database;
a really simple syndication (RSS) feed; or
a header section of an email message.

9. The method of claim 1, wherein processing the plurality of data elements comprises normalizing a value of the plurality of data elements based on dataspace data.

10. The method of claim 1, wherein receiving the data artifact comprises receiving, via an external-facing data interface, the data artifact from an external application executing on an external computer system.

11. The method of claim 1, wherein receiving the data artifact comprises receiving, via a file transfer service, the data artifact from a network location on an external computer system.

12. The method of claim 1, further comprising, in response to the plurality of data elements including a predetermined data size, generating a second plurality of data filters.

13. The method of claim 1, further comprising:
selecting a portion of the dataspace data stored on a first data storage device;
indexing the portion of the dataspace data;
generating, on the first data storage device, a first indexing file including first indexing results in response to indexing the portion of the dataspace data;
receiving a second indexing file from a second data storage device;
sending the first indexing file and the second indexing file to a third data storage device; and
merging the first indexing results and the second indexing results into a third indexing file.

14. A system, comprising:
a first computing device including a first computer-readable storage medium,
wherein the first computer-readable storage medium includes a portion of dataspace, the dataspace including
a plurality of logical segments, and
dataspace data stored in the plurality of logical segments;
a second computing device, including
a second processor configured to process a second set of instructions, and
a second computer-readable storage medium including the second set of instructions,
wherein the second set of instructions, when executed by the second processor, cause the second processor to receive, from a data source external to the dataspace, a data artifact including a plurality of data elements; and
a third computing device, including
a third processor configured to process a third set of instructions, and
a third computer-readable storage medium including the third set of instructions,
wherein the third set of instructions, when executed by the third processor, cause the third processor to perform the steps of
process the plurality of data elements based on a structure of the plurality of the data element,
generate, based on the processed plurality of data elements, processed data, and
send the processed data to at least one logical segment of the plurality of logical segments of the dataspace.

15. The system of claim 14, wherein the first computing device comprises a cloud storage device including a portion of at least one of:
a distributed file system; or
a distributed database.

16. The system of claim 14, wherein the third computing device comprises a cloud computing node configured to execute, via the third processor, the third set of instructions in response to receiving a command from a cloud management node.

17. The system of claim 14, wherein the data artifact comprises at least one of:
a data file;
a portion of a relational database; or
a data stream.

18. A plurality of non-transitory computer-readable storage media including one or more sets of instructions that, when executed by one or more processors, cause a system to perform the following steps:
provide, in a computer-readable storage device, a dataspace, wherein the dataspace includes
a plurality of logical segments, and
dataspace data stored in the plurality of logical segments;
receive, from a data source external to the dataspace, a data artifact, wherein the data artifact includes a plurality of data elements;
process, at a plurality of data filters, the plurality of data elements, wherein a data filter of the plurality of data filters processes a data element of the plurality of data elements, based on
a structure of the plurality of the data element, and
a configuration of the data filter;
generate, based on the processed plurality of data elements, processed data; and
send the processed data to at least one logical segment of the plurality of logical segments of the dataspace.

19. The plurality of non-transitory computer-readable storage media of claim 18:
wherein
processing the plurality of data elements comprises disambiguating a first data element from a second data element of the plurality of data elements,
generating the processed data comprises generating
first metadata associated with a source data artifact, and
disambiguation data based on the disambiguating the first and second data elements, and
sending the processed data to at least one logical segment comprises
sending the first metadata to a first logical segment of the plurality of logical segments, the first logical segment including an artifacts semantics segment, and
sending the disambiguation data to a second logical segment of the plurality of logical segments, the second logical segment including a data semantics segment; and
further comprising sending the data artifact to the first logical segment.

20. The plurality of non-transitory computer-readable storage media of claim 18, wherein:
receiving the data artifact comprises receiving the data artifact from a semi-structured source;
generating the processed data comprises generating second metadata associated with the semi-structured source; and
sending the processed data to at least one logical segment comprises sending the second metadata to the second logical segment.

21. The plurality of non-transitory computer-readable storage media of claim 18:
wherein
receiving the data artifact comprises receiving a structured data artifact,
processing the plurality of data elements comprises retrieving, from the data source, structure data corresponding to the plurality of data elements of the structured data artifact,
generating the processed data comprises generating
second metadata associated with the structure data, and
third metadata associated with the data source, and
sending the processed data to at least one logical segment comprises
sending the structure data and the second metadata to a third logical segment of the plurality of logical segments, the third segment including a data model semantics segment, and
sending the third metadata to the second logical segment; and
further comprising sending the plurality of data elements to the second logical segment.
